(19) United States
(12) Patent Application Publication
(10) Pub. No.: US 2011/0184712 A1
(43) Pub. Date: Jul. 28, 2011

(54) PREDICTIVE MODELS AND METHODS FOR DIAGNOSING AND ASSESSING CORONARY ARTERY DISEASE

(75) Inventors: Steve Rosenberg, Oakland, CA (US); Susan Daniels, Mountain View, CA (US); Michael R. Elashoff, Redwood City, CA (US); James A. Wingrove, Sunnyvale, CA (US); Whittemore G. Tingley, San Francisco, CA (US); Amy J. Sehnert, San Francisco, CA (US); Nicholas F. Paoni, Encinitas, CA (US)

(73) Assignee: CARDIODX, INC., Palo Alto, CA (US)

(21) Appl. No.: 12/682,579

(22) PCT Filed: Oct. 10, 2008
(86) PCT No.: PCT/US08/79646

§ 371 Date: Apr. 5, 2011

Related U.S. Application Data
(60) Provisional application No. 60/979,359, filed on Oct. 11, 2007.

(51) Int. Cl. G06G 7/60

(52) U.S. Cl. 703/11

(57) ABSTRACT

Biomarkers useful for diagnosing and assessing the extent of coronary artery disease (CAD) are provided, along with kits for measuring their expression. The invention also provides predictive models, based on the biomarkers, as well as computer systems, and software embodiments of the models for scoring and optionally classifying samples. In a preferred embodiment, the biomarkers are organized into clustered groups. The expression level of the biomarkers within a group are highly correlated to each other in normal and disease states. Expression values of genes chosen from each of two, three, four or five of the clustered gene groups, A, B, C, D, E may be used. Alternatively, expression values of genes chosen from the groups are combined into a metagene. Preferred biomarkers include S100A12, S100A8, S100A9, BCL2A1, and F5 (group A); XK, P62, and FECH (group B); TUBB2 (group C); IFNG, PDGFB, VSIG4, and TNF (group D); CSF3R, TLR5, CD46, and NCF1 (group E); S100A12, S100A9, BCL2A1, TXN and CSTA (group I); OLIG1, OLIG2, ADORA3, CLC, and SLC29A1 (group II); and CBS and ARG1 (group IV).

### BACKGROUND OF THE INVENTION

1. Field of the Invention

The invention relates to predictive models for diagnosing and assessing the extent of coronary artery disease (CAD) based on gene expression measurements, to their methods of use, and to computer systems and software for their implementation.

2. Description of the Related Art

Stress-treadmill testing is commonly used in the diagnosis of CAD (Gibbons RJ, et al. J Am Coll Cardiol 2003; 41(1):159-68, Gibbons RJ, et al. J Am Coll Cardiol 2002; 40(8):1531-40). By evaluating both the electrophysiology of the heart and symptoms of the patient under exertion physicians can, with varying degrees of accuracy, categorize patients into high, medium and low risk of CAD being the underlying cause of stress-induced chest pain due to coronary ischemia (Shaw L J, et al. Circulation 1998; 98(16):1622-30). In cases where there is clearly a high risk of CAD, for example when significant ST segment elevation/depression with concomitant symptom limiting exercise duration occurs, the patient is referred for angiography and possible percutaneous intervention (PCI). Unfortunately for various reasons the majority of cases fall in the medium or low risk categories where the results are ambiguous. Further testing including SPECT imaging, stress echocardiograms, and CT scanning are often needed and employed at this stage to establish a diagnosis of probable CAD. (Gibbons R J, et al. J Am Coll Cardiol 2003; 41(1):159-68).

PCI, balloon angioplasty with or without insertion of a bare metal or drug-eluting stent, is the treatment of choice for most patients with established CAD. In cases of severe or complex CAD, coronary artery bypass grafting (CABG) may be indicated. Together these two procedures serve to mechanically open or by-pass blocked blood vessel(s) to allow better coronary perfusion. In most cases PCI or CABG relieves the patient's symptoms and risk for subsequent events. While the overall success rate for these procedures is high, recent studies show that a significant number of patients (as many as 15% with multi-vessel disease) represent within a year for repeat PC1 or CABG for progression of atherosclerosis in lesions that were ineligible for treatment in the initial intervention (i.e., non-target lesions) (Cutlip D E, et al. Circulation 2004; 110(10):1226-30, Glaser R, et al. Circulation 2005; 111(2):143-9). The majority of these patients present with a potentially life-threatening acute coronary syndrome in the form of unstable angina or acute myocardial infarction.

Pathology of Atherosclerosis

Atherosclerosis is a disease of the arteries in which a fatty/wax-like substance (plaque) is deposited on the inside of the arterial walls. As this substance builds up, it causes the arteries to narrow. Over time, this narrowing prevents the blood from flowing properly through the arteries and can give rise to chest pain (angina), acute coronary syndromes (unstable angina and myocardial infarction) and stroke (American Heart Association. Heart Disease and Stroke Statistics—2005 Update. 2005).

Atherosclerotic plaque consists of fatty substances, cholesterol, cellular waste products and calcium. Myocardial infarctions (MI) or “heart attacks” are caused by plaque rupture that precipitates acute thrombosis and occlusion of a coronary artery. This is followed by tissue injury and cell death of heart muscle perfused by that artery. Alternatively, if part of the plaque breaks away, it can travel downstream in the blood and occlude the artery at any point where it narrows enough for the plaque to block it completely. When the affected artery feeds the heart, an MI may result, and if it feeds the brain, a stroke may result. While currently available non-invasive and invasive diagnostic tests can determine vessel narrowing due to plaque it is not currently possible to determine total plaque extent or predict which plaques are at greatest risk of progression and rupture (Taylor A J, et al. J Am Coll Cardiol 2003; 41(11):1860-2).

Inflammation is recognized as an essential element in the pathophysiology of atherosclerosis (Armstrong E J, et al. Circulation 2006; 113(6):e72-5, Armstrong E J, et al. Circulation 2006; 113(7):e152-5, Armstrong E J, et al. Circulation 2006; 113(9):e382-5, Armstrong E J, et al. Circulation 2006; 113(8):e289-92). Large scale gene expression studies comparing arteries with and without atherosclerotic lesions performed in the laboratory of Dr. Thomas Quertermous at the Stanford Reynolds Cardiovascular Center identified markers of inflammation as a significant subset of genes differentially expressed between the diseased and normal arterial tissues (King J Y, et al. Physiol Genomics 2005; 23(1):103-18, Tabibiazar R, et al. Physiol Genomics 2005; 22(2):213-26).

Unmet Clinical and Scientific Need

A major advancement in the fight against atherosclerosis would be the development of non-invasive diagnostic tests that can guide treatment decisions by (1) aiding in the diagnosis and assessing the extent of CAD in patients and (2) predicting the need for further intervention in patients before the condition progresses to an acute coronary event.

### SUMMARY OF THE INVENTION

This invention provides biomarkers, predictive models, kits, and methods of use for scoring a sample obtained from a mammalian subject. The score can be used to determine the presence, absence or extent of CAD in the subject. In one embodiment the models are derived using expression data associated with at least one, two, three, four, five, or more genes selected from groups of genes. In another embodiment, samples are scored by inputting into a model expression data for the same genes used to construct the model, obtaining the score by operation of a model-derived interpretation function on the input data, and outputting the score. In one embodiment the inputting and/or outputting comprises use of a computer system having an input device, a processor, memory, and an output device such as a monitor or a printer. In another embodiment, the scores are used to classify the samples. In one embodiment those groups of genes are S100A12, S100A8, S100A9, BCL2A1, and F5 (group A); XK, P62, and FECH (group B); TUBB2 (group C); IFNG, PDGFB, VSIG4, and TNF (group D); and CSF3R, TLR5, CD46, and NCF1 (group E). In another embodiment, those groups of genes are S100A12, S100A9, BCL2A1, TXN and CSTA (group I); OLIG1, OLIG2, ADORA3, CLC, and SLC29A1 (group II); DERL3, IGHA1, IKG@ (group III); and CBS, ARG1 (group IV). Genes within groups A-D are grouped together because their expression levels are highly correlated in samples obtained from control subjects and from subjects with CAD. Accordingly, in one embodiment, a model is generated using expression data for a subset of genes within a selected group. In another embodiment, the subset comprises a single gene within a selected group. In yet another embodiment, a model is generated using expression data for a plurality of genes within a selected group. In one embodiment, the plurality comprises all genes identified as belonging to the selected group. Genes in groups I, II, III, and IV are grouped together because their expression values are orthogonal. In one embodiment expression values of genes in each of groups I, II, and IV may be combined into a metagene. In one embodiment a model is generated by determining a metagene using expression data for some or all of the genes within a selected group. In one embodiment, the model provides an interpretation function which operates upon the gene expression data to generate a score which can be outputted (i.e., displayed, printed, or stored). In one embodiment the score is used to classify a sample associated with the gene expression data. In various embodiments of the invention, the predictive model may be (by way of example but not limitation) a partial least squares model, a logistic regression model, a linear regression model, a linear discriminant analysis model, or a tree-based recursive partitioning model. In yet other embodiments, samples are scored by inputting into a model expression data for the same genes used to construct the model, obtaining the score by operation of the model-derived interpretation function on the input data, and outputting the score. In still other embodiments, a sample is classified according to the score. In one embodiment the classification predicts the presence or absence of CAD. In another embodiment, the classification predicts the absence or severity of CAD.

In certain embodiments, a model is constructed using expression data for genes chosen from two groups. Exemplary group combinations are: AB, AC, AD, AE, CD, II IV, I IV, and I II.

In other embodiments, a model is constructed using expression data for genes chosen from three groups. Exemplary group combinations are: ABC, ABD, ACD, ACE, ADE, BCE, and I II IV.

In other embodiments, a model is constructed using expression data for genes chosen from four groups. Exemplary group combinations are: ABCD, ABDE, ABCE, ACDE and BCDE.

In other embodiments, a model is constructed using expression data for genes chosen from five groups: ABCDE.

In certain embodiments the gene expression data is derived from a blood sample. In another embodiment, the gene expression data is derived from RNA extracted from cells in a blood sample. In another embodiment, the RNA is extracted from leukocytes isolated from a blood sample.

In one embodiment, the gene expression data is derived using microarray hybridization analysis. In another embodiment, the gene expression data is derived using polymerase chain reaction analysis.

### BRIEF DESCRIPTION OF THE DRAWINGS AND TABLES

FIG. 1 is a heatmap showing results of expression values for markers that are differentially expressed in populations having CAD and normal controls.

FIG. 2 shows the comparison of RT-PCR results for selected markers obtained from two independent patient cohorts.

FIG. 3 is a graph illustrating ability to separate samples into disease severity categories using a simple algorithm based on summing expression values for selected markers.

FIG. 4 is a graph illustrating ability to separate samples into disease severity categories using average expression value of a set of 14 genes (CAPG, MGST1, CSPG2, ALOX5, VSIG4, NS5ATP13T, CD4, IL1RN, HP, CSF3R, CSF2RA, HK3, RNASE2, AND CREB5).

Table 1 is a list of 197 candidate genes identified by microarray analysis, literature searches and splice variants that were subjected to RT-PCR across samples from Cohorts 1 and 2, and exemplary primers and probe sequences used to quantify their expression.

Table 2 are the clinical characteristics of the samples from Cohort 1.

Table 3 is a list of 162 significant genes identified in the first microarray analysis.

Table 4 is a list of 107 significant genes identified in the second microarray analysis.

Table 5 is a list of 88 genes used in plate 1 of the RT-PCR screening of Example 4.

Table 6 is a list of 69 genes used in plate 2 of the RT-PCR screening of Example 4.

Table 7 is a list of 51 genes identified showing a p value of ≦0.05 across plates 1 and 2 RT-PCR screening of samples in Example 4.

Table 8 is a list of 41 genes identified showing a p value of ≦0.05 across plates 1 and 2 in initial RT-PCR screening of samples in Example 5.

Table 9 lists the clinical characteristics of the samples from Cohort 2.

Table 10 lists the disease classifications for the samples from Cohort 2.

Table 11 illustrates the performance of an exemplary disease severity model.

Table 12 lists preferred groups of covarying genes resulting from the model development.

Table 13 provides a summary of exemplary 5-gene component models.

Table 14 lists the mean control expression values of genes used to construct the exemplified models.

Table 15 provides a summary of additional exemplary 5-gene component models.

Table 16 provides a summary of exemplary 2-gene component models.

Table 17 provides a summary of exemplary 3-gene component models.

Table 18 provides summary statistics for the metagene model scores and their components.

Table 19 lists the genes identified in feasibility study for metagene models.

Table 20 provides the clinical demographics of 180 samples used for validation of metagene models experiment.

Table 21 provides the number of samples missing data for each in validation of metagene models experiment.

Table 22 provides the summary statistics for validation of metagene models experiment.

Table 23 provides results of primary and secondary ANOVA comparisons of disease categories.

Table 24 provides results of the primary and secondary Area Under the Curve (AUC) comparisons for two metagene models.

### DETAILED DESCRIPTION OF THE INVENTION

### Definitions

In general, terms used in the claims and the specification are intended to be construed as having the plain meaning understood by a person of ordinary skill in the art. Certain terms are defined below to provide additional clarity. In case of conflict between the plain meaning and the provided definitions, the provided definitions are to be used.

The term “acute coronary syndrome” encompasses all forms of unstable coronary artery disease.

The term “coronary artery disease” or “CAD” encompasses all forms of atherosclerotic disease affecting the coronary arteries.

The term “Cₜ” refers to cycle threshold and is defined as the PCR cycle number where the fluorescent value is above a set threshold. Therefore, a low Cₜ value corresponds to a high level of expression, and a high Cₜ value corresponds to a low level of expression.

The term “FDR” means to false discovery rate. FDR can be estimated by analyzing randomly-permuted datasets and tabulating the average number of genes at a given p-value threshold.

The term “highly correlated gene expression” refers to gene expression values that have a sufficient degree of correlation to allow their interchangeable use in a predictive model of coronary artery disease. For example, if gene x having expression value X is used to construct a predictive model, highly correlated gene y having expression value Y can be substituted into the predictive model in a straightforward way readily apparent to those having ordinary skill in the art and the benefit of the instant disclosure. Assuming an approximately linear relationship between the expression values of genes x and y such that Y=a+bX, then X can be substituted into the predictive model with (Y-a)/b. For non-linear correlations, similar mathematical transformations can be used that effectively convert the expression value of gene y into the corresponding expression value for gene x.

The term “mammal” encompasses both humans and non-humans and includes but is not limited to humans, non-human primates, canines, felines, murines, bovines, equines, and porcines.

The term “metagene” refers to a set of genes whose expression values are combined to generate a single value that can be used as a component in a predictive model (Brunet, J. P., et al. Proc. Natl. Acad. Sciences 2004; 101(12):4164-9).

The term “myocardial infarction” refers to an ischemic myocardial necrosis. This is usually the result of abrupt reduction in coronary blood flow to a segment of the myocardium, the muscular tissue of the heart. Myocardial infarction can be classified into ST-elevation and non-ST elevation MI (also referred to as unstable angina). Myocardial necrosis results in either classification. Myocardial infarction, of either ST-elevation or non-ST elevation classification, is an unstable form of atherosclerotic cardiovascular disease.

The term “obtaining a dataset associated with a sample” encompasses obtaining a set of data determined from at least one sample. Obtaining a dataset encompasses obtaining a sample, and processing the sample to experimentally determine the data. The phrase also encompasses receiving a set of data, e.g., from a third party that has processed the sample to experimentally determine the dataset. Additionally, the phrase encompasses mining data from at least one database or at least one publication or a combination of databases and publications.

The term “score is predictive of” means that a score provides a measure of the likelihood or probability of whatever follows the term.

### Informative Gene Groups

One embodiment of the present invention relates to biomarkers, predictive models, and their methods of use based on the discovery of five groups of informative genes, defined herein as A, B, C, D, and E. Gene group A includes S100A12, S100A8, S100A9, BCL2A1, and F5. Gene group B includes XK, P62, and FECH. Gene group C includes TUBB2. Gene group D includes IFNG, PDGFB, VSIG4, and TNF. Gene group E includes CSF3R, TLR5, CD46, and NCF1. The predictive models can be developed and used based on the expression value of gene(s) chosen from each of two, three, four or five of the clustered gene groups, A, B, C, D and E. Models can be developed and used based on selecting the groups as follows, and using one or more of the exemplified genes within the selected groups, or a gene whose expression is highly correlated with that of an exemplified gene. The combinations using genes from two groups are: AB, AC, AD, AE, BC, BD, BE, CD, CE, and DE. The combinations using genes from three groups are: ABC, ABD, ABE, ACD, ACE, ADE, BCD, BCE, BDE, and CDE. The combinations using genes from four groups are: ABCD, ABDE, ABCE, ACDE and BCDE. The invention may also be practiced using one or more genes from each of all five gene groups, A, B, C, D and E. Predictive models wholly or partially based on these combinations are expressly contemplated to be within the scope of the present invention.

Another embodiment of the present invention relates to biomarkers, predictive models, and their methods of use based on the discovery of three groups of informative genes, defined herein as I, II, and IV. Gene group I includes S100A12, S100A9, BCL2A1, TXN and CSTA. Gene group II includes OLIG1, OLIG2, ADORA3, CLC, and SLC29A1. Gene group IV includes CBS, ARG1. Predictive models can be developed and used based on the expression value of gene(s) chosen from one, two or three of the clustered gene groups. Alternatively or additionally, a predictive model can be developed and used based on a metagene developed from expression values of two or more genes within a gene groups. Models can be developed and used based on selecting the groups as follows, and using one or more of the exemplified genes within the selected groups or a metagene determined from the selected groups, or a gene whose expression is highly correlated with that of an exemplified gene. The combination using genes from two groups are: I II, I IV, and II IV. The invention may also be practiced using one or more genes or metagene of each of all three groups, I, II and IV. Predictive models wholly or partially based on these combinations are expressly contemplated to be within the scope of the present invention.

In addition to the specific, exemplary genes or sequences identified in this application by name, accession number, or sequence, included within the scope of the invention are all operable predictive models of CAD and methods for their use to score and optionally classify samples using expression values of variant sequences having at least 90% or at least 95% or at least 97% or greater identity to the exemplified sequences or that encode proteins having sequences with at least 90% or at least 95% or at least 97% or greater identity to those encoded by the exemplified genes or sequences. The percentage of sequence identity may be determined using algorithms well known to those of ordinary skill in the art, including, e.g., BLASTn, and BLASTp, as described in Stephen F. Altschul et al., J. Mol. Biol. 215:403-410 (1990) and available at the National Center for Biotechnology Information website maintained by the National Institutes of Health. As described below, in accordance with an embodiment of the present invention, are all operable predictive models and methods for their use in scoring and optionally classifying samples that use a gene expression measurement that is now known or later discovered to be highly correlated with the expression of an exemplary gene expression value in addition to or in lieu of that exemplary gene expression value. For the purposes of the present invention, such highly correlated genes are contemplated to be within the literal scope of the claimed inventions or alternatively encompassed as equivalents to the exemplary genes. Identification of genes having expression values that are highly correlated to those of the exemplary genes, and their use as a component of a predictive model is well within the level of ordinary skill in the art.

### EXAMPLES

### Example 1

### General Procedures Used to Identify and Validate Candidate Genes

Multiple approaches were used to identify and confirm the consistency of gene expression data for candidate genes whose expression pattern in peripheral blood cells may be correlated with the various stages of CAD. Gene expression measurements were made using RNA extracted from human blood samples. Two approaches were used: microarray analysis using a Whole Genome Chip (44K) available from Agilent Technologies, Inc., Santa Clara, Calif. in accordance with the manufacturer's instructions, and real time polymerase chain reaction (RT-PCR) analysis carried out on a model 7900 Fast Real-Time PCR instrument available from an Applied Biosystems, Inc., Foster City, Calif. used in accordance with the manufacturer's instructions. Candidate genes are those genes that are differentially expressed in patients having established CAD as compared to disease-free controls. An extensive literature search was also completed to identify genes expressed in peripheral blood cells that have been previously shown to be involved in various states of inflammation. Genes also were selected using knowledge-based and pathway/associative approaches. In addition, splice variants for a number of genes were considered and included as candidate genes.

A total of 261 of these genes were prioritized for analysis based primarily on how consistent and robust the marker gene signal was among the different studies and disease states.

In all, 197 candidates selected from the approaches listed above were subjected to TAQMAN™-based RT-PCR across samples from Cohorts 1 and 2, and are listed in Table 1. The sequences of the primers and probes used for the 197 assays are also included in Table 1.

### Example 2

### Identification of Candidate Genes from a First Cohort via Whole Genome Microarray Analysis

Samples were selected from a first cohort of patient samples. These patients had undergone cardiac catheterization and peripheral blood leukocyte samples from these patients had been prepared for RNA extraction. All samples were collected in CPT™ cell preparation tubes containing sodium citrate and total RNA was purified from the peripheral blood mononuclear cells. The samples represented various stages of CAD including: cases with single and multi-vessel disease and stable angina; single and multi-vessel disease and unstable angina and control subjects with no angiographic evidence of CAD. The clinical characteristics of this first cohort are found in Table 2.

Two microarray experiments were performed using the microarray chip described in Example 1.

### Array 1 Pilot Study

For the first microarray experiment, the samples selected from the first cohort were classified as either unstable, stable or control using the following guidelines where diseased is defined as ≧50% stenosis.

Unstable—32 samples—two or more diseased vessels including the left anterior descending artery (LAD) and the left circumflex artery (LCX) and a current indication of unstable angina or a myocardial infarction (MI) in the previous 24 hours.

Stable—18 samples—two or more diseased vessels including the LAD and the LCX, a current indication of unstable angina and no history of MI or of indications of unstable angina.

Stenotic—50 samples—all samples classified as Unstable or Stable.

Control—19 samples—0% stenosis in the LAD, LCX and right coronary artery (RCA) and no indication or history of stable angina, unstable angina, or MI.

To identify genes that were differentially expressed between types of samples, the dataset of genes identified by the first array was subjected to the following procedure which was performed with five pair-wise comparisons:
1. Genes were analyzed for quality control.
2. Y-linked genes were removed.
3. Identify genes correlated with experimental parameters (Non-parametric, p≦0.05).
4. Remove features showing significance with experimental parameters.
5. Identify genes that are differentially expressed 1.3 fold between the two classifications being compared in the pair being analyzed.
6. The genes identified in step 5 were tested for significance using a non-parametric method, Mann-Whitney, where p is ≦0.01 with no multiple testing correction applied.

The five pair-wise comparisons that were made using the above method were: (1) Unstable (N=32) v. Stable (N=18); (2) Unstable (N=32) v. Control (N=19); (3) Stable (N=18) v. Control (N=19); (4) MI (N=7) v. Control (N=19); and (5) Stenotic (N=24) v. Control (N=19).

This analysis yielded 162 significant genes listed in Table 3.

### Array 2 Pilot Study

For the second microarray experiment, the samples were classified as either unstable, stable or control using the following guidelines, wherein a major vessel is one of the LAD, LCX or RCA:

Unstable—13 samples—either ≧70% stenosis in one major vessel or ≧50% stenosis in two or more vessels and current indication of unstable angina.

Stable—14 samples—either ≧70% stenosis in one major vessel or ≧50% stenosis in two or more vessels; current indication of stable angina and no histories or current indications of MI or of unstable angina

Control—14 samples—no disease in any of the LAD, LCX or RCA, no indication or history of unstable angina, no history of MI, and no indication of stable angina.

To identify genes that were differentially expressed between types of samples, the dataset of genes identified by the second array was subjected to the following procedure which was performed with three pair-wise comparisons:
1. Genes were analyzed for quality control.
2. Y-linked genes were removed.
3. Genes that were differentially expressed 1.5 fold between the two classifications being compared in the pair being analyzed.
4. The genes identified in step 3 were tested for significance using a non-parametric method, Mann-Whitney, where p is ≦0.01 with no multiple testing correction applied.

The three pair-wise comparisons that were made using the above method were: (1) Unstable (N=13) v. Stable (N=14); (2) Unstable (N=13) v. Control (N=14); and (3) Stable (N=14) v. Control (N=14).

This analysis yielded 107 significant genes listed in Table 4.

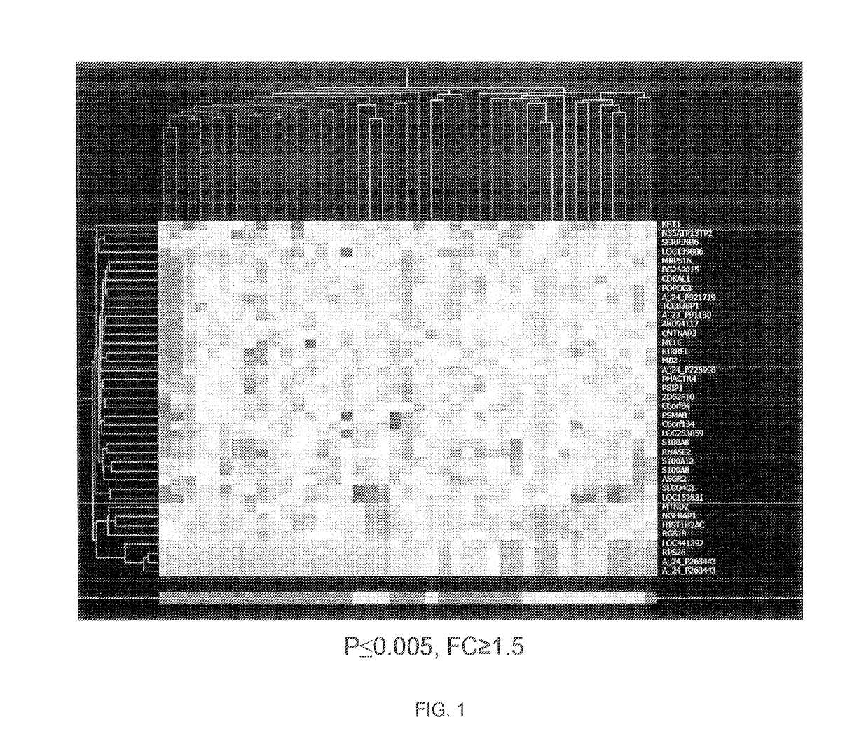

FIG. 1 is a heatmap that graphically illustrates differential expression of a subset of genes (listed on right side of Figure), in control v. disease samples. Expression values for individual patient samples are found in separate columns. Dark (red) squares correspond to genes that are overexpressed in disease state; Light (green) squares correspond to genes that are underexpressed in disease state. Dark (red) lines leading to columns correspond to samples from patients known to have disease; light (green) lines correspond to samples from disease-free control patients. Dendrograms illustrate degree of correlation of gene expression within samples (left side of figure), and across samples (top of figure). Bottom bar provides summary of ability of exemplified genes to segregate samples into disease (dark bar) and control (light bar) classes. Genes shown in heatmap have fold-expression change greater than or equal to 1.5 and p≦0.005.

### Example 3

### Pilot RT-PCR Experiment

RT-PCR studies were undertaken to determine the validity of the genes identified from the microarray analysis. The RT-PCR studies were completed on two ABI 7900 Real Time PCR systems using the default 40 cycle program. Data was exported using an ABI baseline setting at 0.2 and a background subtraction of cycles 3 through 15.

The first study was a pilot RT-PCR study to determine the false discovery rate (FDR) from both of the array experiments. 27 genes were selected from Array 1 for this pilot study: the initial 10 test were selected at random while the subsequent 17 were selected based on the lowest p values. Of these 27 genes, 16 had p values of ≦0.15 and were included in the set of 30 genes from Array 1 which would be included in the initial RT-PCR screening, with the remaining 14 genes being selected from genes showing lower p values on the array.

A similar strategy was employed for genes selected from Array 2 for the pilot study. Ten genes were selected for the pilot with 3 showing p values of ≦0.15. These 3 genes were included in the set of 30 from array 2 that would be included in the initial RT-PCR screening, with the remaining 27 genes being selected from genes showing lower p values on the array.

### Example 4

### Validation of Array-Identified Genes Using RT-PCR

An RT-PCR study of all of the samples of the first cohort was undertaken. The first study involved samples that had been part of the microarray studies.

To be included in the study, subjects had to be less than 100 years of age, with a normal white blood cell count (WBC) where normal was assessed according to normal range values for the laboratory where measured, and no history of inflammatory disease or treatment with anti-inflammatory medications. For the stable and unstable groups patients were included with CAD defined as ≧50% maximum stenosis in at least two vessels or ≧70% maximum stenosis in a single vessel. Patients in the control group showed 0% vessel stenosis by angiography in the LAD, LCX and RCA. Controls with a catheterization indication of stable angina or positive stress test were also required to show 0% stenosis in the left main coronary artery (L Main).

Samples were classified as follows:

Unstable—43 samples—positive catheterization indication of unstable angina but no history of heart failure. Histories of prior and/or current evolving MI, history of acute coronary syndrome (ACS) and history of previous re-vascularization, either by coronary artery bypass graft surgery (CABG) or a stent were permissible. Current vessel thrombus was also permissible, as well as patients with a current vessel re-stenosis if at least one other vessel showed stenosis ≧70% or progression in at least one vessel from a previous angiogram that was below intervention level at that catheterization.

Stable—28 samples—positive catheterization indication of stable angina, current catheterization was the first catheterization; but no current re-stenosis, thrombus, MI, and ACS and no histories of prior catheterization, re-vascularization (CABG or stent), re-stenosis or thrombus, MI, ACS or heart failure. An indication of a positive stress test was permissible.

Stenotic—81 samples—all samples classified as Unstable or Stable.

Control—24 samples—positive catheterization indication of either ‘stable angina,’ ‘positive stress test,’ or ‘other’ where ‘other’ was most often due to aortic valve stenosis or atypical symptoms. No current re-stenosis, thrombus, MI, ACS and no histories of re-vascularization (CABG or stent) re-stenosis, thrombus, MI, ACS, or heart failure. Previous catheterization if the prior catheterization also showed 0% stenosis in all vessels (L main, LAD, LCX, and RCA) was permissible.

The candidate genes were distributed across two 384-well plates. The first plate contained 88 genes: 30 from Array 1, 30 from Array 2, and 28 from the literature search. The genes from Arrays 1 and 2 were selected as indicated in the description of the pilot study. The 28 genes from the literature were picked either based on the number of citations or by mutual decision.

For each assay 2 ng (2 μl) of total cDNA was used in singleton and in each quadrant 1 well was reserved for a non-template control, 1 well for a PBMC control, 3 wells for the first normalization gene (RPL 19) and 3 wells for the second normalization gene (PRO1853). The 88 genes are listed in Table 5.

The second plate contained 69 genes that were assayed across, of which: 17 were from Array 1, 11 from Array 2, and 41 from the Literature. The 69 genes are listed in Table 6.

Data quality was assessed using an average correlation metric. For a given sample, the average correlation is the average of the pair-wise correlations of that sample to each other sample. Samples with less than 92% average correlation were considered to be outliers and so were excluded from further analysis. Cₜ values were normalized by the geometric mean of RPL18 and PRO. Normalized Cₜ values were analyzed using a robust linear model (P. J. Huber (1981) Robust Statistics. Wiley) to assess the association between disease status and gene expression. The FDR was estimated by analyzing randomly permuted datasets and tabulating the average number of genes at a given p-value threshold.

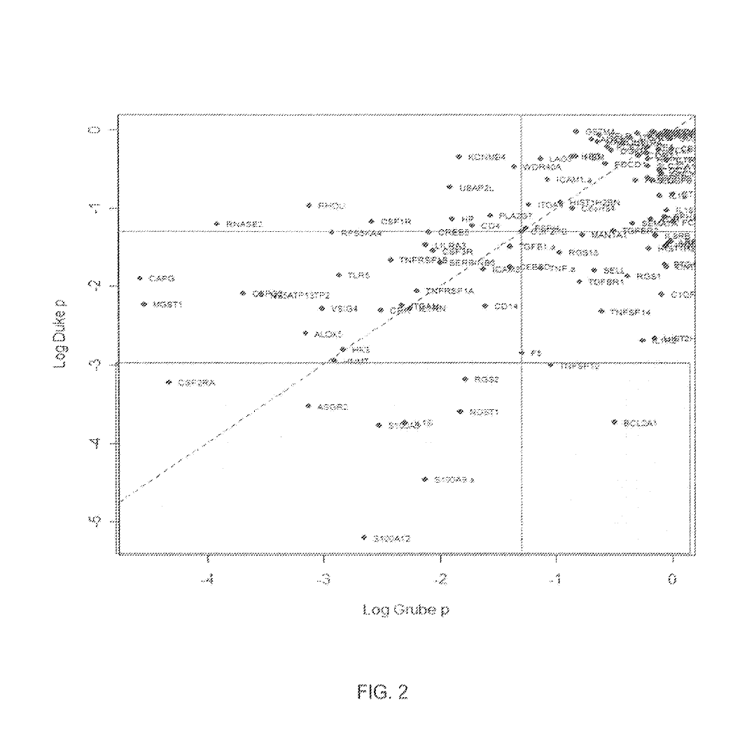

Pairwise comparisons between Stenotic (Stable or Unstable) and Control patients were made. 51 genes were identified that showed a p value of ≦0.05 across plates 1 and 2, using all samples (Table 7), see FIG. 2. Nucleotide sequences of the probes and primer pairs used in the RT-PCR assays for the genes listed in Tables 7 and 8 are provided in Table 1.

### Example 5

### Validation of Array-Identified Genes Using RT-PCR and Independent Samples

To be included in this analysis, the samples had to meet the same criteria as laid out for Example 4.

62 samples were run across the same assays as in Example 4. This validation cohort had the following breakdown: Stable=15; Unstable=26; and Control=21. 41 genes (Table 8) were identified (p value≦0.05) on plates 1 and 2, a sub-set of the 51 genes identified in Example 4. Nucleotide sequences of the probes and primer pairs used in the RT-PCR assays for the genes listed in Tables 8 are provided in Table 1.

### Example 6

### Genes that Predict CAD Severity

A second cohort (Cohort 2) was obtained that consisted of 252 samples collected from patients in a catheter lab between January 2001 and November 2005. At the time of catheter placement, whole blood was collected into PAXGENE™ tubes from PREANALYTIX™ and was subsequently stored at −20° C. RNA was purified from the samples using a column-based method specifically designed to isolate whole RNA for PAXGENE™ tubes. The clinical characteristics of Cohort 2 are provided in Table 9.

241 samples were selected from Cohort 2 and the extent of the associated CAD was classified as follows: None, Mild, Intermediate, Significant, and MVD (multi-vessel disease). The classification criteria and number of samples in each class are provided in Table 11. RT-PCR assays for 197 candidate genes were carried out for the selected samples using primers and probes provided in Table 1.

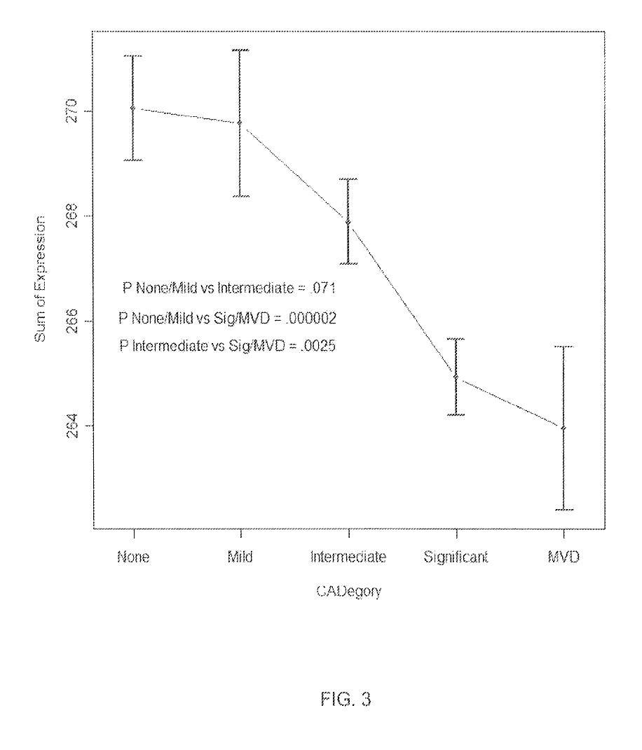

From data on the 241 samples, 10 genes were selected based on the criterion that the differential expression for case:control had a p≦0.001. These genes are: S100A9, S100A8, IL18, RGS2, NDST1, S100A12, ASGR2, CSF2RA, TNFSF10, and BCL2A1. See FIG. 2, shaded region. Each of these genes was determined to be overexpressed in case vs. control samples, and the degree of overexpression was found to correlate with the degree of disease severity. FIG. 3 provides the sum of expression values for each of these genes (shown as summed Cₜ values) as a function of disease severity (CADegory). A predictive model was developed by linear discriminant analysis using the summed expression values. In this model, samples are assigned to classes by estimating the means and variances within each class and then calculating which class mean is closest to the summed expression value obtained for an individual sample. The performance of the disease severity model is illustrated in Table 11, below.

TABLE 11
Performance of disease severity model.

Actual Disease Category

| | | 1 | 2 | 3 | 4 | 5 |
|---|---|---|---|---|---|---|
| Predicted Disease | 1 | 17 | 5 | 11 | 10 | 3 |
| Category | 2 | 8 | 7 | 12 | 10 | 3 |
| | 3 | 6 | 1 | 18 | 9 | 4 |
| | 4 | 2 | 4 | 9 | 25 | 7 |
| | 5 | 6 | 0 | 12 | 16 | 9 |

### Example 7

### Gene Clustering and Model Development

Modeling was performed using a modified forward stepwise logistic regression procedure (Hastie, T, et al. The Elements of Statistical Learning. 2001, Springer). In step 1, univariate logistic regressions were run for each gene. The most significant genes were clustered. If a cluster with high internal correlation (target of >0.70 within-cluster correlation coefficient) could be identified, then the genes from that cluster were selected for step 1. If a high correlation cluster could not be identified, the top individual gene was selected. For step 2, logistic regression models were again run for each gene, but the models included the most significant gene from the step 1-selected cluster. In this way, the step 2 analysis is adjusted for the step 1 gene. From the logistic regression of step 2, the top significant genes were clustered, and the best cluster or best gene selected. Step 3 then included the best gene from step 1 and the best gene from step 2. The process was repeated until no additional genes were identified in a particular step.

The resulting genes and clusters are shown in Table 12. In general, the best predictive model that uses only one gene is based on a Group A gene, the best predictive model that uses two genes includes a Group A and a Group B gene, etc. For full models (those that use a gene from each of the five groups), each gene is generally independently significant, although for some permutations of the choices not all five genes will have a p value of ≦0.05. As one of ordinary skill will recognize, informative predictive models also can be generated using one or more metagenes derived from one or more of the disclosed Groups.

Predictive models were developed using the genes that had been clustered into Groups A, B, C, D, and E. Different models were developed based upon varying combinations of groups. Groups of genes were selected and logistic regression was used to generate coefficients and intercepts that define the models. Exemplary models are provided below in Tables 13, and 15-17. In these Tables, the model coefficients for a given gene are identified under the column labeled “Estimate.” Model performance characteristics, Sensitivity (Sens), Specificity (Spec), and Area Under the Curve (AUC) also are provided. The reported classification model accuracy was based on a leave-one-out cross-validation. The classification area under the curve (AUC) and associated confidence interval were based on Somer's Dxy rank correlation of model prediction scores to disease status. (Newson R: Confidence intervals for rank statistics: Somer's D and extensions. Stata Journal 6:309-334; 2006.) All analysis was performed in R. Table 13 provides representative models that use a single gene from each of Groups A, B, C, D, and E. These alternative models illustrate the use of highly-correlated gene expression values as alternative inputs for model development and scoring. Note that the performance of the model is not materially affected by the substitution of one highly-correlated gene by another.

TABLE 13
Exemplary 5-component gene models (Groups A, B, C, D, and E)

| | Model Coefficient Estimates and Significance | | | | | | | |
|---|---|---|---|---|---|---|---|---|
| Model | | Estimate | Std. Error | z-value | Pr(>\|z\|) | Sens | Spec | AUC |
| 1 | (Intercept) | 51.1126 | 19.2554 | 2.654 | 0.00794 | 84/96 | 33/55 | .80 |
| | CDXR0056.S100A12 | −1.3705 | 0.3197 | −4.287 | 1.81e−05 | (88%) | (60%) | |
| | CDXR0198.XK | −0.6359 | 0.3007 | −2.115 | 0.03446 | | | |
| | CDXR0281.TUBB2 | 0.2703 | 0.1022 | 2.646 | 0.00814 | | | |
| | CDXR0085.PDGFB | −0.8700 | 0.3595 | −2.420 | 0.01552 | | | |
| | CDXR0235.CSF3R | 0.7827 | 0.3548 | 2.206 | 0.02738 | | | |
| 2 | (Intercept) | 49.4885 | 17.3336 | 2.855 | 0.00430 | 82/96 | 30/55 | .82 |
| | CDXR0056.S100A12 | −1.3300 | 0.3000 | −4.433 | 9.28e−06 | (85%) | (55%) | |
| | CDXR0002.FECH | −0.6534 | 0.2901 | −2.252 | 0.02432 | | | |
| | CDXR0281.TUBB2 | 0.3131 | 0.1063 | 2.946 | 0.00322 | | | |
| | CDXR0151.TNF | −1.0528 | 0.3799 | −2.771 | 0.00559 | | | |
| | CDXR0235.CSF3R | 0.7844 | 0.3258 | 2.408 | 0.01605 | | | |
| 3 | (Intercept) | 61.83577 | 17.99991 | 3.435 | 0.000592 | 81/96 | 31/55 | .80 |
| | CDXR0020.S100A9 | −1.69261 | 0.45318 | −3.735 | 0.000188 | (84%) | (56%) | |
| | CDXR0002.FECH | −0.81269 | 0.27969 | −2.906 | 0.003665 | | | |
| | CDXR0281.TUBB2 | 0.22212 | 0.09957 | 2.231 | 0.025694 | | | |
| | CDXR0085.PDGFB | −1.05396 | 0.34412 | −3.063 | 0.002193 | | | |
| | CDXR0406.TLR5 | 0.78195 | 0.40370 | 1.937 | 0.052752 | | | |
| 4 | (Intercept) | 45.6062 | 16.7634 | 2.721 | 0.006517 | 80/96 | 31/55 | .79 |
| | CDXR0181.BCL2A1 | −1.5347 | 0.4317 | −3.555 | 0.000378 | (83%) | (56%) | |
| | CDXR0198.XK | −0.6300 | 0.2781 | −2.266 | 0.023473 | | | |
| | CDXR0281.TUBB2 | 0.2581 | 0.1019 | 2.534 | 0.011290 | | | |
| | CDXR0079.IFNG | −0.3410 | 0.2203 | −1.548 | 0.121553 | | | |
| | CDXR0235.CSF3R | 0.7852 | 0.3829 | 2.051 | 0.040298 | | | |
| 5 | (Intercept) | 44.1947 | 16.3594 | 2.701 | 0.0069 | 83/96 | 32/55 | .79 |
| | CDXR0056.S100A12 | −1.4848 | 0.3366 | −4.412 | 1.03e−05 | (86%) | (58%) | |
| | CDXR0011.p62 | −0.6345 | 0.3134 | −2.025 | 0.0429 | | | |
| | CDXR0281.TUBB2 | 0.2528 | 0.1001 | 2.524 | 0.0116 | | | |
| | CDXR0119.VSIG4 | −0.4531 | 0.2343 | −1.933 | 0.0532 | | | |
| | CDXR0406.TLR5 | 0.6710 | 0.3624 | 1.852 | 0.0641 | | | |

To score a sample using the predictive models, the expression values for each gene included in the model is multiplied by its corresponding coefficient estimate. The resulting values are summed and the intercept is added. For the exemplified models, classification is accomplished as follows. Samples having a score >0 are classified as disease samples, while those having a score <0 are classified as normal samples. Based upon the classification of the cohort used to construct the model, a disease classification corresponds to significant or multi-vessel disease states, while a normal classification corresponds to no disease, mild disease, or intermediate disease. As will be apparent to one of ordinary skill, the threshold value of 0 is not limiting, and other threshold values may be used. In some instances, it may be necessary to scale expression data prior to using the expression values with the provided exemplary model coefficients. Data scaling is well within the level of ordinary skill in the art. One exemplary scaling method is based on obtaining gene expression values for a number of control samples and multiplication of those values by a factor whose magnitude is selected so as to scale those values to match the mean gene expression values for controls used to construct the exemplary models. Mean gene expression values for controls used to construct the exemplary models are provided in Table 14, below:

TABLE 14
Mean gene expression values

| Gene | Mean Control Expression Value |
|---|---|
| CDXR0056.S100A12 | 25.90 |
| CDXR0020.S100A9 | 21.42 |
| CDXR0069.S100A8 | 23.28 |
| CDXR0181.BCL2A1 | 30.02 |
| CDXR0076.F5 | 32.23 |
| CDXR0198.XK | 28.56 |
| CDXR0011.p62 | 27.97 |
| CDXR0002.FECH | 25.69 |
| CDXR0281.TUBB2 | 26.58 |
| CDXR0085.PDGFB | 32.19 |
| CDXR0151.TNF | 28.50 |
| CDXR0119.VSIG4 | 32.38 |
| CDXR0079.IFNG | 34.35 |
| CDXR0235.CSF3R | 29.59 |
| CDXR0406.TLR5 | 29.58 |
| CDXR0356.CD46 | 28.10 |
| CDXR0266.NCF1 | 24.36 |

### Example 7

### Alternative Five-Component Gene Models Developed Using Highly Correlated Group A Gene Expression Values

In this example, alternative five-component gene models (A, B, C, D, and E) are constructed by substituting different exemplary Group A genes while holding constant the Group B, C, D, and E genes. See Table 15. Note the model performance is not materially changed by the Group A substitutions.

TABLE 15
Additional representative 5 gene models

| | Model Coefficient Estimates and Significance | | | | | | | |
|---|---|---|---|---|---|---|---|---|
| Model | | Estimate | Std. Error | z-value | Pr(>\|z\|) | Sens | Spec | AUC |
| A.1 | (Intercept) | 51.1126 | 19.2554 | 2.6544 | 0.0079 | 84/96 | 33/55 | .80 |
| | CDXR0056.S100A12 | −1.3705 | 0.3197 | −4.2870 | 0.0000 | (88%) | (60%) | |
| | CDXR0198.XK | −0.6359 | 0.3007 | −2.1146 | 0.0345 | | | |
| | CDXR0281.TUBB2 | 0.2703 | 0.1022 | 2.6461 | 0.0081 | | | |
| | CDXR0085.PDGFB | −0.8700 | 0.3595 | −2.4201 | 0.0155 | | | |
| | CDXR0235.CSF3R | 0.7827 | 0.3548 | 2.2061 | 0.0274 | | | |
| A.2 | (Intercept) | 49.3952 | 18.5846 | 2.6579 | 0.0079 | 83/96 | 28/55 | .80 |
| | CDXR0020.S100A9 | −1.8547 | 0.4656 | −3.9831 | 0.0001 | (86%) | (51%) | |
| | CDXR0198.XK | −0.6736 | 0.2889 | −2.3316 | 0.0197 | | | |
| | CDXR0281.TUBB2 | 0.2170 | 0.0959 | 2.2629 | 0.0236 | | | |
| | CDXR0085.PDGFB | −0.9619 | 0.3395 | −2.8330 | 0.0046 | | | |
| | CDXR0235.CSF3R | 1.1693 | 0.4177 | 2.7992 | 0.0051 | | | |
| A.3 | (Intercept) | 47.0544 | 18.9156 | 2.4876 | 0.0129 | 84/96 | 28/55 | .78 |
| | CDXR0069.S100A8 | −1.1401 | 0.3006 | −3.7930 | 0.0001 | (88%) | (51%) | |
| | CDXR0198.XK | −0.6411 | 0.2874 | −2.2305 | 0.0257 | | | |
| | CDXR0281.TUBB2 | 0.2574 | 0.0971 | 2.6502 | 0.0080 | | | |
| | CDXR0085.PDGFB | −0.8716 | 0.3392 | −2.5696 | 0.0102 | | | |
| | CDXR0235.CSF3R | 0.6388 | 0.3419 | 1.8683 | 0.0617 | | | |
| A.4 | (Intercept) | 52.6083 | 18.5979 | 2.8287 | 0.0047 | 83/96 | 30/55 | .79 |
| | CDXR0181.BCL2A1 | −1.6366 | 0.4211 | −3.8866 | 0.0001 | (86%) | (54%) | |
| | CDXR0198.XK | −0.5971 | 0.2765 | −2.1592 | 0.0308 | | | |
| | CDXR0281.TUBB2 | 0.2265 | 0.0972 | 2.3296 | 0.0198 | | | |
| | CDXR0085.PDGFB | −0.5835 | 0.3578 | −1.6306 | 0.1030 | | | |
| | CDXR0235.CSF3R | 0.8860 | 0.3794 | 2.3350 | 0.0195 | | | |
| A.5 | (Intercept) | 47.5468 | 18.2751 | 2.6017 | 0.0093 | 80/96 | 32/55 | .78 |
| | CDXR0076.F5 | −1.2369 | 0.3403 | −3.6348 | 0.0003 | (83%) | (58%) | |
| | CDXR0198.XK | −0.4397 | 0.2686 | −1.6371 | 0.1016 | | | |
| | CDXR0281.TUBB2 | 0.2111 | 0.0944 | 2.2366 | 0.0253 | | | |
| | CDXR0085.PDGFB | −0.7332 | 0.3371 | −2.1751 | 0.0296 | | | |
| | CDXR0235.CSF3R | 0.7699 | 0.3514 | 2.1912 | 0.0284 | | | |

### Example 8

### Exemplary Two-Component Gene Models

In this example, different two-component gene models were constructed. See Table 16. The groups used to construct the model are listed under the column heading “Model,” the identities of the exemplary genes selected from the included groups are provided in the second column, and the model performance characteristics are provided in the last three columns. Note that informative models can be developed using a variety of two-component combinations.

TABLE 16
Representative 2 gene models

| | Model Coefficient Estimates and Significance | | | | | | | |
|---|---|---|---|---|---|---|---|---|
| Model | | Estimate | Std. Error | z-value | Pr(>\|z\|) | Sens | Spec | AUC |
| A/B | (Intercept) | 45.4259 | 10.7756 | 4.2156 | 0.0000 | 84/96 | 26/55 | .75 |
| | CDXR0056.S100A12 | −1.2254 | 0.2652 | −4.6212 | 0.0000 | (88%) | (47%) | |
| | CDXR0198.XK | −0.4748 | 0.2402 | −1.9765 | 0.0481 | | | |
| A/C | (Intercept) | 22.4999 | 6.8506 | 3.2843 | 0.0010 | 83/96 | 27/55 | .76 |
| | CDXR0056.S100A12 | −1.0510 | 0.2535 | −4.1466 | 0.0000 | (86%) | (49%) | |
| | CDXR0281.TUBB2 | 0.1819 | 0.0881 | 2.0648 | 0.0389 | | | |
| A/D | (Intercept) | 45.5623 | 11.0084 | 4.1389 | 0.0000 | 83/96 | 25/55 | .75 |
| | CDXR0056.S100A12 | −0.9545 | 0.2427 | −3.9325 | 0.0001 | (86%) | (45%) | |
| | CDXR0085.PDGFB | −0.6454 | 0.2983 | −2.1637 | 0.0305 | | | |
| A/E | (Intercept) | 18.3254 | 7.6860 | 2.3843 | 0.0171 | 81/96 | 27/55 | .75 |
| | CDXR0056.S100A12 | −1.2875 | 0.2852 | −4.5135 | 0.0000 | (84%) | (49%) | |
| | CDXR0235.CSF3R | 0.5121 | 0.2714 | 1.8872 | 0.0591 | | | |
| C/D | (Intercept) | 18.9900 | 9.3905 | 2.0222 | 0.0432 | 85/96 | 17/55 | .69 |
| | CDXR0085.PDGFB | −0.7324 | 0.2782 | −2.6323 | 0.0085 | (89%) | (31%) | |
| | CDXR0281.TUBB2 | 0.1842 | 0.0825 | 2.2333 | 0.0255 | | | |

### Example 9

### Exemplary 3—Component Gene Models

In this example, different three-component gene models were constructed. See Table 17. The groups used to construct the model are listed under the column heading “Model,” the identities of the exemplary genes selected from the included groups are provided in the second column, and the model performance characteristics are provided in the last three columns. Note that informative models can be developed using a variety of three-component combinations.

TABLE 17
Representative 3 gene models

| | Model Coefficient Estimates and Significance | | | | | | | |
|---|---|---|---|---|---|---|---|---|
| Model | | Estimate | Std. Error | z-value | Pr(>\|z\|) | Sens | Spec | AUC |
| A/B/C | (Intercept) | 43.7708 | 11.2164 | 3.9024 | 0.0001 | 81/96 | 30/55 | .77 |
| | CDXR0056.S100A12 | −1.2626 | 0.2831 | −4.4595 | 0.0000 | (84%) | (54%) | |
| | CDXR0198.XK | −0.5995 | 0.2545 | −2.3556 | 0.0185 | | | |
| | CDXR0281.TUBB2 | 0.2285 | 0.0957 | 2.3892 | 0.0169 | | | |
| A/B/D | (Intercept) | 75.3652 | 17.8660 | 4.2184 | 0.0000 | 80/96 | 32/55 | .78 |
| | CDXR0056.S100A12 | −1.1006 | 0.2605 | −4.2244 | 0.0000 | (83%) | (58%) | |
| | CDXR0198.XK | −0.6727 | 0.2700 | −2.4911 | 0.0127 | | | |
| | CDXR0085.PDGFB | −0.8595 | 0.3406 | −2.5233 | 0.0116 | | | |
| A/C/D | (Intercept) | 30.1328 | 8.3948 | 3.5895 | 0.0003 | 82/96 | 28/55 | .78 |
| | CDXR0056.S100A12 | −0.8483 | 0.2398 | −3.5376 | 0.0004 | (85%) | (51%) | |
| | CDXR0281.TUBB2 | 0.2231 | 0.0913 | 2.4427 | 0.0146 | | | |
| | CDXR0079.IFNG | −0.4100 | 0.1885 | −2.1753 | 0.0296 | | | |
| A/C/E | (Intercept) | 7.4614 | 9.0569 | 0.8238 | 0.4100 | 85/96 | 29/55 | .78 |
| | CDXR0056.S100A12 | −1.4179 | 0.3139 | −4.5175 | 0.0000 | (89%) | (53%) | |
| | CDXR0281.TUBB2 | 0.2566 | 0.0970 | 2.6457 | 0.0082 | | | |
| | CDXR0235.CSF3R | 0.7580 | 0.2988 | 2.5372 | 0.0112 | | | |
| A/D/E | (Intercept) | 25.0824 | 8.8992 | 2.8185 | 0.0048 | 80/96 | 25/55 | .76 |
| | CDXR0056.S100A12 | −1.1272 | 0.2712 | −4.1554 | 0.0000 | (83%) | (45%) | |
| | CDXR0079.IFNG | −0.3735 | 0.1838 | −2.0320 | 0.0422 | | | |
| | CDXR0235.CSF3R | 0.5746 | 0.2777 | 2.0688 | 0.0386 | | | |
| B/C/D | (Intercept) | 33.0930 | 10.6572 | 3.1052 | 0.0019 | 76/96 | 27/55 | .74 |
| | CDXR0198.XK | −0.5951 | 0.2424 | −2.4555 | 0.0141 | (79%) | (49%) | |
| | CDXR0281.TUBB2 | 0.3215 | 0.0961 | 3.3465 | 0.0008 | | | |
| | CDXR0079.IFNG | −0.7123 | 0.1951 | −3.6508 | 0.0003 | | | |

### Metagene Models

### Example 10

### Feasibility Study

A feasibility study utilized clinical samples from patients in a catheter lab obtained between May 2001 and December 2001. An initial subset of 41 samples from this cohort (Cohort 3) comprising 27 cases with angiographically significant CAD and 14 controls without coronary stenosis were chosen for whole genome microarray analysis. This analysis performed on peripheral blood mononuclear cells (PBMC) yielded 526 genes with >1.3-fold differential expression (p<0.05) between cases and controls. RT-PCR was performed on the 50 most significant microarray genes and 56 additional literature genes in a second independent subset of 95 subjects (63 cases, 32 controls) from Cohort 3. The RT-PCR analysis yielded 14 genes with p<0.05 that independently discriminated CAD state in multivariate analysis including clinical and demographic factors.

### Example 11

### Validation of the Feasibility Study-Identified Genes Using RT-PCR and Independent Samples

A fourth cohort (Cohort 4) of 757 samples was obtained from a catheter lab different from that of Cohort 3. Blood samples were collected from sequential patients undergoing cardiac catheterization between August 2004 and February 2007. Whole blood was collected via 50 ml syringe from the femoral arterial sheath at the start of each case (prior to patient heparinization) and dispensed into 2.5 ml PAXGENE™ tubes, processed according to manufacturer's instructions, and subsequently stored at −80° C.

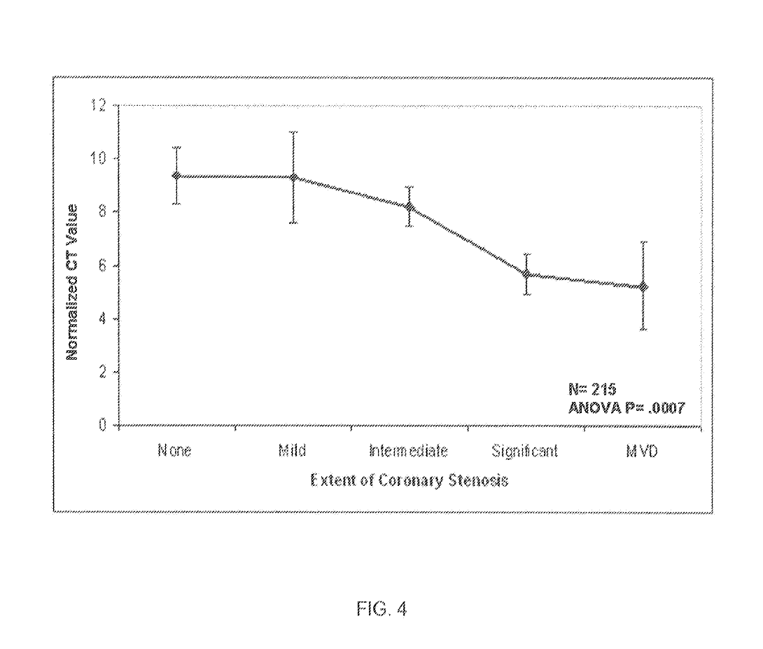

From Cohort 4, a subset of 215 patients (Set 1) was selected for RT-PCR-based replication. The CAD severity for these patients was prospectively divided into five angiographically defined categories (none, mild, intermediate, significant, and multi vessel disease (MVD)) based on luminal diameter stenosis as shown in Table 18. These categories were designed to discriminate clinically significant subgroups (e.g. significant obstructive disease and multi-vessel disease). Thresholds between categories were chosen to correspond to stenosis values listed in the Duke Information System for Cardiovascular Care (DISCC) clinical database in which all lesions are coded using one of the following % stenosis values: 100%, 95%, 75%, 50%, 25% and <25%. A case:control subset of 107 patients (86 cases, 21 controls) replicated 11 of the 14 significant genes from Cohort 3. The 11 replicated genes are NS5ATP13T, CAPG, CSPG2, MGST1, CSF2RA, HK3, ALOX5, VSIG4, IL1RN, CSF3R, and CREB5. Using these 5 categories, an analysis of the 14 significant genes in the entire set of 215 patients demonstrated that gene expression was proportional to maximal coronary artery stenosis (p<0.001 by ANOVA) as shown in FIG. 4. The normalized cycle threshold values for the 14 genes (CAPG, MGST1, CSPG2, ALOX5, VSIG4, NS5ATP13T, CD4, IL1RN, HP, CSF3R, CSF2RA, HK3, RNASE2, AND CREB5) were summed for each patient and a constant of 375 subtracted to normalize the data. For each disease category, the means and standard errors are shown in FIG. 4. Paired t tests analysis: none and mild disease versus intermediates (P=not significant), intermediate versus significant and multivessel disease (P=0.006), none and mild disease versus significant and multivessel disease (P=0.0004). Single-value ANOVA with linear trend for the 5 group comparison is P=0.0003. From these results it appears that gene expression in peripheral blood gene expression cells reflects the presence clinically significant CAD in patients undergoing invasive coronary angiography.

TABLE 18
CAD category for Cohort 4, Set 1

| | | | |
|---|---|---|---|
| Group 1 | Control | None | undetectable or 0% |
| | | | Stenosis |
| Group 2 | Control | Minimal Stenosis | <25% in a major vessel |
| | | | or <50% in a small |
| | | | vessel |
| Group 3 | Intermediate | Intermediate Stenosis | ≧25% and <75% in a |
| | | | major vessel |
| Group 4 | Case | Significant | ≧ one major vessel |
| | | | stenosis ≧75% or left |
| | | | main stenosis ≧50% |
| Group 5 | Case | Multi-Vessel | Three major vessel |
| | | | stenosis ≧75%, with left |
| | | | main stenosis ≧75% |
| | | | counting as two vessels |

### Example 12

### Feasibility Study for Development of Metagene Models

The RNA from the Cohort 4 samples was purified and subjected to both quantitative (Ribogreen, Molecular Probes, Eugene, Oreg.) and qualitative (Agilent Bioanalyzer) analysis. Genomic DNA contamination was assessed by RT-PCR on RPL28 in the absence of reverse transcriptase. Samples showing genomic contamination underwent DNaseI treatment (Ambion, Austin, Tex., PN#AM1906) and re-testing. RNA was then converted to cDNA using Applied Biosystems High Capacity cDNA Archive Kit (AB1, Foster City, Calif., PN#4322171). cDNA was stored at −20° C. until use.

RT-PCR assays used TAQMAN™ MGB probes. Target sequences were masked for SNPs, via BLAST against dbSNP prior to primer and probe design. Amplification efficiency was evaluated using a PBMC cDNA standard curve, and amplicon identity (size) and specificity by gel-electrophoresis. Assays contained 8 μl assay mix (250 nM probe, 900 nM each primer) plus Master Mix and 2 ng cDNA in 2 μl, for a total of 10 μl For each target gene, samples were assayed once per plate. Two normalization genes with the lowest standard deviations across all were included in triplicate for each sample. Plates containing assay mix were stored at −20° C. Complete assay plates were sealed, centrifuged and subjected to RT-PCR using ABI suggested cycling parameters. Data were exported using a 0.2 threshold, with 3-15 cycles as baseline.

Set 1 of Cohort 4 were run on whole transcriptome microarrays. From this experiment, 168 genes, shown in Table 19, were selected for technical validation via RT-PCR with genes showing significance by RT-PCR as well as meeting the following criteria:

1) Non-correlation with previously identified genes. Genes were chosen that had an r² of <0.75 with genes chosen for the first metagene model.
2) Biological significance. Genes were chosen that appeared to play a role in relevant biological pathways such as inflammation, atherosclerosis, etc.
3) Statistical significance. Genes were chosen with p values <0.05.
4) Low Cₜ value. Genes were chosen with Cₜs that tended to be less than 30 and which displayed low SD within groups.
5) Expression pattern. Genes were chosen that displayed a monotonic change in Cₜs in going from CAD class 1 to CAD class 5.
6) Correlation with other genes. Genes were chosen that met criteria #1, and showed correlation (r²>0.75) with other genes in the set, preferably genes that also met criteria 2 through 5.

Preliminary analysis of these data suggested that genes that classified patients with respect to the extent of coronary disease were dependent on diabetic status. Development of the metagene model focused on non-diabetic patients who represent about 66% of Cohort 4.

### Example 13

### A First Metagene Model

A first metagene algorithm was derived based on findings that S100A12, and genes highly correlated to it, were excellent predictors of the extent of maximum coronary artery stenosis. S100A12 is a member of the group A, described above in Example 7, see also Table 12. The model was comprised of a set of five genes that had both high correlation to S100A12 (r²>0.70) and a significant association with CAD (p<0.0001). Those genes are S100A12, S100A9, BCL2A1, TXN and CSTA. Principal components analysis (PCA) was used to examine the correlation structure of these genes. The first PCA component can be approximated by the mean of the genes, therefore, the mean of the five genes was used as the main predictor for the model.

A regression model was fit, using CAD category as shown in Table 18 as the outcome variable and the 5 gene mean, metagene I (“MI”), as the independent variable. In the two prior studies, RPL28 was found to be the best candidate normalization gene. Each plate was run with three replicate RPL28 assays and then a second model was fit where the median RPL28 was used as a predictor. This model was found to be significantly better than the model with only MI, and was therefore chosen to be the basis of the first metagene model.

### Metagene Model 1 Score=Algorithm 1=20.4994−1.0386*MI+0.4774*n1

MI=metagene I=average Cₜ of the group I genes (S100A12, S100A9, BCL2A1, TXN and CSTA)
n1=median Cₜ of the three RPL28 replicates

### Example 14

### A Second Metagene Model

Candidate classifier genes for the second metagene model were derived from analyzing candidate genes from one prior study for the same characteristics as described for Example 12.

CAD category, as described in Table 18, was again the outcome variable for second metagene model. Four metagenes, MI (S100A12, S100A9, BCL2A1, TXN and CSTA), MH (OLIG1, OLIG2, ADORA3, CLC, and SLC29A1), MIII (DERL3, BCO32451, and IGHA1), and MIV (CBS, ARG1), were selected from the PCR results from Set 1 of Cohort 4 based on factors such as disease association and biological plausibility. These metagenes served as the independent predictors in model development. For each meta gene the mean Cₜ value across the genes within the meta gene was used. The PCA weights were nearly identical within each meta gene. A regression model was fit, using CAD categories 1 through 5 (as in Table 18) as the outcome variable and the 4 metagenes as the independent variables. This was used as the basis for the second metagene model. The coefficients in the model were found to be similar to coefficients from ridge regression or from a robust linear model.

### Metagene Model 2 Score=Algorithm 2=27.7782−0.7643*MI−0.3142*MII+0.3339*MIII−0.1596*MIV

MI=metagene I=average Cₜ of the following genes: S100A12, S100A9, BLC2A1, TXN, CSTA
MII=metagene II=average Cₜ of the following genes: OLIG1, OLIG2, ADORA3, CLC, SLC29A1
MIII=metagene III=average Cₜ of the following genes: DERL3, IGHA1, BCO32451
MIV=metagene IV=average Cₜ of the following genes: CBS, ARG1

### Example 15

### Validation of Metagene Models

An independent set of 273 samples from Cohort 4 (Set 2) were selected based on the following criteria:

### Inclusion Criteria:

Age 18 to 100 years.
Undergoing first cardiac catheterization.
Indication for catheterization is or includes ischemic heart disease.
Left ventricular ejection fraction ≧40%.
No prior history of coronary artery disease, myocardial infarction, coronary revascularization, congestive heart failure, or severe valve disease.
White blood count within normal lab range (<11×10³/mL) at the time of catheterization.

### Exclusion Criteria:

Indications for catheterization include congenital heart disease, cardiomyopathy or pericardial disease.
New York Heart Association classification >2.
Any major surgery, febrile illness, positive blood or urine cultures, antibiotic use or blood/blood product transfusion within the preceding two months.
Allergy to IV contrast agents requiring steroids.
When available any history of rheumatoid arthritis, gout, polymyalgia rheumatica, systemic lupus erythematosis, sarcoidosis, vasculitis, scleroderma, severe renal insufficiency (creatinine >3), thrombocytopenia, pancytopenia, myelodysplasia, chronic infectious disease (including HIV/AIDS, TB, hepatitis B or C, abscess), or any organ transplant.

Prior to any data analysis, a quality control check was completed to ensure that no major sample mislabeling had occurred during the process. This was completed by comparing the Y specific gene assay expression of CDXR0487.RPS4Y1 with the reported gender of the samples.

To determine the gene expression data quality, samples were assessed in a blinded manner to determine if any samples should be removed prior to the primary analysis. Samples with an average pair wise correlation less than the 2^{nd} percentile were flagged as outliers and excluded. This determination of outlier status was made while still blinded to any clinical characteristics of the samples.

In addition, an assessment of the Cₜ distributions for each gene was made also while still blinded to clinical characteristics of the samples. Individual gene Cₜ measurements greater than the 99^{th} percentile of a gene's Cₜ distribution was truncated at the 99^{th} percentile. Missing Cₜ values were imputed by conditional mean imputation using the non-missing genes as predictors for the first metagene model, and for the present genes for the relevant metagene for second metagene model.

Metagene models using Algorithms 1 and 2 were assessed as well as models utilizing combinations of metagenes I and II (Algorithm 2a), metagenes I and IV (Algorithm 2b), metagenes II and IV (Algorithm 2c) and metagenes I, II, and IV (Algorithm 2d). Each of the metagene models was assessed separately for the following primary endpoints:
Does the metagene model score significantly separate the three CAD categories none (1)/minimal (2), intermediate (3) and significant (4)/multi-vessel (5) non-diabetic coronary disease groups, with p<0.005, using ANOVA?
Does the metagene model score classify non-diabetic patients with an AUC significantly >0.5 in receiver operating characteristic (ROC) analysis (p<0.005), with retrospectively defined thresholds where intermediate patients are grouped alternately with:
   None/minimal disease patients;
   Multi-vessel/significant disease patients; and
   Excluded.

Each of the metagene models was also assessed separately for the following secondary endpoints:
Does the metagene model score significantly separate the none (1)/minimal (2), intermediate (3), and significant (4)/multi-vessel (5) disease groups by pairwise t-test (Tukey HSD multiple comparisons correction) using either all patients or the subset of stable patients?
Does the metagene model performance (scores, AUC) change if the RPL28 normalization term is included/excluded form the algorithm score?

Of the 201 non-diabetics in the study, 13 samples were excluded based on the clinical data and 2 samples were excluded based from laboratory QC. In addition we identified 2 samples that had a reported value for ‘Sex’ that was different from the gene expression indicated Sex (based on RPS4Y1 expression). The catheter lab confirmed that the sex of these samples may be incorrect. Both samples were excluded from the analysis, resulting in a sample size of 184. The protocol specified that the lower 2% of samples be excluded based on average correlation. Four samples were excluded based on this criteria. The final sample size for analysis was 180 samples. The demographics for these 180 samples are summarized in Table 20.

Per protocol, algorithm genes with missing values were imputed using conditional mean imputation based on observed expression values for other genes within the meta gene. Table 21 identifies the number of samples with missing data for each gene.

Summary statistics of this analysis are shown in Table 22.

Primary and secondary ANOVA comparisons are shown in Table 23. Four analyses were designated as primary, with a criteria for success of p<0.005. Three of the four ANOVA primary endpoints were significant at this level.

Results of primary and secondary AUC comparisons are shown in Table 24. Six of these analyses were designated as primary, with a criteria for success of p<0.005. Three of the six AUC primary endpoints were significant at this level.

For each of the models, 5 analyses (ANOVA, clinically adjusted ANOVA, and three AUC analyses) were defined. The analysis was initially performed for Algorithms 1 and 2 and in that analysis 10 analyses were being performed and therefore p<0.005 was used as the criteria for success. Both algorithms were prospectively validated using this p<0.005 threshold, with the first metagene model meeting this level of statistical significance for ⅗ endpoints and the second metagene model meeting this level for ⅘ endpoints. Some of the work described in the above working examples is published in Wingrove, Daniels et al. (2008), “Correlation of Peripheral-Blood Gene Expression With the Extent of Coronary Artery Stenosis,” Circ Cardiovasc Genet 1:31-38.

As can be seen from the results it was determined that expression values for individual genes, individual metagenes and combinations of metagenes are predictive for disease state.

### Reagents and Kits

It is also contemplated that the invention comprises reagents and kits to practice the method of the invention. A kit would comprise reagents to measure the expression values of a representative gene from a plurality of the Groups A-E. Such reagents comprise probes that are nucleotide sequences complementary to the RNA expressed by the genes whose expression values are to be determined. In one embodiment such probes are fixed onto a chip as a microarray. Alternatively, the probes are in plates for analysis by RT-PCR.

A representative kit comprises reagents to measure the expression value of two genes: one of S100A12, S100A8, S100A9, BCL2A1, and F5; and one of XK, P62, and FECH.

In the alternative, a kit comprises reagents to measure the expression value of three genes: TUBB2; one of IFNG, PDGFB, VSIG4, and TNF; and one of CSF3R, TLR5, CD46, and NCF1.

In yet another alternative, a kit comprises reagents to measure the expression value of five genes: one of S100A12, S100A8, S100A9, BCL2A1, and F5; one of XK, P62, and FECH; TUBB2; one of IFNG, PDGFB, VSIG4, and TNF; and one of CSF3R, TLR5, CD46, and NCF1.

In yet another alternative, a kit comprises the reagents to measure the expression value of genes in groups I, II, III, and IV, including reagents for measuring combinations and subcombinations described above.

In yet another alternative, a kit comprises the reagents to measure the expression value of gene components comprising one of metagene I, metagene II and metagene IV.

In yet another alternative, a kit comprises the reagents to measure the expression value of gene components comprising metagenes I, II, and IV.

In yet another alternative, a kit comprises the reagents to measure the expression value of gene components comprising metagenes I and II.

In yet another alternative, a kit comprises the reagents to measure the expression value of gene components comprising metagenes I and IV.

In yet another alternative, a kit comprises the reagents to measure the expression value of gene components comprising metagenes II and IV.

A representative kit may optionally comprise packaging, and/or instructions for use, and/or software useful for scoring a sample using a predictive model of the present invention. Such instructions may be provided in the kit. In the alternative, such instructions may be provided at a website address through which the user may access the instructions. When such instructions are provided in the kit, they may be provided in any number of formats. Such formats include, but are not limited, paper or computer-readable format, e.g., an ADOBE ACROBAT™ or MICROSOFT WORD™ on computer-readable medium, e.g., diskette or CD.

All publications, including scientific publications, references to gene sequences (including without limitation, references to accession numbers and gene names), issued patents, patent publications, and the like are hereby incorporated by reference in their entirety for all purposes. Accession numbers refer to the sequences available in the corresponding sequence database as of the filing date of this specification.

1. A method for scoring a sample from a mammalian subject, comprising:
obtaining a dataset associated with said sample, wherein said dataset comprises expression values of two, three, four or five of five genes, A, B, C, D and E wherein:
A is a member selected from the group consisting of S100A12, S100A8, S100A9, BCL2A1, and F5,
B is a member selected from the group consisting of XK, P62, and FECH,
C is TUBB2,
D is a member selected from the group consisting of IFNG, PDGFB, VSIG4, and TNF, and
E is a member selected from the group consisting of CSF3R, TLR5, CD46, and NCF1;
inputting said data into an interpretation function that uses said data to determine a score wherein said score is predictive of coronary artery disease; and
outputting said score.

2. The method of claim 1, further comprising classifying said sample according to said score.

3. The method of claim 2 wherein said classifying is predictive of the presence or absence of coronary artery disease in said mammalian subject.

4. The method of claim 2 wherein said classifying is predictive of the extent of coronary artery disease in said mammalian subject.

5. The method according to claim 1, wherein the interpretation function is a function produced by a predictive model selected from the group consisting of a partial least squares model, a logistic regression model, a linear regression model, a linear discriminant analysis model, and a tree-based recursive partitioning model.

6. The method according to claim 1, wherein said sample comprises peripheral blood cells.

7. The method according to claim 6, wherein said peripheral blood cells comprise isolated leukocytes.

8. The method according to claim 1, wherein said sample comprises RNA extracted from peripheral blood cells.

9. The method according to claim 1, wherein said gene expression values are derived from microarray hybridization data.

10. The method according to claim 1, wherein said gene expression values are derived from polymerase chain reaction data.

11. The method of claim 1 wherein said dataset comprises expression values of five genes, A, B, C, D and E wherein:
A is a member selected from the group consisting of S100A12, S100A8, S100A9, BCL2A1, and F5,
B is a member selected from the group consisting of XK, P62, and FECH,
C is TUBB2,
D is a member selected from the group consisting of IFNG, PDGFB, VSIG4, and TNF, and
E is a member selected from the group consisting of CSF3R, TLR5, CD46, and NCF1.

12. The method of claim 1 wherein said dataset comprises expression values of four of five genes, A, B, C, D and E wherein:
A is a member selected from the group consisting of S100A12, S100A8, S100A9, BCL2A1, and F5,
B is a member selected from the group consisting of XK, P62, and FECH,
C is TUBB2,
D is a member selected from the group consisting of IFNG, PDGFB, VSIG4, and TNF, and
E is a member selected from the group consisting of CSF3R, TLR5, CD46, and NCF1.

13. The method of claim 1 wherein said dataset comprises expression values of three of five genes, A, B, C, D and E wherein:
A is a member selected from the group consisting of S100A12, S100A8, S100A9, BCL2A1, and F5,
B is a member selected from the group consisting of XK, P62, and FECH,
C is TUBB2,
D is a member selected from the group consisting of IFNG, PDGFB, VSIG4, and TNF, and
E is a member selected from the group consisting of CSF3R, TLR5, CD46, and NCF1.

14. The method of claim 13 wherein said dataset comprises expression values of three genes, A, B and C wherein:
A is a member selected from the group consisting of S100A12, S100A8, S100A9, BCL2A1, and F5,
B is a member selected from the group consisting of XK, P62, and FECH, and
C is TUBB2.

15. The method of claim 13 wherein said dataset comprises expression values of three genes, A, B and D wherein
A is a member selected from the group consisting of S100A12, S100A8, S100A9, BCL2A1, and F5,
B is a member selected from the group consisting of XK, P62, and FECH, and
D is a member selected from the group consisting of IFNG, PDGFB, VSIG4, and TNF.

16. The method of claim 13 wherein said dataset comprises expression values of three genes, A, C and D wherein
A is a member selected from the group consisting of S100A12, S100A8, S100A9, BCL2A1, and F5,
C is TUBB2, and
D is a member selected from the group consisting of IFNG, PDGFB, VSIG4, and TNF.

17. The method of claim 13 wherein said dataset comprises expression values of three genes A, C and E wherein
A is a member selected from the group consisting of S100A12, S100A8, S100A9, BCL2A1, and F5,
C is TUBB2, and
E is a member selected from the group consisting of CSF3R, TLR5, CD46, and NCF1.

18. The method of claim 13 wherein said dataset comprises expression values of three genes A, D and E wherein
A is a member selected from the group consisting of S100A12, S100A8, S100A9, BCL2A1, and F5,
D is a member selected from the group consisting of IFNG, PDGFB, VSIG4, and TNF, and
E is a member selected from the group consisting of CSF3R, TLR5, CD46, and NCF1.

19. The method of claim 13 wherein said dataset comprises expression values of three genes, B, C and D wherein
B is a member selected from the group consisting of XK, P62, and FECH,
C is TUBB2, and
D is a member selected from the group consisting of IFNG, PDGFB, VSIG4, and TNF.

20. The method of claim 1 wherein said dataset comprises expression values of two of five genes, A, B, C, D and E wherein:
A is a member selected from the group consisting of S100A12, S100A8, S100A9, BCL2A1, and F5,
B is a member selected from the group consisting of XK, P62, and FECH,
C is TUBB2,
D is a member selected from the group consisting of IFNG, PDGFB, VSIG4, and TNF, and
E is a member selected from the group consisting of CSF3R, TLR5, CD46, and NCF1.

21. The method of claim 20 wherein said dataset comprises expression values of two genes, A and B, wherein
A is a member selected from the group consisting of S100A12, S100A8, S100A9, BCL2A1, and F5, and
B is a member selected from the group consisting of XK, P62, and FECH.

22. The method of claim 20 wherein said dataset comprises expression values of two genes, A and C, wherein
A is a member selected from the group consisting of S100A12, S100A8, S100A9, BCL2A1, and F5, and
C is TUBB2.

23. The method of claim 20 wherein said dataset comprises expression values of two genes, A and D, wherein
A is a member selected from the group consisting of S100A12, S100A8, S100A9, BCL2A1, and F5, and
D is a member selected from the group consisting of IFNG, PDGFB, VSIG4, and TNF.

24. The method of claim 20 wherein said dataset comprises expression values of two genes, A and E, wherein
A is a member selected from the group consisting of S100A12, S100A8, S100A9, BCL2A1, and F5, and
E is a member selected from the group consisting of CSF3R, TLR5, CD46, and NCF1.

25. The method of claim 20 wherein said dataset comprises expression values of two genes, C and D, wherein
C is TUBB2, and
D is a member selected from the group consisting of IFNG, PDGFB, VSIG4, and TNF.

26-42. (canceled)


SEQUENCE LISTING (672 sequences)

SEQ ID NO: 1 - DNA, 2261 bp, Homo sapiens
atctttgctgcaaaggctgggtatcggctgtgctcagcaaagcgtcaactcgtgcaagaacttagcaggaatagttctggctaaggttaggaggctgccaccaaagtctcttttttgttcctctgcttctcccgtttgcctccttatcatgagatctttttgctaagctggcagaaagattgcatagtcagtgcttccagctctgctcccacctgatcctgcactgtcctctggtccctgaatgaatgaactctgatacccaatcttgtctcgagccttctctatgccactcatggctcctcttctgctctttccatctttttgctgagagttctgagctctgtacttcctcttggcccatctcacttcctgaaacacccctgaagagggttgcttatcttgatggaactcaaaaagccaaaaagctgcaggcagaggcgttgaggacatctgtttggggaactaagagcagcagcactttcagattcagtccatatagagctgtcctacagcattctggaaacttgaggatgtgcggtgcataaaggggctggaagtgacccacctgtgatgagccctttctaaggagaagggtttccaagagatcaccccaccagaaaagggtaggaatgagcaagttgggaattttagactgtcactgcacatggacctctgggaagacgtctggcgagagctaggcccactggccctacagacggatcttgctggctcacctgtccctgtggaggttcccctgggaaggcaagatgcccaacaacagcactgctctgtcattggccaatgttacctacatcaccatggaaattttcattggactctgcgccatagtgggcaacgtgctggtcatctgcgtggtcaagctgaaccccagcctgcagaccaccaccttctatttcattgtctctctagccctggctgacattgctgttggggtgctggtcatgcctttggccattgttgtcagcctgggcatcacaatccacttctacagctgcctttttatgacttgcctactgcttatctttacccacgcctccatcatgtccttgctggccatcgctgtggaccgatacttgcgggtcaagcttaccgtcagatacaagagggtcaccactcacagaagaatatggctggccctgggcctttgctggctggtgtcattcctggtgggattgacccccatgtttggctggaacatgaaactgacctcagagtaccacagaaatgtcaccttcctttcatgccaatttgtttccgtcatgagaatggactacatggtatacttcagcttcctcacctggattttcatccccctggttgtcatgtgcgccatctatcttgacatcttttacatcattcggaacaaactcagtctgaacttatctaactccaaagagacaggtgcattttatggacgggagttcaagacggctaagtccttgtttctggttcttttcttgtttgctctgtcatggctgcctttatctatcatcaactgcatcatctactttaatggtgaggtaccacagcttgtgctgtacatgggcatcctgctgtcccatgccaactccatgatgaaccctatcgtctatgcctataaaataaagaagttcaaggaaacctaccttttgatcctcaaagcttgtgtggtctgccatccctctgattctttggacacaagcattgagaagaattctgagtagttatccatcagagatgactctgtctcattgaccttcagattccccatcaacaaacacttgagggcctgtatgcctgggccaagggatttttacatccttgattacttccactgaggtgggagcatctccagtgctccccaattatatctcccccactccactactctcttcctccacttcatttttcccttgtcctttctctctaattcagtgttttggaggcctgacttggggacaacgtattattgatattattgtctgttttccttcttcccaatagaagaataagtcatggagcctgaagggtgcctagttgacttactgacaaaaggctccagttgggctgaacatgtgtgtggtggtgactcatttccataccattgtggaattgagcagagaacctgctctcggaggatgcctaggagatgttgggaacagaaaaaataaactgagtttaagggggacttaaactgctgaattcacctgtggatgtttttgagtaaataaaagctaatagctaaaaaaaaaaaaaaaaaa

SEQ ID NO: 2 - protein, 318 aa, Homo sapiens
MPNNSTALSLANVTYITMEIFIGLCAIVGNVLVICVVKLNPSLQTTTFYFIVSLALADIAVGVLVMPLAIVVSLGITIHFYSCLFMTCLLLIFTHASIMSLLAIAVDRYLRVKLTVRYKRVTTHRRIWLALGLCWLVSFLVGLTPMFGWNMKLTSEYHRNVTFLSCQFVSVMRMDYMVYFSFLTWIFIPLVVMCAIYLDIFYIIRNKLSLNLSNSKETGAFYGREFKTAKSLFLVLFLFALSWLPLSIINCIIYFNGEVPQLVLYMGILLSHANSMMNPIVYAYKIKKFKETYLLILKACVVCHPSDSLDTSIEKNSE

SEQ ID NO: 3 - DNA, 104 bp, Homo sapiens
gcctccatcatgtccttgctggccatcgctgtggaccgatacttgcgggtcaagcttaccgtcagatacaagagggtcaccactcacagaagaatatggctggc

SEQ ID NO: 4 - DNA, 1447 bp, Homo sapiens
tgtcactgagggttgactgactggagagctcaagtgcagcaaagagaagtgtcagagcatgagcgccaagtccagaaccatagggattattggagctcctttctcaaagggacagccacgaggaggggtggaagaaggccctacagtattgagaaaggctggtctgcttgagaaacttaaagaacaagagtgtgatgtgaaggattatggggacctgccctttgctgacatccctaatgacagtccctttcaaattgtgaagaatccaaggtctgtgggaaaagcaagcgagcagctggctggcaaggtggcagaagtcaagaagaacggaagaatcagcctggtgctgggcggagaccacagtttggcaattggaagcatctctggccatgccagggtccaccctgatcttggagtcatctgggtggatgctcacactgatatcaacactccactgacaaccacaagtggaaacttgcatggacaacctgtatctttcctcctgaaggaactaaaaggaaagattcccgatgtgccaggattctcctgggtgactccctgtatatctgccaaggatattgtgtatattggcttgagagacgtggaccctggggaacactacattttgaaaactctaggcattaaatacttttcaatgactgaagtggacagactaggaattggcaaggtgatggaagaaacactcagctatctactaggaagaaagaaaaggccaattcatctaagttttgatgttgacggactggacccatctttcacaccagctactggcacaccagtcgtgggaggtctgacatacagagaaggtctctacatcacagaagaaatctacaaaacagggctactctcaggattagatataatggaagtgaacccatccctggggaagacaccagaagaagtaactcgaacagtgaacacagcagttgcaataaccttggcttgtttcggacttgctcgggagggtaatcacaagcctattgactaccttaacccacctaagtaaatgtggaaacatccgatataaatctcatagttaatggcataattagaaagctaatcattttcttaagcatagagttatccttctaaagacttgttctttcagaaaaatgtttttccaattagtataaactctacaaattccctcttggtgtaaaattcaagatgtggaaattctaacttttttgaaatttaaaagcttatattttctaacttggcaaaagacttatccttagaaagagaagtgtacattgatttccaattaaaaatttgctggcattaaaaataagcacacttacataagcccccatacatagagtgggactcttggaatcaggagacaaagctaccacatgtggaaaggtactatgtgtccatgtcattcaaaaaatgtgattttttataataaactctttataacaag

SEQ ID NO: 5 - protein, 322 aa, Homo sapiens
MSAKSRTIGIIGAPFSKGQPRGGVEEGPTVLRKAGLLEKLKEQECDVKDYGDLPFADIPNDSPFQIVKNPRSVGKASEQLAGKVAEVKKNGRISLVLGGDHSLAIGSISGHARVHPDLGVIWVDAHTDINTPLTTTSGNLHGQPVSFLLKELKGKIPDVPGFSWVTPCISAKDIVYIGLRDVDPGEHYILKTLGIKYFSMTEVDRLGIGKVMEETLSYLLGRKKRPIHLSFDVDGLDPSFTPATGTPVVGGLTYREGLYITEEIYKTGLLSGLDIMEVNPSLGKTPEEVTRTVNTAVAITLACFGLAREGNHKPIDYLNPPK

SEQ ID NO: 6 - DNA, 97 bp, Homo sapiens
aggtctgacatacagagaaggtctctacatcacagaagaaatctacaaaacagggctactctcaggattagatataatggaagtgaacccatccctg

SEQ ID NO: 7 - DNA, 899 bp, Homo sapiens
agcctacgcacgaaagtgactaggaggaaggatattataaagtgatgcaaacagaaattccaccagcctccatgtatcatcatgtgtcataactcagtcaagctcagtgagcattctcagcacattgcctcaacagcttcaaggtgagccagctcaagactttgctctccaccaggcagaagatgacagactgtgaatttggatatatttacaggctggctcaggactatctgcagtgcgtcctacagataccacaacctggatcaggtccaagcaaaacgtccagagtgctacaaaatgttgcgttctcagtccaaaaagaagtggaaaagaatctgaagtcatgcttggacaatgttaatgttgtgtccgtagacactgccagaacactattcaaccaagtgatggaaaaggagtttgaagacggcatcattaactggggaagaattgtaaccatatttgcatttgaaggtattctcatcaagaaacttctacgacagcaaattgccccggatgtggatacctataaggagatttcatattttgttgcggagttcataatgaataacacaggagaatggataaggcaaaacggaggctgggaaaatggctttgtaaagaagtttgaacctaaatctggctggatgacttttctagaagttacaggaaagatctgtgaaatgctatctctcctgaagcaatactgttgaccagaaaggacactccatattgtgaaaccggcctaatttttctgactgatatggaaacgattgccaacacatacttctacttttaaataaacaactttgatgatgtaacttgaccttccagagttatggaaattttgtccccatgtaatgaataaattgtatgtatttttctctataaaaaaaaaaaaa

SEQ ID NO: 8 - protein, 175 aa, Homo sapiens
MTDCEFGYIYRLAQDYLQCVLQIPQPGSGPSKTSRVLQNVAFSVQKEVEKNLKSCLDNVNVVSVDTARTLFNQVMEKEFEDGIINWGRIVTIFAFEGILIKKLLRQQIAPDVDTYKEISYFVAEFIMNNTGEWIRQNGGWENGFVKKFEPKSGWMTFLEVTGKICEMLSLLKQYC

SEQ ID NO: 9 - DNA, 91 bp, Homo sapiens
gtgtcataactcagtcaagctcagtgagcattctcagcacattgcctcaacagcttcaaggtgagccagctcaagactttgctctccacca

SEQ ID NO: 10 - DNA, 2544 bp, Homo sapiens
ctgcagggccaggacgcacgtttcaagctcatcagtaaaggttccttaaattcccgaagcaagaagttaaccaagtaaaacagcatcggaacaccaggatcccatgacagattctgttgtcacgtctccttacagagtttgagcggtgctgaactgtcagcaccatctgtccggtcccagcatgccttctgagaccccccaggcagaagtggggcccacaggctgcccccaccgctcagggccacactcggcgaaggggagcctggagaaggggtccccagaggataaggaagccaaggagcccctgtggatccggcccgatgctccgagcaggtgcacctggcagctgggccggcctgcctccgagtccccacatcaccacactgccccggcaaaatctccaaaaatcttgccagatattctgaagaaaatcggggacacccctatggtcagaatcaacaagattgggaagaagttcggcctgaagtgtgagctcttggccaagtgtgagttcttcaacgcgggcgggagcgtgaaggaccgcatcagcctgcggatgattgaggatgctgagcgcgacgggacgctgaagcccggggacacgattatcgagccgacatccgggaacaccgggatcgggctggccctggctgcggcagtgaggggctatcgctgcatcatcgtgatgccagagaagatgagctccgagaaggtggacgtgctgcgggcactgggggctgagattgtgaggacgcccaccaatgccaggttcgactccccggagtcacacgtgggggtggcctggcggctgaagaacgaaatccccaattctcacatcctagaccagtaccgcaacgccagcaaccccctggctcactacgacaccaccgctgatgagatcctgcagcagtgtgatgggaagctggacatgctggtggcttcagtgggcacgggcggcaccatcacgggcattgccaggaagctgaaggagaagtgtcctggatgcaggatcattggggtggatcccgaagggtccatcctcgcagagccggaggagctgaaccagacggagcagacaacctacgaggtggaagggatcggctacgacttcatccccacggtgctggacaggacggtggtggacaagtggttcaagagcaacgatgaggaggcgttcacctttgcccgcatgctgatcgcgcaagaggggctgctgtgcggtggcagtgctggcagcacggtggcggtggccgtgaaggctgcgcaggagctgcaggagggccagcgctgcgtggtcattctgcccgactcagtgcggaactacatgaccaagttcctgagcgacaggtggatgctgcagaagggctttctgaaggaggaggacctcacggagaagaagccctggtggtggcacctccgtgttcaggagctgggcctgtcagccccgctgaccgtgctcccgaccatcacctgtgggcacaccatcgagatcctccgggagaagggcttcgaccaggcgcccgtggtggatgaggcgggggtaatcctgggaatggtgacgcttgggaacatgctctcgtccctgcttgccgggaaggtgcagccgtcagaccaagttggcaaagtcatctacaagcagttcaaacagatccgcctcacggacacgctgggcaggctctcgcacatcctggagatggaccacttcgccctggtggtgcacgagcagatccagtaccacagcaccgggaagtccagtcagcggcagatggtgttcggggtggtcaccgccattgacttgctgaacttcgtggccgcccaggagcgggaccagaagtgaagtccggagcgctgggcggtgtggagcgggcccgccacccttgcccacttctccttcgctttcctgagccctaaacacacgcgtgattggtaactgcctggcctggcaccgttatccctgcacacggcacagagcatccgtctcccctcgttaacacatggcttcctaaatggccctgtttacggcctatgagatgaaatatgtgattttctctaatgtaacttcctcttaggatgtttcaccaaggaaatattgagagagaagtcggccaggtaggatgaacacaggcaatgactgcgcagagtggattaaaggcaaaagagagaagagtccaggaaggggcggggagaagcctgggtggctcagcatcctccacgggctgcgcgtctgctcggggctgagctggcgggacgagtttgcgtgtttgggttttttaattgagatgaaattcaaataacctaaaaatcaatcacttgaaagtgaacaatcagcggcatttagtacatccagaaagttgtgtaggcaccacctctgtcacgttctggaacattctgtcatcaccccgtgaagcaatcatttcccctcccgtcttcctcctcccctggcaactgctgatcgactttgtgtctctgttgtctaaaataggttttccctgttctggacatttcatataaatggaatcacacaaaaaaaaaaaaaaaaaaaaa

SEQ ID NO: 11 - protein, 551 aa, Homo sapiens
MPSETPQAEVGPTGCPHRSGPHSAKGSLEKGSPEDKEAKEPLWIRPDAPSRCTWQLGRPASESPHHHTAPAKSPKILPDILKKIGDTPMVRINKIGKKFGLKCELLAKCEFFNAGGSVKDRISLRMIEDAERDGTLKPGDTIIEPTSGNTGIGLALAAAVRGYRCIIVMPEKMSSEKVDVLRALGAEIVRTPTNARFDSPESHVGVAWRLKNEIPNSHILDQYRNASNPLAHYDTTADEILQQCDGKLDMLVASVGTGGTITGIARKLKEKCPGCRIIGVDPEGSILAEPEELNQTEQTTYEVEGIGYDFIPTVLDRTVVDKWFKSNDEEAFTFARMLIAQEGLLCGGSAGSTVAVAVKAAQELQEGQRCVVILPDSVRNYMTKFLSDRWMLQKGFLKEEDLTEKKPWWWHLRVQELGLSAPLTVLPTITCGHTIEILREKGFDQAPVVDEAGVILGMVTLGNMLSSLLAGKVQPSDQVGKVIYKQFKQIRLTDTLGRLSHILEMDHFALVVHEQIQYHSTGKSSQRQMVFGVVTAIDLLNFVAAQERDQK

SEQ ID NO: 12 - DNA, 81 bp, Homo sapiens
catcctggagatggaccacttcgccctggtggtgcacgagcagatccagtaccacagcaccgggaagtccagtcagcggca

SEQ ID NO: 13 - DNA, 3371 bp, Homo sapiens
gctcgggccacgcccacctgtcctgcagcactggatgctttgtgagttggggattgttgcgtcccatatctggacccagaagggacttccctgctcggctggctctcggtttctctgctttcctccggagaaataacagcgtcttccgcgccgcgcatggagcctcccggccgccgcgagtgtccctttccttcctggcgctttcctgggttgcttctggcggccatggtgttgctgctgtactccttctccgatgcctgtgaggagccaccaacatttgaagctatggagctcattggtaaaccaaaaccctactatgagattggtgaacgagtagattataagtgtaaaaaaggatacttctatatacctcctcttgccacccatactatttgtgatcggaatcatacatggctacctgtctcagatgacgcctgttatagagaaacatgtccatatatacgggatcctttaaatggccaagcagtccctgcaaatgggacttacgagtttggttatcagatgcactttatttgtaatgagggttattacttaattggtgaagaaattctatattgtgaacttaaaggatcagtagcaatttggagcggtaagcccccaatatgtgaaaaggttttgtgtacaccacctccaaaaataaaaaatggaaaacacacctttagtgaagtagaagtatttgagtatcttgatgcagtaacttatagttgtgatcctgcacctggaccagatccattttcacttattggagagagcacgatttattgtggtgacaattcagtgtggagtcgtgctgctccagagtgtaaagtggtcaaatgtcgatttccagtagtcgaaaatggaaaacagatatcaggatttggaaaaaaattttactacaaagcaacagttatgtttgaatgcgataagggtttttacctcgatggcagcgacacaattgtctgtgacagtaacagtacttgggatcccccagttccaaagtgtcttaaagtgctgcctccatctagtacaaaacctccagctttgagtcattcagtgtcgacttcttccactacaaaatctccagcgtccagtgcctcaggtcctaggcctacttacaagcctccagtctcaaattatccaggatatcctaaacctgaggaaggaatacttgacagtttggatgtttgggtcattgctgtgattgttattgccatagttgttggagttgcagtaatttgtgttgtcccgtacagatatcttcaaaggaggaagaagaaaggcacatacctaactgatgagacccacagagaagtaaaatttacttctctctgagaaggagagatgagagaaaggtttgcttttatcattaaaaggaaagcagatggtggagctgaatatgccacttaccagactaaatcaaccactccagcagagcagagaggctgaatagattccacaacctggtttgccagttcatcttttgactctattaaaatcttcaatagttgttattctgtagtttcactctcatgagtgcaactgtggcttagctaatattgcaatgtggcttgaatgtaggtagcatcctttgatgcttctttgaaacttgtatgaatttgggtatgaacagattgcctgctttcccttaaataacacttagatttattggaccagtcagcacagcatgcctggttgtattaaagcagggatatgctgtattttataaaattggcaaaattagagaaatatagttcacaatgaaattatattttctttgtaaagaaagtggcttgaaatcttttttgttcaaagattaatgccaactcttaagattattctttcaccaactatagaatgtattttatatatcgttcattgtaaaaagcccttaaaaatatgtgtatactactttggctcttgtgcataaaaacaagaacactgaaaattgggaatatgcacaaacttggcttctttaaccaagaatattattggaaaattctctaaaagttaatagggtaaattctctattttttgtaatgtgttcggtgatttcagaaagctagaaagtgtatgtgtggcatttgttttcactttttaaaacatccctaactgatcgaatatatcagtaatttcagaatcagatgcatcctttcataagaagtgagaggactctgacagccataacaggagtgccacttcatggtgcgaagtgaacactgtagtcttgttgttttcccaaagagaactccgtatgttctcttaggttgagtaacccactctgaattctggttacatgtgtttttctctccctccttaaataaagagaggggttaaacatgccctctaaaagtaggtggttttgaagagaataaattcatcagataacctcaagtcacatgagaatcttagtccatttacattgccttggctagtaaaagccatctatgtatatgtcttacctcatctcctaaaaggcagagtacaaagtaagccatgtatctcaggaaggtaacttcattttgtctatttgctgttgattgtaccaagggatggaagaagtaaatatagctcaggtagcactttatactcaggcagatctcagccctctactgagtcccttagccaagcagtttctttcaaagaagccagcaggcgaaaagcagggactgccactgcatttcatatcacactgttaaaagttgtgttttgaaattttatgtttagttgcacaaattgggccaaagaaacattgccttgaggaagatatgattggaaaatcaagagtgtagaagaataaatactgttttactgtccaaagacatgtttatagtgctctgtaaatgttcctttcctttgtagtctctggcaagatgctttaggaagataaaagtttgaggagaacaaacaggaattctgaattaagcacagagttgaagtttatacccgtttcacatgcttttcaagaatgtcgcaattactaagaagcagataatggtgttttttagaaacctaattgaagtatattcaaccaaatactttaatgtataaaataaatattatacaatatacttgtatagcagtttctgcttcacatttgattttttcaaatttaatatttatattagagatctatatatgtataaatatgtattttgtcaaatttgttacttaaatatatagagaccagttttctctggaagtttgtttaaatgacagaagcgtatatgaattcaagaaaatttaagctgcaaaaatgtatttgctataaaatgagaagtctcactgatagaggttctttattgctcattttttaaaaaatggactcttgaaatctgttaaaataaaattgtacatttggagatgtttca

SEQ ID NO: 14 - protein, 392 aa, Homo sapiens [sequence omitted]

SEQ ID NO: 15 - DNA, 94 bp, Homo sapiens
ggagagatgagagaaaggtttgcttttatcattaaaaggaaagcagatggtggagctgaatatgccacttaccagactaaatcaaccactccag

SEQ ID NO: 16 - DNA, 641 bp, Homo sapiens
atttaaattctgcagctcagagattcacacagaagtctggacacaattcagaagagccacccagaaggagacaacaatgtccctgctacccgtgccatacacagaggctgcctctttgtctactggttctactgtgacaatcaaagggcgaccacttgcctgtttcttgaatgaaccatatctgcaggtggatttccacactgagatgaaggaggaatcagacattgtcttccatttccaagtgtgctttggtcgtcgtgtggtcatgaacagccgtgagtatggggcctggaagcagcaggtggaatccaagaatatgccctttcaggatggccaagaatttgaactgagcatctcagtgctgccagataagtaccaggtaatggtcaatggccaatcctcttacacctttgaccatagaatcaagcctgaggctgtgaagatggtgcaagtgtggagagatatctccctgaccaaatttaatgtcagctatttaaagagataaccagacttcatgttgccaaggaatccctgtctctacgtgaacttgggattccaaagccagctaacagcatgatcttttctcacttcaatccttactcctgctcattaaaacttaatcaaacttcaaaaaaaaaaaa

SEQ ID NO: 17 - protein, 142 aa, Homo sapiens
MSLLPVPYTEAASLSTGSTVTIKGRPLACFLNEPYLQVDFHTEMKEESDIVFHFQVCFGRRVVMNSREYGAWKQQVESKNMPFQDGQEFELSISVLPDKYQVMVNGQSSYTFDHRIKPEAVKMVQVWRDISLTKFNVSYLKR

SEQ ID NO: 18 - DNA, 78 bp, Homo sapiens
gccaagaatttgaactgagcatctcagtgctgccagataagtaccaggtaatggtcaatggccaatcctcttacacct

SEQ ID NO: 19 - DNA, 3003 bp, Homo sapiens
tcggggagagaagctggactgcagctggtttcaggaacttctcttgacgagaagagagaccaaggaggccaagcaggggctgggccagaggtgccaacatggggaaactgaggctcggctcggaaaggtgaagtaacttgtccaagatcacaaagctggtgaacatcaagttggtgctatggcaaggctgggaaactgcagcctgacttgggctgccctgatcatcctgctgctccccggaagtctggaggagtgcgggcacatcagtgtctcagcccccatcgtccacctgggggatcccatcacagcctcctgcatcatcaagcagaactgcagccatctggacccggagccacagattctgtggagactgggagcagagcttcagcccgggggcaggcagcagcgtctgtctgatgggacccaggaatctatcatcaccctgccccacctcaaccacactcaggcctttctctcctgctgcctgaactggggcaacagcctgcagatcctggaccaggttgagctgcgcgcaggctaccctccagccataccccacaacctctcctgcctcatgaacctcacaaccagcagcctcatctgccagtgggagccaggacctgagacccacctacccaccagcttcactctgaagagtttcaagagccggggcaactgtcagacccaaggggactccatcctggactgcgtgcccaaggacgggcagagccactgctgcatcccacgcaaacacctgctgttgtaccagaatatgggcatctgggtgcaggcagagaatgcgctggggaccagcatgtccccacaactgtgtcttgatcccatggatgttgtgaaactggagccccccatgctgcggaccatggaccccagccctgaagcggcccctccccaggcaggctgcctacagctgtgctgggagccatggcagccaggcctgcacataaatcagaagtgtgagctgcgccacaagccgcagcgtggagaagccagctgggcactggtgggccccctccccttggaggcccttcagtatgagctctgcgggctcctcccagccacggcctacaccctgcagatacgctgcatccgctggcccctgcctggccactggagcgactggagccccagcctggagctgagaactaccgaacgggcccccactgtcagactggacacatggtggcggcagaggcagctggaccccaggacagtgcagctgttctggaagccagtgcccctggaggaagacagcggacggatccaaggttatgtggtttcttggagaccctcaggccaggctggggccatcctgcccctctgcaacaccacagagctcagctgcaccttccacctgccttcagaagcccaggaggtggcccttgtggcctataactcagccgggacctctcgtcccactccggtggtcttctcagaaagcagaggcccagctctgaccagactccatgccatggcccgagaccctcacagcctctgggtaggctgggagccccccaatccatggcctcagggctatgtgattgagtggggcctgggcccccccagcgcgagcaatagcaacaagacctggaggatggaacagaatgggagagccacggggtttctgctgaaggagaacatcaggccctttcagctctatgagatcatcgtgactcccttgtaccaggacaccatgggaccctcccagcatgtctatgcctactctcaagaaatggctccctcccatgccccagagctgcatctaaagcacattggcaagacctgggcacagctggagtgggtgcctgagccccctgagctggggaagagcccccttacccactacaccatcttctggaccaacgctcagaaccagtccttctccgccatcctgaatgcctcctcccgtggctttgtcctccatggcctggagcccgccagtctgtatcacatccacctcatggctgccagccaggctggggccaccaacagtacagtcctcaccctgatgaccttgaccccagaggggtcggagctacacatcatcctgggcctgttcggcctcctgctgttgctcacctgcctctgtggaactgcctggctctgttgcagccccaacaggaagaatcccctctggccaagtgtcccagacccagctcacagcagcctgggctcctgggtgcccacaatcatggaggaggatgccttccagctgcccggccttggcacgccacccatcaccaagctcacagtgctggaggaggatgaaaagaagccggtgccctgggagtcccataacagctcagagacctgtggcctccccactctggtccagacctatgtgctccagggggacccaagagcagtttccacccagccccaatcccagtctggcaccagcgatcaggtcctttatgggcagctgctgggcagccccacaagcccagggccagggcactatctccgctgtgactccactcagcccctcttggcgggcctcacccccagccccaagtcctatgagaacctctggttccaggccagccccttggggaccctggtaaccccagccccaagccaggaggacgactgtgtctttgggccactgctcaacttccccctcctgcaggggatccgggtccatgggatggaggcgctggggagcttctagggcttcctggggttcccttcttgggcctgcctcttaaaggcctgagctagctggagaagaggggagggtccataagcccatgactaaaaactaccccagcccaggctctcaccatctccagtcaccagcatctccctctcctcccaatctccataggctgggcctcccaggcgatctgcatactttaaggaccagatcatgctccatccagccccacccaatggccttttgtgcttgtttcctataacttcagtattgtaaactagtttttggtttgcagtttttgttgttgtttatagacactcttgggtgta

SEQ ID NO: 20 - protein, 836 aa, Homo sapiens
MARLGNCSLTWAALIILLLPGSLEECGHISVSAPIVHLGDPITASCIIKQNCSHLDPEPQILWRLGAELQPGGRQQRLSDGTQESIITLPHLNHTQAFLSCCLNWGNSLQILDQVELRAGYPPAIPHNLSCLMNLTTSSLICQWEPGPETHLPTSFTLKSFKSRGNCQTQGDSILDCVPKDGQSHCCIPRKHLLLYQNMGIWVQAENALGTSMSPQLCLDPMDVVKLEPPMLRTMDPSPEAAPPQAGCLQLCWEPWQPGLHINQKCELRHKPQRGEASWALVGPLPLEALQYELCGLLPATAYTLQIRCIRWPLPGHWSDWSPSLELRTTERAPTVRLDTWWRQRQLDPRTVQLFWKPVPLEEDSGRIQGYVVSWRPSGQAGAILPLCNTTELSCTFHLPSEAQEVALVAYNSAGTSRPTPVVFSESRGPALTRLHAMARDPHSLWVGWEPPNPWPQGYVIEWGLGPPSASNSNKTWRMEQNGRATGFLLKENIRPFQLYEIIVTPLYQDTMGPSQHVYAYSQEMAPSHAPELHLKHIGKTWAQLEWVPEPPELGKSPLTHYTIFWTNAQNQSFSAILNASSRGFVLHGLEPASLYHIHLMAASQAGATNSTVLTLMTLTPEGSELHIILGLFGLLLLLTCLCGTAWLCCSPNRKNPLWPSVPDPAHSSLGSWVPTIMEEDAFQLPGLGTPPITKLTVLEEDEKKPVPWESHNSSETCGLPTLVQTYVLQGDPRAVSTQPQSQSGTSDQVLYGQLLGSPTSPGPGHYLRCDSTQPLLAGLTPSPKSYENLWFQASPLGTLVTPAPSQEDDCVFGPLLNFPLLQGIRVHGMEALGSF

SEQ ID NO: 21 - DNA, 59 bp, Homo sapiens
ctgggtgcccacaatcatggaggaggatgccttccagctgcccggccttggcacgccac

SEQ ID NO: 22 - DNA, 838 bp, Homo sapiens
tgctgtttgtggaaaataaagcattctataggcggagctagtgaacgcctcttttaaaacacgagtctccacacttccctgttcactttggttccagcatcctgtccagcaaagaagcaatcagccaaaatgatacctggaggcttatctgaggccaaacccgccactccagaaatccaggagattgttgataaggttaaaccacagcttgaagaaaaaacaaatgagacttacggaaaattggaagctgtgcagtataaaactcaagttgttgctggaacaaattactacattaaggtacgagcaggtgataataaatatatgcacttgaaagtattcaaaagtcttcccggacaaaatgaggacttggtacttactggataccaggttgacaaaaacaaggatgacgagctgacgggcttttagcagcatgtacccaaagtgttctgattccttcaactggctactgagtcatgatccttgctgataaatataaccatcaataaagaagcattcttttccaaagaaattatttcttcaattatttctcatttattgtattaagcagaaattaccttttctttctcaaaatcagtgttattgctttagagtataaactccatataaattgatggcaattggaaatcttataaaaactagtcaagcctaatgcaactggctaaaggatagtaccaccctcacccccaccataggcaggctggatcgtggactatcaattcaccagcctccttgttccctgtggctgctgataacccaacattccatctctaccctcatacttcaaaattaaatcaagtattttacaaaaaaaaaaaaa

SEQ ID NO: 23 - protein, 98 aa, Homo sapiens
MIPGGLSEAKPATPEIQEIVDKVKPQLEEKTNETYGKLEAVQYKTQVVAGTNYYIKVRAGDNKYMHLKVFKSLPGQNEDLVLTGYQVDKNKDDELTGF

SEQ ID NO: 24 - DNA, 107 bp, Homo sapiens
gtgcagtataaaactcaagttgttgctggaacaaattactacattaaggtacgagcaggtgataataaatatatgcacttgaaagtattcaaaagtcttcccggaca

SEQ ID NO: 25 - DNA, 9179 bp, Homo sapiens
gcaagaactgcaggggaggaggacgctgccacccacagcctctagagctcattgcagctgggacagcccggagtgtggttagcagctcggcaagcgctgcccaggtcctggggtggtggcagccagcgggagcaggaaaggaagcatgttcccaggctgcccacgcctctgggtcctggtggtcttgggcaccagctgggtaggctgggggagccaagggacagaagcggcacagctaaggcagttctacgtggctgctcagggcatcagttggagctaccgacctgagcccacaaactcaagtttgaatctttctgtaacttcctttaagaaaattgtctacagagagtatgaaccatattttaagaaagaaaaaccacaatctaccatttcaggacttcttgggcctactttatatgctgaagtcggagacatcataaaagttcactttaaaaataaggcagataagcccttgagcatccatcctcaaggaattaggtacagtaaattatcagaaggtgcttcttaccttgaccacacattccctgcggagaagatggacgacgctgtggctccaggccgagaatacacctatgaatggagtatcagtgaggacagtggacccacccatgatgaccctccatgcctcacacacatctattactcccatgaaaatctgatcgaggatttcaactcggggctgattgggcccctgcttatctgtaaaaaagggaccctaactgagggtgggacacagaagacgtttgacaagcaaatcgtgctactatttgctgtgtttgatgaaagcaagagctggagccagtcatcatccctaatgtacacagtcaatggatatgtgaatgggacaatgccagatataacagtttgtgcccatgaccacatcagctggcatctgctgggaatgagctcggggccagaattattctccattcatttcaacggccaggtcctggagcagaaccatcataaggtctcagccatcacccttgtcagtgctacatccactaccgcaaatatgactgtgggcccagagggaaagtggatcatatcttctctcaccccaaaacatttgcaagctgggatgcaggcttacattgacattaaaaactgcccaaagaaaaccaggaatcttaagaaaataactcgtgagcagaggcggcacatgaagaggtgggaatacttcattgctgcagaggaagtcatttgggactatgcacctgtaataccagcgaatatggacaaaaaatacaggtctcagcatttggataatttctcaaaccaaattggaaaacattataagaaagttatgtacacacagtacgaagatgagtccttcaccaaacatacagtgaatcccaatatgaaagaagatgggattttgggtcctattatcagagcccaggtcagagacacactcaaaatcgtgttcaaaaatatggccagccgcccctatagcatttaccctcatggagtgaccttctcgccttatgaagatgaagtcaactcttctttcacctcaggcaggaacaacaccatgatcagagcagttcaaccaggggaaacctatacttataagtggaacatcttagagtttgatgaacccacagaaaatgatgcccagtgcttaacaagaccatactacagtgacgtggacatcatgagagacatcgcctctgggctaataggactacttctaatctgtaagagcagatccctggacaggcgaggaatacagagggcagcagacatcgaacagcaggctgtgtttgctgtgtttgatgagaacaaaagctggtaccttgaggacaacatcaacaagttttgtgaaaatcctgatgaggtgaaacgtgatgaccccaagttttatgaatcaaacatcatgagcactatcaatggctatgtgcctgagagcataactactcttggattctgctttgatgacactgtccagtggcacttctgtagtgtggggacccagaatgaaattttgaccatccacttcactgggcactcattcatctatggaaagaggcatgaggacaccttgaccctcttccccatgcgtggagaatctgtgacggtcacaatggataatgttggaacttggatgttaacttccatgaattctagtccaagaagcaaaaagctgaggctgaaattcagggatgttaaatgtatcccagatgatgatgaagactcatatgagatttttgaacctccagaatctacagtcatggctacacggaaaatgcatgatcgtttagaacctgaagatgaagagagtgatgctgactatgattaccagaacagactggctgcagcattaggaatcaggtcattccgaaactcatcattgaatcaggaagaagaagagttcaatcttactgccctagctctggagaatggcactgaattcgtttcttcaaacacagatataattgttggttcaaattattcttccccaagtaatattagtaagttcactgtcaataaccttgcagaacctcagaaagccccttctcaccaacaagccaccacagctggttccccactgagacacctcattggcaagaactcagttctcaattcttccacagcagagcattccagcccatattctgaagaccctatagaggatcctctacagccagatgtcacagggatacgtctactttcacttggtgctggagaattcaaaagtcaagaacatgctaagcataagggacccaaggtagaaagagatcaagcagcaaagcacaggttctcctggatgaaattactagcacataaagttgggagacacctaagccaagacactggttctccttccggaatgaggccctgggaggaccttcctagccaagacactggttctccttccagaatgaggccctggaaggaccctcctagtgatctgttactcttaaaacaaagtaactcatctaagattttggttgggagatggcatttggcttctgagaaaggtagctatgaaataatccaagatactgatgaagacacagctgttaacaattggctgatcagcccccagaatgcctcacgtgcttggggagaaagcacccctcttgccaacaagcctggaaagcagagtggccacccaaagtttcctagagttagacataaatctctacaagtaagacaggatggaggaaagagtagactgaagaaaagccagtttctcattaagacacgaaaaaagaaaaaagagaagcacacacaccatgctcctttatctccgaggacctttcaccctctaagaagtgaagcctacaacacattttcagaaagaagacttaagcattcgttggtgcttcataaatccaatgaaacatctcttcccacagacctcaatcagacattgccctctatggattttggctggatagcctcacttcctgaccataatcagaattcctcaaatgacactggtcaggcaagctgtcctccaggtctttatcagacagtgcccccagaggaacactatcaaacattccccattcaagaccctgatcaaatgcactctacttcagaccccagtcacagatcctcttctccagagctcagtgaaatgcttgagtatgaccgaagtcacaagtccttccccacagatataagtcaaatgtccccttcctcagaacatgaagtctggcagacagtcatctctccagacctcagccaggtgaccctctctccagaactcagccagacaaacctctctccagacctcagccacacgactctctctccagaactcattcagagaaacctttccccagccctcggtcagatgcccatttctccagacctcagccatacaaccctttctccagacctcagccatacaaccctttctttagacctcagccagacaaacctctctccagaactcagtcagacaaacctttctccagccctcggtcagatgcccctttctccagacctcagccatacaaccctttctctagacttcagccagacaaacctctctccagaactcagccatatgactctctctccagaactcagtcagacaaacctttccccagccctcggtcagatgcccatttctccagacctcagccatacaaccctttctctagacttcagccagacaaacctctctccagaactcagtcaaacaaacctttccccagccctcggtcagatgcccctttctccagaccccagccatacaaccctttctctagacctcagccagacaaacctctctccagaactcagtcagacaaacctttccccagacctcagtgagatgcccctctttgcagatctcagtcaaattccccttaccccagacctcgaccagatgacactttctccagaccttggtgagacagatctttccccaaactttggtcagatgtccctttccccagacctcagccaggtgactctctctccagacatcagtgacaccacccttctcccggatctcagccagatatcacctcctccagaccttgatcagatattctacccttctgaatctagtcagtcattgcttcttcaagaatttaatgagtcttttccttatccagaccttggtcagatgccatctccttcatctcctactctcaatgatacttttctatcaaaggaatttaatccactggttatagtgggcctcagtaaagatggtacagattacattgagatcattccaaaggaagaggtccagagcagtgaagatgactatgctgaaattgattatgtgccctatgatgacccctacaaaactgatgttaggacaaacatcaactcctccagagatcctgacaacattgcagcatggtacctccgcagcaacaatggaaacagaagaaattattacattgctgctgaagaaatatcctgggattattcagaatttgtacaaagggaaacagatattgaagactctgatgatattccagaagataccacatataagaaagtagtttttcgaaagtacctcgacagcacttttaccaaacgtgatcctcgaggggagtatgaagagcatctcggaattcttggtcctattatcagagctgaagtggatgatgttatccaagttcgttttaaaaatttagcatccagaccgtattctctacatgcccatggactttcctatgaaaaatcatcagagggaaagacttatgaagatgactctcctgaatggtttaaggaagataatgctgttcagccaaatagcagttatacctacgtatggcatgccactgagcgatcagggccagaaagtcctggctctgcctgtcgggcttgggcctactactcagctgtgaacccagaaaaagatattcactcaggcttgataggtcccctcctaatctgccaaaaaggaatactacataaggacagcaacatgcctatggacatgagagaatttgtcttactatttatgacctttgatgaaaagaagagctggtactatgaaaagaagtcccgaagttcttggagactcacatcctcagaaatgaaaaaatcccatgagtttcacgccattaatgggatgatctacagcttgcctggcctgaaaatgtatgagcaagagtgggtgaggttacacctgctgaacataggcggctcccaagacattcacgtggttcactttcacggccagaccttgctggaaaatggcaataaacagcaccagttaggggtctggccccttctgcctggttcatttaaaactcttgaaatgaaggcatcaaaacctggctggtggctcctaaacacagaggttggagaaaaccagagagcagggatgcaaacgccatttcttatcatggacagagactgtaggatgccaatgggactaagcactggtatcatatctgattcacagatcaaggcttcagagtttctgggttactgggagcccagattagcaagattaaacaatggtggatcttataatgcttggagtgtagaaaaacttgcagcagaatttgcctctaaaccttggatccaggtggacatgcaaaaggaagtcataatcacagggatccagacccaaggtgccaaacactacctgaagtcctgctataccacagagttctatgtagcttacagttccaaccagatcaactggcagatcttcaaagggaacagcacaaggaatgtgatgtattttaatggcaattcagatgcctctacaataaaagagaatcagtttgacccacctattgtggctagatatattaggatctctccaactcgagcctataacagacctacccttcgattggaactgcaaggttgtgaggtaaatggatgttccacacccctgggtatggaaaatggaaagatagaaaacaagcaaatcacagcttcttcgtttaagaaatcttggtggggagattactgggaacccttccgtgcccgtctgaatgcccagggacgtgtgaatgcctggcaagccaaggcaaacaacaataagcagtggctagaaattgatctactcaagatcaagaagataacggcaattataacacagggctgcaagtctctgtcctctgaaatgtatgtaaagagctataccatccactacagtgagcagggagtggaatggaaaccatacaggctgaaatcctccatggtggacaagatttttgaaggaaatactaataccaaaggacatgtgaagaactttttcaaccccccaatcatttccaggtttatccgtgtcattcctaaaacatggaatcaaagtattgcacttcgcctggaactctttggctgtgatatttactagaattgaacattcaaaaacccctggaagagactctttaagacctcaaaccatttagaatgggcaatgtattttacgctgtgttaaatgttaacagttttccactatttctctttcttttctattagtgaataaaattttatacaagaagcttttataatgtaactccttgctaccagtaagtaagataatggctattacttctgcattaatttgaatacaggtaggaaaatatcaagaaccaacaagaaaagggcttatctttcttaatgattgaaaatgctatgaagtaatatttatgtagttaaaatgcttcattataactcttttaaatcctttacacactagtaaaacagatattactttaaataataattgatagacctggataactttcacaaacacatgattttttaatggtttttcttgagtgaagagaaaaacaatattatcaaatgaaataagtacttaaaatatcctgtctttcccatataacaatgatttttctgactttccatgagtaaaaaaacagccaagcatctttccagtagccccattgaaattgtgaatccgtcctggtctccctaaggactgcacacattgatattcaaggttggtggtcattagatatggaacagaactgaaataaccatggtagaactgaatgtgtaatgttggctttattctagctggtactacatggcacacagtttcaaaacataatttcacctactggaaagctcagacctgtaaaacagagcatgggaactgctggtctaaatgcagttgttcctgctcaaagagacctctggccaaactggcaagcagttaaagttttctttcagggccttcctctctatggcctcaacttcctcctctctcttcttccagcaacttcccctttcatcattcctttccctggggacttggcattcagtgatcctgtagatattgcacaactggggaacctttagacatccttaaaatcacatgagatagacagtcatttggggtgtctgaaataaaccaccccaaaacttagtgttaaaagagcaaccaaaaaaaatttatgtgagattatggatttgttacttagcttgatttaatcatcctgtaacgtgtacatatatcaaaatgttatgtataccataaatatataaaattttatcaacgaaattcataacaatctctcagaccacagagaaatcaaattagaactgaggactaagaaactcactcgaaaccacacaactacatggaaactgaacaacctgctcctgaatgactactgggtaaataatgaaattaaggcagaaataaataagttccttaaaaccaatgagaacaaagagacaacataccagaatctctaggagacagggctttgcttttgctgcattctattcgttgtgaacacaaattacaggccagtctcgattcagtgtagaagggaactgcataaggaccacataccaggaggcataattcactgggagcatctttagaaactaccagagttacctgttgcccataccagtggggtaagccctatgaatgtatatgagagtttcaaacatccacaaaacattggctttctaatattcgtattcccactattcctttcttttcatgattcatgtcattgtcccatcaacatttctaagatttccattccgttaagagcaaaagagaatgttggaaggtgggggaaaacatttctttgttttctacagggccagcttcttggatgtgtgtgatctgttcagttgcaaagggtcacatgctcagaaggaccgcatgctaaatttaatgctttgcagttaccctcttgaaatcctttattttttaagaaggaattcgacatttccatttttcaatgagccccacaaattacgcagctagtcctgggcttctctactctgaaattgggcaggatctctcttgatctagaatttactaaggcataataggggcaagaaaatcttatgaaataatggggggtagggaagagatgggaatggagcatgagatccagcttcgttattctctacttgagaaaaataaggccccaaagattaaacaacttgcccaaggatattgcttgttagtgtcagaactgaaaccagaaaccaaatgatcatatccctagacttttagtctgctttctcttccataaaatgaaacttataatgtttctaatccattgctcagacaggtagacatgaatattaattgataatgactattaattgatctggaaaatacttgtttggggatcaataatatgtttgggctattatctaatgctgtgtagaaatattaaaacccctgttattttgaaataaaaaagatacccactttt

SEQ ID NO: 26 - protein, 2224 aa, Homo sapiens
MFPGCPRLWVLVVLGTSWVGWGSQGTEAAQLRQFYVAAQGISWSYRPEPTNSSLNLSVTSFKKIVYREYEPYFKKEKPQSTISGLLGPTLYAEVGDIIKVHFKNKADKPLSIHPQGIRYSKLSEGASYLDHTFPAEKMDDAVAPGREYTYEWSISEDSGPTHDDPPCLTHIYYSHENLIEDFNSGLIGPLLICKKGTLTEGGTQKTFDKQIVLLFAVFDESKSWSQSSSLMYTVNGYVNGTMPDITVCAHDHISWHLLGMSSGPELFSIHFNGQVLEQNHHKVSAITLVSATSTTANMTVGPEGKWIISSLTPKHLQAGMQAYIDIKNCPKKTRNLKKITREQRRHMKRWEYFIAAEEVIWDYAPVIPANMDKKYRSQHLDNFSNQIGKHYKKVMYTQYEDESFTKHTVNPNMKEDGILGPIIRAQVRDTLKIVFKNMASRPYSIYPHGVTFSPYEDEVNSSFTSGRNNTMIRAVQPGETYTYKWNILEFDEPTENDAQCLTRPYYSDVDIMRDIASGLIGLLLICKSRSLDRRGIQRAADIEQQAVFAVFDENKSWYLEDNINKFCENPDEVKRDDPKFYESNIMSTINGYVPESITTLGFCFDDTVQWHFCSVGTQNEILTIHFTGHSFIYGKRHEDTLTLFPMRGESVTVTMDNVGTWMLTSMNSSPRSKKLRLKFRDVKCIPDDDEDSYEIFEPPESTVMATRKMHDRLEPEDEESDADYDYQNRLAAALGIRSFRNSSLNQEEEEFNLTALALENGTEFVSSNTDIIVGSNYSSPSNISKFTVNNLAEPQKAPSHQQATTAGSPLRHLIGKNSVLNSSTAEHSSPYSEDPIEDPLQPDVTGIRLLSLGAGEFKSQEHAKHKGPKVERDQAAKHRFSWMKLLAHKVGRHLSQDTGSPSGMRPWEDLPSQDTGSPSRMRPWKDPPSDLLLLKQSNSSKILVGRWHLASEKGSYEIIQDTDEDTAVNNWLISPQNASRAWGESTPLANKPGKQSGHPKFPRVRHKSLQVRQDGGKSRLKKSQFLIKTRKKKKEKHTHHAPLSPRTFHPLRSEAYNTFSERRLKHSLVLHKSNETSLPTDLNQTLPSMDFGWIASLPDHNQNSSNDTGQASCPPGLYQTVPPEEHYQTFPIQDPDQMHSTSDPSHRSSSPELSEMLEYDRSHKSFPTDISQMSPSSEHEVWQTVISPDLSQVTLSPELSQTNLSPDLSHTTLSPELIQRNLSPALGQMPISPDLSHTTLSPDLSHTTLSLDLSQTNLSPELSQTNLSPALGQMPLSPDLSHTTLSLDFSQTNLSPELSHMTLSPELSQTNLSPALGQMPISPDLSHTTLSLDFSQTNLSPELSQTNLSPALGQMPLSPDPSHTTLSLDLSQTNLSPELSQTNLSPDLSEMPLFADLSQIPLTPDLDQMTLSPDLGETDLSPNFGQMSLSPDLSQVTLSPDISDTTLLPDLSQISPPPDLDQIFYPSESSQSLLLQEFNESFPYPDLGQMPSPSSPTLNDTFLSKEFNPLVIVGLSKDGTDYIEIIPKEEVQSSEDDYAEIDYVPYDDPYKTDVRTNINSSRDPDNIAAWYLRSNNGNRRNYYIAAEEISWDYSEFVQRETDIEDSDDIPEDTTYKKVVFRKYLDSTFTKRDPRGEYEEHLGILGPIIRAEVDDVIQVRFKNLASRPYSLHAHGLSYEKSSEGKTYEDDSPEWFKEDNAVQPNSSYTYVWHATERSGPESPGSACRAWAYYSAVNPEKDIHSGLIGPLLICQKGILHKDSNMPMDMREFVLLFMTFDEKKSWYYEKKSRSSWRLTSSEMKKSHEFHAINGMIYSLPGLKMYEQEWVRLHLLNIGGSQDIHVVHFHGQTLLENGNKQHQLGVWPLLPGSFKTLEMKASKPGWWLLNTEVGENQRAGMQTPFLIMDRDCRMPMGLSTGIISDSQIKASEFLGYWEPRLARLNNGGSYNAWSVEKLAAEFASKPWIQVDMQKEVIITGIQTQGAKHYLKSCYTTEFYVAYSSNQINWQIFKGNSTRNVMYFNGNSDASTIKENQFDPPIVARYIRISPTRAYNRPTLRLELQGCEVNGCSTPLGMENGKIENKQITASSFKKSWWGDYWEPFRARLNAQGRVNAWQAKANNNKQWLEIDLLKIKKITAIITQGCKSLSSEMYVKSYTIHYSEQGVEWKPYRLKSSMVDKIFEGNTNTKGHVKNFFNPPIISRFIRVIPKTWNQSIALRLELFGCDIY

SEQ ID NO: 27 - DNA, 117 bp, Homo sapiens
ggaaaccatacaggctgaaatcctccatggtggacaagatttttgaaggaaatactaataccaaaggacatgtgaagaactttttcaaccccccaatcatttccaggtttatccgtg

SEQ ID NO: 28 - DNA, 7277 bp, Homo sapiens
aggtcagggggctggggacgcgcgtggggatcgctacccggctcggccactgctgggcggacacctgggcgcgccgccgcgggaggagcccggactcgggccgaggctgcccaggcaatgcgttcactcggcgcaaacatggctgcggccctgcgcgccgcgggcgtcctgctccgcgatccgctggcatccagcagctggagggtctgtcagccatggaggtggaagtcaggtgcagctgcagcggccgtcaccacagaaacagcccagcatgcccagggtgcaaaacctcaagttcaaccgcagaagaggaagccgaaaactggaatattaatgctaaacatgggaggccctgaaactcttggagatgttcacgacttccttctgagactcttcttggaccgagacctcatgacacttcctattcagaataagctggcaccattcatcgccaaacgccgaacccccaagattcaagagcagtaccgcaggattggaggcggatcccccatcaagatatggacttccaagcagggagagggcatggtgaagctgctggatgaattgtcccccaacacagcccctcacaaatactatattggatttcggtacgtccatcctttaacagaagaagcaattgaagagatggagagagatggcctagaaagggctattgctttcacacagtatccacagtacagctgctccaccacaggcagcagcttaaatgccatttacagatactataatcaagtgggacggaagcccacgatgaagtggagcactattgacaggtggcccacacatcacctcctcatccagtgctttgcagatcatattctaaaggaactggaccattttccacttgagaagagaagcgaggtggtcattctgttttctgctcactcactgcccatgtctgtggtcaacagaggcgacccatatcctcaggaggtaagcgccactgtccaaaaagtcatggaaaggctggagtactgcaacccctaccgactggtgtggcaatccaaggttggtccaatgccctggttgggtcctcaaacagacgaatctatcaaagggctttgtgagagggggaggaagaatatcctcttggttccgatagcatttaccagtgaccatattgaaacgctgtatgagctggacatcgagtactctcaagttttagccaaggagtgtggagttgaaaacatcagaagagctgagtctcttaatggaaatccattgttctctaaggccctggccgacttggtgcattcacacatccagtcaaacgagctgtgttccaagcagctgaccctgagctgtccgctctgtgtcaatcctgtctgcagggagactaaatccttcttcaccagccagcagctgtgacccccgccggtggaccccgtggcgttaggcaaatgcccaacctccagatacctccgatgtggagagggtgttatttagagatcaaggaaggaagtcatccttccttgatatatatacagcctttgggtacaaattgtgtggtttcttgaggattggactcttgatggatttctatttttatataactatacagtaagcatttgtattttctctctctaggtataagttactagtttggaatgtccatcaggacctttaataaatgagttaaaaatttgtcttatgagacacacctatttaagtacagattttggctttattgcccaaaaccctcctgaaagggtacggagagtcccctctgtgggctggcagtgtgaatgagatctgtttagtctcgtgcatatagttgctgttttttaaatgaacacagttgagtatttgaagtgaatttgaaaaagaaatgttacttaatctttccctaagcccatgggttacagaatgctagggaggcaatttggttacctgcaatggctgcttttgccagcgaggccaccattcattggtcatcttggtatttgtgtgtgaatctcactttcctcaatgtaaaaaggaatcaagtatggatttcagaggtgctcttagattccccatacacccaagggtaataaacgtgtacaagtacagtgttcatgatacgtgccttggtgggagtccgtggtgccacagggaaggggctcccactgcttctggtctccagggacagtgctgctggaaaggctagtgatgagcttcaccctggagctcctcccgggaccttgcaagcctctccatccagcatcttctctatcttagttgaatgccttctttctgaacatttgttttaagaattattttataaagtcaacaatactttgcttgaattctttcttaatttacgattttttattataaaaatgtatagtgatacaatgggacatgtgaagaatacagaaaagtaaccactttaatgcaataactgttatcataatattgtatttcgtggtagtcctttcctgtagatatttttaatgccatttaatgccattgtcaccttggatttatgagtgaaaagtgtttctaaaaatatagaaataatgtcagatcagagtctgatcttctatgtttgtatttaaatggattaaaagatccccggtggttccatgaagaatttgtaaagatcactttctctttcctccaagccctgaaactttgttcttcaaaagagcgtttctttttttttttttttttagccagtttataaagtggaagtattaggagattcataaatcttctatattgagaattggctatgttaataaatattacaacatcattaaggttttagctaagtttgattcatgctgtctgttaaatcaaaactgatctaaatcagaattattaaatgtgaggagcttttttaatacaggaaaagaaacatgtcatccacttgagttaatagttttcctacgttgatgacagccctcatgagtagcatccacatttttaaaatttcaaattggtttttctactagtagattgtgtttctagagaaagatacaaggcataggtgattgtttaggattttcctctagcctttgccattacctttttggggatgaggttcacagtagactttgagtgaccgtcccaccgtgaagtgaattctctgagctggtggtgtggtgctggaaggaaggttatttttggagccactctctccccttaaggatatttcccaagggcctgcttcaattctttgatgactttagaggtgaaaaaatatttttatggagatgatgcagaaaactccaattcaggagcccttgcgagtatatctgaagcacttatttgctaaggaaacctgaattgatagcagtactgtgctgtctggaataatgtccttgatactgagttgggaccagactggcttttatagtgacaggcaaagaggaatttattgagatcactgctcatggcatttgttgctgtaagaagtgttgcctttgattgttactaaccacggatgggtaacggtcatacattaggctagtgtttggtaggacaaaatctttttagagctttgagaattgtcatcctgttggtcaactttgaaatacaaatgtttgccctggtaattagcaatgaactgctggcagtttcttcagctgtgtatatacggatctggcttttaattgatgaatcaacttctacagaaacttttgcagggacagtgttgatgaggcagtttagcttgccagggtgatgataaagcccaggtccctgcatgtatagtgctcttctaaagaatatgcattcttgaactacttaactttttaaaaatcacaataaatttttgcactcaaaatttgcttcgtatcaggagaaatgaactcattgttttgttttgtttttttttttttttaagatggagtcttgctatgtcacccaggctggagggcagtggtgcgatctcggctcactgctacttccacctcctgggctcaagtgatcctcccacctcagcctccaagtagctgggactacaggagtgcttcaccacgctgggctacttttttatattttttgtagagatggggttttgccatgttgtccaggctggtcttgaactcctgggctcaagggattctcctgcctcagtctcccaaagtgctgggattacaaggatgagcctctgcacctggccctgaactcattattaaaagccctttaaatgtgaggctgggtgccgtgccttacatgtgtaattccaatactttggaaggccaaggttggaggattgcttgatcccaagagttcaagaccagcctgggcaacatagggagaccctgactctacaaaaaataaagtaaaaattaactgggtgtagtgtcacatgcctgtagttccagctacttaggaggctgaggtggtaggattgcttgagcccagcagtttgaggttgcagtgaggtgtgattgcaccactgcactccagcctgggtgacagaggaagaccctgtcccaaaaccaaaaaaaagaaaagaaatacagagactgggtcatttacaaaggaaagaggtttaattgactcggttcggctttctgaggaagccttaggaaattgacaatcatggcagaaggggaagcagatgtcttacatggcagtgagtgagagcaagcaaaggggaagagcccccttataaaaccatcagatctcgtgagaactggctgtcacaagaacagcatgggggaactgtctccatgttccaatctccttccaccaggtccctccctcaacacgtggggattatggggattacaatttgaaatgagatttgggtggggaacagagccaaatcatatcattccaccctggcccctcccaaatcacatgtcctttttacatttcaaaaccaatcatgccttcacaacagtcctccagagtcttaactcattccagcattaacccaaaagtccaagttcaaagtctcatccaagacaaggcaagtcccttctgcctgtgagcctgtaacattaaaagcaagttagtgacttccaagatacaatgggagtacagacattggtaaatgttcccattccaaatgggagaaattggccaaaacacaggggctacaggccccatgcaccactgcactccactgtgcaagtctgaaacccggcagggcactccttaaattttttttttttttttttgagatggagtctcgctctgttgcccaagctggagtacagtggcacgatctcggctcactgcaacctccgcctcttgggttcaaaggatcatcctgcctcagcctccggagtagctgggctactcaggcgtgtgccaccatgcccggctaatttttgtatttttagtagagatggggcctgaccatgttggtcaggctggtctctaattcctgacctcgtgatccacccgcctcagcctctgaaagtgttgggattacaggcgtgagccaccatccccggcctactcaataaatcttaaagttccggaataatctcctttgactccatgtctcacctccaggtcacgctgatgcaagaggtgggctaatctttctagtaaattccatatttaattcaagaaaccataacttaaggcatgtaaaagagatcctttgctcaatgtgatgccattgtgcttatccaaagtatattattattacccacaaagggtgagagattaggctgcagccataccccaagtggagtgagcagcaagacctgccccctgctcagagtgtagatgactgggggcacctgcattcctaggggctctgccgtatgagctcctgtcgatgcggcaaaggaccaccttgcccaacgacagcgggaaggcagaatttaaagctggcagctgtaagcgaacgtctatgtgtgcgcacgggggcacgtgaaggcacaggtgcatcagccaagaacctccaattcacctcttaaccttctcacctcacctgaaaccccttctgccagaatcctgaaggtggcccaggaacagggctcctaacgttaggtggaaatgggaaattcattgagatgtcacaagctggaataagaaaattctgagctcacccggaaactaatgccctaaattaagattattcagcttctcaatttttaatagcaaaatggagacctgagtgtggataacttttagtatctgtgggggatcctggaaccaattccctgccaatatagaaggacaactgtctacagtacttgaagtattattaactacattcgccatgctgtatgttagatccccagaacatatttatcctgcatatctaaaattttgatcattttacaaactttctattttttttgtcaattttctccagctagacacttgtgcaatacggctattatctgatctttgccttaaatgttgtgcttcttttccatatgcacgtattttgcaaaatataaagtgtgtagagctatatagcactcagccaagtggtgggtacctgcaggtgcttcagagaagtaaattgatgctgctaatatttgttgaatggcacgaatatgatgagcaatagcaggtggtgcccttcagccagaccatcgctccgtgcgtctgatgcatcttgccaaagagtagttctgggaggtggttgcctctagagaacacattcctcctattctggggtcccgtgagagaaagaaatgcttttgcttttgatgtgggactcttactaagcctttcttcagagaaaaggaagtgaaaaatgcaccccatgataatcagtttcttacaacatactgtgatagtaccggcttcgttgtttttagctggaatcattagcttccatttttagaataacagctattggctaaattaggctacagtaggccattaagatggatgttggaattaaaaacatttttggaaaaaagcctgctttgagcctttgttataagcccttgggtagagatctgggtcctgtttctgatttcttgtgagccttcactctgacagttttgtttccagaaacacactcttagcctgctcctgaaatgggaacagacaggccaacttcccctctccagtctcccctgcgggtcaaagctttactttcctgtcatgttaagaaagaatagatttaaccttgataatccatgtagtattctgtatttttaccttttccttatctgaaaaaaagtgtatatatggcatggaattgattgcacaggcacatggcatgttggcttgtgaaccaattgttaaaatttcaagttaatcattaaaataatatctttcaaattaagttatattaaaaacaaaggtaacattctaaattcaaaaaaaaaaaaaaaaaa

SEQ ID NO: 29 - protein, 423 aa, Homo sapiens
MRSLGANMAAALRAAGVLLRDPLASSSWRVCQPWRWKSGAAAAAVTTETAQHAQGAKPQVQPQKRKPKTGILMLNMGGPETLGDVHDFLLRLFLDRDLMTLPIQNKLAPFIAKRRTPKIQEQYRRIGGGSPIKIWTSKQGEGMVKLLDELSPNTAPHKYYIGFRYVHPLTEEAIEEMERDGLERAIAFTQYPQYSCSTTGSSLNAIYRYYNQVGRKPTMKWSTIDRWPTHHLLIQCFADHILKELDHFPLEKRSEVVILFSAHSLPMSVVNRGDPYPQEVSATVQKVMERLEYCNPYRLVWQSKVGPMPWLGPQTDESIKGLCERGRKNILLVPIAFTSDHIETLYELDIEYSQVLAKECGVENIRRAESLNGNPLFSKALADLVHSHIQSNELCSKQLTLSCPLCVNPVCRETKSFFTSQQL

SEQ ID NO: 30 - DNA, 69 bp, Homo sapiens
gagctgagtctcttaatggaaatccattgttctctaaggccctggccgacttggtgcattcacacatcc

SEQ ID NO: 31 - DNA, 1240 bp, Homo sapiens
cacattgttctgatcatctgaagatcagctattagaagagaaagatcagttaagtcctttggacctgatcagcttgatacaagaactactgatttcaacttctttggcttaattctctcggaaacgatgaaatatacaagttatatcttggcttttcagctctgcatcgttttgggttctcttggctgttactgccaggacccatatgtaaaagaagcagaaaaccttaagaaatattttaatgcaggtcattcagatgtagcggataatggaactcttttcttaggcattttgaagaattggaaagaggagagtgacagaaaaataatgcagagccaaattgtctccttttacttcaaactttttaaaaactttaaagatgaccagagcatccaaaagagtgtggagaccatcaaggaagacatgaatgtcaagtttttcaatagcaacaaaaagaaacgagatgacttcgaaaagctgactaattattcggtaactgacttgaatgtccaacgcaaagcaatacatgaactcatccaagtgatggctgaactgtcgccagcagctaaaacagggaagcgaaaaaggagtcagatgctgtttcgaggtcgaagagcatcccagtaatggttgtcctgcctgcaatatttgaattttaaatctaaatctatttattaatatttaacattatttatatggggaatatatttttagactcatcaatcaaataagtatttataatagcaacttttgtgtaatgaaaatgaatatctattaatatatgtattatttataattcctatatcctgtgactgtctcacttaatcctttgttttctgactaattaggcaaggctatgtgattacaaggctttatctcaggggccaactaggcagccaacctaagcaagatcccatgggttgtgtgtttatttcacttgatgatacaatgaacacttataagtgaagtgatactatccagttactgccggtttgaaaatatgcctgcaatctgagccagtgctttaatggcatgtcagacagaacttgaatgtgtcaggtgaccctgatgaaaacatagcatctcaggagatttcatgcctggtgcttccaaatattgttgacaactgtgactgtacccaaatggaaagtaactcatttgttaaaattatcaatatctaatatatatgaataaagtgtaagttcacaacaaaaaaaaaaaaaaaaaaaaaaaaaaaaaa

SEQ ID NO: 32 - protein, 166 aa, Homo sapiens
MKYTSYILAFQLCIVLGSLGCYCQDPYVKEAENLKKYFNAGHSDVADNGTLFLGILKNWKEESDRKIMQSQIVSFYFKLFKNFKDDQSIQKSVETIKEDMNVKFFNSNKKKRDDFEKLTNYSVTDLNVQRKAIHELIQVMAELSPAAKTGKRKRSQMLFRGRRASQ

SEQ ID NO: 33 - DNA, 73 bp, Homo sapiens
cgagatgacttcgaaaagctgactaattattcggtaactgacttgaatgtccaacgcaaagcaatacatgaac

SEQ ID NO: 34 - DNA, 1409 bp, Homo sapiens
cgacttcctctttccagtgcatttaaggcgcagcctggaagtgccagggagcactggaggccacccagtcatgggggacaccttcatccgtcacatcgccctgctgggctttgagaagcgcttcgtacccagccagcactatgtgtacatgttcctggtgaaatggcaggacctgtcggagaaggtggtctaccggcgcttcaccgagatctacgagttccataaaaccttaaaagaaatgttccctattgaggcaggggcgatcaatccagagaacaggatcatcccccacctcccagctcccaagtggtttgacgggcagcgggccgccgagaaccgccagggcacacttaccgagtactgcggcacgctcatgagcctgcccaccaagatctcccgctgtccccacctcctcgacttcttcaaggtgcgccctgatgacctcaagctccccacggacaaccagacaaaaaagccagagacatacttgatgcccaaagatggcaagagtaccgcgacagacatcaccggccccatcatcctgcagacgtaccgcgccattgccaactacgagaagacctcgggctccgagatggctctgtccacgggggacgtggtggaggtcgtagagaagagcgagagcggttggtggttctgtcagatgaaagcaaagcgaggctggatcccagcgtccttcctcgagcccctggacagtcctgacgagacggaagaccctgagcccaactatgcaggtgagccatacgtcgccatcaaggcctacactgctgtggagggggacgaggtgtccctgctcgagggtgaagctgttgaggtcattcacaagctcctggacggctggtgggtcatcaggaaagacgacgtcacaggctacttcccgtccatgtacctgcaaaagtcagggcaagacgtgtcccaggcccaacgccagatcaagcggggggcgccgccccgcaggtcgtccatccgcaacgcgcacagcatccaccagcggtcgcggaagcgcctcagccaggacgcctatcgccgcaacagcgtccgttttctgcagcagcgacgccgccaggcgcggccgggaccgcagagccccgggagcccgctcgaggaggagcggcagacgcagcgctctaaaccgcagccggcggtgcccccgcggccgagcgccgacctcatcctgaaccgctgcagcgagagcaccaagcggaagctggcgtctgccgtctgaggctggagcgcagtccccagctagcgtctcggcccttgccgccccgtgcctgtacatacgtgttctatagagcctggcgtctggacgccgagggcagccccgacccctgtccagcgcggctcccgccaccctcaataaatgttgcttggagtggaaaaaaaaaaaa

SEQ ID NO: 35 - protein, 390 aa, Homo sapiens
MGDTFIRHIALLGFEKRFVPSQHYVYMFLVKWQDLSEKVVYRRFTEIYEFHKTLKEMFPIEAGAINPENRIIPHLPAPKWFDGQRAAENRQGTLTEYCGTLMSLPTKISRCPHLLDFFKVRPDDLKLPTDNQTKKPETYLMPKDGKSTATDITGPIILQTYRAIANYEKTSGSEMALSTGDVVEVVEKSESGWWFCQMKAKRGWIPASFLEPLDSPDETEDPEPNYAGEPYVAIKAYTAVEGDEVSLLEGEAVEVIHKLLDGWWVIRKDDVTGYFPSMYLQKSGQDVSQAQRQIKRGAPPRRSSIRNAHSIHQRSRKRLSQDAYRRNSVRFLQQRRRQARPGPQSPGSPLEEERQTQRSKPQPAVPPRPSADLILNRCSESTKRKLASAV

SEQ ID NO: 36 - DNA, 71 bp, Homo sapiens
ccgggaccgcagagccccgggagcccgctcgaggaggagcggcagacgcagcgctctaaaccgcagccggc

SEQ ID NO: 37 - DNA, 2168 bp, Homo sapiens
ggcgcgcgtgaacgcggtccccgggaccatgctgcggccacagcggcccggagacttgcagctcggggcctccctctacgagctggtgggctacaggcagccgccctcctcctcctcctcctccacctcctccacctcctccacttcctcctcctccacgacggcccccctcctccccaaggctgcgcgcgagaagccggaggcgccggccgagcctccaggccccgggcccgggtcaggcgcgcacccgggcggcagcgcccggccggacgccaaggaggagcagcagcagcagctgcggcgcaagatcaacagccgcgagcggaagcgcatgcaggacctgaacctggccatggacgccctgcgcgaggtcatcctgccctactcagcggcgcactgccagggcgcgcccggccgcaagctctccaagatagccacgctgctgctcgcccgcaactacatcctactgctgggcagctcgctgcaggagctgcgccgcgcgctgggcgagggcgccgggcccgccgcgccgcgcctgctgctggccgggctgcccctgctcgccgccgcgcccggctccgtgttgctggcgcccggcgccgtaggaccccccgacgcgctgcgccccgccaagtacctgtcgctggcgctggacgagccgccgtgcggccagttcgctctccccggcggcggcgcaggcggccccggcctctgcacctgcgccgtgtgcaagttcccgcacctggtcccggccagcctgggcctggccgccgtgcaggcgcaattctccaagtgagggcgggcctgggcctggggcgcgacctcggcccggcctcccttcgctcagcttctccgcgcccctgctccctgcgtctgggagagcgaggccgagcaaggaaagcatttcgaaccttccagtccagaggaagggactgtcgggcacccccttccccgcccccacccctgggacgttaaagtgaccagagcggatgttcgatggcgcctcggggcagtttggggttctgggtcggttccagcggctttaggcagaaagtgctcgctctcacccagcacatctctctccttgtccctggagttgcgcgcttcgcggggccgatgtagaacttagggcgccttgccgtggttggcgcgccccgggtgcagcgagaggccatccccgagcgctatctccccggagcggagcacgccggctcccagtactaggggctgcgctcgagcagtggcgggggcggaggggtggttcttttccttctcctccgccagaggccacgggcgcccttgttcccgccggccaggtcctatcaaaggaggctgccggaactcaagaggcagaaaaagaccagttaggcggtgcagacggtctgggacgtggcagacggacggaccctcggcggacaggtggtcggcgtcggggtgcggtgggtaggggcgaggacaacgcagggtgcgctgggttgggacgtgggtccacttttgtagaccagctgtttggagagctgtatttaagactcgcgtatccagtgttttgtcgcagagagttttcgctcttaaatcctgggggtttcttagaaagcaacttagaactcgagattcacctttcgtttccctttccccaaaagtagcgtaaccaacatttaagcttgcttaaaaacgaaaaccaaccgccttgcatccagtgttcccgatttactaaaataggtaaccaggcgtctcacagtcgccgtcctgtcaagagcgctaatgaacgttctcattaacacgcaggagtaccgggagccctgaaccgcccgctgctcggcggatcccagctgcggtggcgacggcgggaaggcgctttccgctgttcctcagcgggccgggcccttgaccagcgcggcccgcaggtcttccttctcgccgtcttgcagttgaagagctacatacgtagtcagtttcgatttgttacagacgttaacaaattcctttacccaaggttatgctatgacctttccgcagtttactttgattttctatgtttaaggttttggttgttggtagtagccgaatttaactggcactttattttacttctaaccttgtttcctgacggtgtacagaatcaacaaaataaaacatttaaagtctgattttttaaaaaaaaaaaaaaa

SEQ ID NO: 38 - protein, 255 aa, Homo sapiens
MLRPQRPGDLQLGASLYELVGYRQPPSSSSSSTSSTSSTSSSSTTAPLLPKAAREKPEAPAEPPGPGPGSGAHPGGSARPDAKEEQQQQLRRKINSRERKRMQDLNLAMDALREVILPYSAAHCQGAPGRKLSKIATLLLARNYILLLGSSLQELRRALGEGAGPAAPRLLLAGLPLLAAAPGSVLLAPGAVGPPDALRPAKYLSLALDEPPCGQFALPGGGAGGPGLCTCAVCKFPHLVPASLGLAAVQAQFSK

SEQ ID NO: 39 - DNA, 63 bp, Homo sapiens
gaaaaccaaccgccttgcatccagtgttcccgatttactaaaataggtaaccaggcgtctcac

SEQ ID NO: 40 - DNA, 2505 bp, Homo sapiens
gtgcggatgcttattatagatcgacgcgacaccagcgcccggtgccaggttctcccctgaggcttttcggagcgagctcctcaaatcgcatccagattttcgggtccgagggaaggaggaccctgcgaaagctgcgacgactatcttcccctggggccatggactcggacgccagcctggtgtccagccgcccgtcgtcgccagagcccgatgacctttttctgccggcccggagtaagggcagcagcggcagcgccttcactgggggcaccgtgtcctcgtccaccccgagtgactgcccgccggagctgagcgccgagctgcgcggcgctatgggctctgcgggcgcgcatcctggggacaagctaggaggcagtggcttcaagtcatcctcgtccagcacctcgtcgtctacgtcgtcggcggctgcgtcgtccaccaagaaggacaagaagcaaatgacagagccggagctgcagcagctgcgtctcaagatcaacagccgcgagcgcaagcgcatgcacgacctcaacatcgccatggatggcctccgcgaggtcatgccgtacgcacacggcccttcggtgcgcaagctttccaagatcgccacgctgctgctggcgcgcaactacatcctcatgctcaccaactcgctggaggagatgaagcgactggtgagcgagatctacgggggccaccacgctggcttccacccgtcggcctgcggcggcctggcgcactccgcgcccctgcccgccgccaccgcgcacccggcagcagcagcgcacgccgcacatcaccccgcggtgcaccaccccatcctgccgcccgccgccgcagcggctgctgccgccgctgcagccgcggctgtgtccagcgcctctctgcccggatccgggctgccgtcggtcggctccatccgtccaccgcacggcctactcaagtctccgtctgctgccgcggccgccccgctggggggcgggggcggcggcagtggggcgagcgggggcttccagcactggggcggcatgccctgcccctgcagcatgtgccaggtgccgccgccgcaccaccacgtgtcggctatgggcgccggcagcctgccgcgcctcacctccgacgccaagtgagccgactggcgccggcgcgttctggcgacaggggagccaggggccgcggggaagcgaggactggcctgcgctgggctcgggagctctgtcgcgaggaggggcgcaggaccatggactgggggtggggcatggtggggattccagcatctgcgaacccaagcaatgggggcgcccacagagcagtggggagtgaggggatgttctctccgggacctgatcgagcgctgtctggctttaacctgagctggtccagtagacatcgttttatgaaaaggtaccgctgtgtgcattcctcactagaactcatccgacccccgacccccacctccgggaaaagattctaaaaacttctttccctgagagcgtggcctgacttgcagactcggcttgggcagcacttcggggggggagggggtgttatgggagggggacacattggggccttgctcctcttcctcctttcttggcgggtgggagactccgggtagccgcactgcagaagcaacagcccgaccgcgccctccagggtcgtccctggcccaaggccaggggccacaagttagttggaagccggcgttcggtatcagaagcgctgatggtcatatccaatctcaatatctgggtcaatccacaccctcttagaactgtggccgttcctccctgtctctcgttgatttgggagaatatggttttctaataaatctgtggatgttccttcttcaacagtatgagcaagtttatagacattcagagtagaaccacttgtggattggaataacccaaaactgccgatttcaggggcgggtgcattgtagttattattttaaaatagaaactaccccaccgactcatctttccttctctaagcacaaagtgatttggttattttggtacctgagaacgtaacagaattaaaaggcagttgctgtggaaacagtttgggttatttgggggttctgttggctttttaaaattttcttttttggatgtgtaaatttatcaatgatgaggtaagtgcgcaatgctaagctgtttgctcacgtgactgccagccccatcggagtctaagccggctttcctctattttggtttatttttgccacgtttaacacaaatggtaaactcctccacgtgcttcctgcgttccgtgcaagccgcctcggcgctgcctgcgttgcaaactgggctttgtagcgtctgccgtgtaacacccttcctctgatcgcaccgcccctcgcagagagtgtatcatctgttttatttttgtaaaaacaaagtgctaaataatatttattacttgtttggttgcaaaaacggaataaatgactgagtgttgagattttaaataaaatttaaagcaaaaaaaaaaaaaaaa

SEQ ID NO: 41 - protein, 323 aa, Homo sapiens
MDSDASLVSSRPSSPEPDDLFLPARSKGSSGSAFTGGTVSSSTPSDCPPELSAELRGAMGSAGAHPGDKLGGSGFKSSSSSTSSSTSSAAASSTKKDKKQMTEPELQQLRLKINSRERKRMHDLNIAMDGLREVMPYAHGPSVRKLSKIATLLLARNYILMLTNSLEEMKRLVSEIYGGHHAGFHPSACGGLAHSAPLPAATAHPAAAAHAAHHPAVHHPILPPAAAAAAAAAAAAAVSSASLPGSGLPSVGSIRPPHGLLKSPSAAAAAPLGGGGGGSGASGGFQHWGGMPCPCSMCQVPPPHHHVSAMGAGSLPRLTSDAK

SEQ ID NO: 42 - DNA, 97 bp, Homo sapiens
ttctcccctgaggcttttcggagcgagctcctcaaatcgcatccagattttcgggtccgagggaaggaggaccctgcgaaagctgcgacgactatct

SEQ ID NO: 43 - DNA, 3547 bp, Homo sapiens
gagagacgagggcagcggaggaggcgaggagcgccgggtaccgggccgggggagccgcgggctctcggggaagagacggatgatgaacaagctttacatcgggaacctgagccccgccgtcaccgccgacgacctccggcagctctttggggacaggaagctgcccctggcgggacaggtcctgctgaagtccggctacgccttcgtggactaccccgaccagaactgggccatccgcgccatcgagaccctctcgggtaaagtggaattgcatgggaaaatcatggaagttgattactcagtctctaaaaagctaaggagcaggaaaattcagattcgaaacatccctcctcacctgcagtgggaggtgttggatggacttttggctcaatatgggacagtggagaatgtggaacaagtcaacacagacacagaaaccgccgttgtcaacgtcacatatgcaacaagagaagaagcaaaaatagccatggagaagctaagcgggcatcagtttgagaactactccttcaagatttcctacatcccggatgaagaggtgagctccccttcgccccctcagcgagcccagcgtggggaccactcttcccgggagcaaggccacgcccctgggggcacttctcaggccagacagattgatttcccgctgcggatcctggtccccacccagtttgttggtgccatcatcggaaaggagggcttgaccataaagaacatcactaagcagacccagtcccgggtagatatccatagaaaagagaactctggagctgcagagaagcctgtcaccatccatgccaccccagaggggacttctgaagcatgccgcatgattcttgaaatcatgcagaaagaggcagatgagaccaaactagccgaagagattcctctgaaaatcttggcacacaatggcttggttggaagactgattggaaaagaaggcagaaatttgaagaaaattgaacatgaaacagggaccaagataacaatctcatctttgcaggatttgagcatatacaacccggaaagaaccatcactgtgaagggcacagttgaggcctgtgccagtgctgagatagagattatgaagaagctgcgtgaggcctttgaaaatgatatgctggctgttaacacccactccggatacttctccagcctgtacccccatcaccagtttggcccgttcccgcatcatcactcttatccagagcaggagattgtgaatctcttcatcccaacccaggctgtgggcgccatcatcgggaagaagggggcacacatcaaacagctggcgagattcgccggagcctctatcaagattgcccctgcggaaggcccagacgtcagcgaaaggatggtcatcatcaccgggccaccggaagcccagttcaaggcccagggacggatctttgggaaactgaaagaggaaaacttctttaaccccaaagaagaagtgaagctggaagcgcatatcagagtgccctcttccacagctggccgggtgattggcaaaggtggcaagaccgtgaacgaactgcagaacttaaccagtgcagaagtcatcgtgcctcgtgaccaaacgccagatgaaaatgaggaagtgatcgtcagaattatcgggcacttctttgctagccagactgcacagcgcaagatcagggaaattgtacaacaggtgaagcagcaggagcagaaataccctcagggagtcgcctcacagcgcagcaagtgaggctcccacaggcaccagcaaaacaacggatgaatgtagcccttccaacacctgacagaatgagaccaaacgcagccagccagatcgggagcaaaccaaagaccatctgaggaatgagaagtctgcggaggcggccagggactctgccgaggccctgagaaccccaggggccgaggaggggcggggaaggtcagccaggtttgccagaaccaccgagccccgcctcccgccccccagggcttctgcaggcttcagccatccacttcaccatccactcggatctctcctgaactcccacgacgctatcccttttagttgaactaacataggtgaacgtgttcaaagccaagcaaaatgcacaccctttttctgtggcaaatcgtctctgtacatgtgtgtacatattagaaagggaagatgttaagatatgtggcctgtgggttacacagggtgcctgcagcggtaatatattttagaaataatatatcaaataactcaactaactccaatttttaatcaattattaatttttttttctttttaaagagaaagcaggcttttctagactttaaagaataaagtctttgggaggtctcacggtgtagagaggagctttgaggccacccgcacaaaattcacccagagggaaatctcgtcggaaggacactcacggcagttctggatcacctgtgtatgtcaacagaagggataccgtctccttgaagaggaaactctgtcactcctcatgcctgtctagctcatacacccatttctctttgcttcacaggttttaaactggttttttgcatactgctatataattctctgtctctctctgtttatctctcccctccctcccctccccttcttctccatctccattcttttgaatttcctcatccctccatctcaatcccgtatctacgcacccccccccccccaggcaaagcagtgctctgagtatcacatcacacaaaaggaacaaaagcgaaacacacaaaccagcctcaacttacacttggttactcaaaagaacaagagtcaatggtacttgtcctagcgttttggaagaggaaaacaggaacccaccaaaccaaccaatcaaccaaacaaagaaaaaattccacaatgaaagaatgtattttgtctttttgcattttggtgtataagccatcaatattcagcaaaatgattcctttctttaaaaaaaaaaaatgtggaggaaagtagaaatttaccaaggttgttggcccagggcgttaaattcacagatttttttaacgagaaaaacacacagaagaagctacctcaggtgtttttacctcagcaccttgctcttgtgtttcccttagagattttgtaaagctgatagttggagcatttttttatttttttaataaaaatgagttggaaaaaaaataagatatcaactgccagcctggagaaggtgacagtccaagtgtgcaacagctgttctgaattgtcttccgctagccaagaacctatatggccttcttttggacaaaccttgaaaatgtttatttaaaaaaaaaaaagatgacaaagaaaaacagagagagagaatattggagatgtcctgaattttaatagggtacgcgccattagggctttttgcgctaaaggatgaacatgtactggtttatgtggacaagccattataccaccagactgcaatgccagtttcctctactgcaaacagtgttctgtgacaaaaaaaaaaaaaaaaaaaagaaaaaaaaagaaaaaacagaaatatatccagctaacaagaaaaaa

SEQ ID NO: 44 - protein, 556 aa, Homo sapiens
MMNKLYIGNLSPAVTADDLRQLFGDRKLPLAGQVLLKSGYAFVDYPDQNWAIRAIETLSGKVELHGKIMEVDYSVSKKLRSRKIQIRNIPPHLQWEVLDGLLAQYGTVENVEQVNTDTETAVVNVTYATREEAKIAMEKLSGHQFENYSFKISYIPDEEVSSPSPPQRAQRGDHSSREQGHAPGGTSQARQIDFPLRILVPTQFVGAIIGKEGLTIKNITKQTQSRVDIHRKENSGAAEKPVTIHATPEGTSEACRMILEIMQKEADETKLAEEIPLKILAHNGLVGRLIGKEGRNLKKIEHETGTKITISSLQDLSIYNPERTITVKGTVEACASAEIEIMKKLREAFENDMLAVNTHSGYFSSLYPHHQFGPFPHHHSYPEQEIVNLFIPTQAVGAIIGKKGAHIKQLARFAGASIKIAPAEGPDVSERMVIITGPPEAQFKAQGRIFGKLKEENFFNPKEEVKLEAHIRVPSSTAGRVIGKGGKTVNELQNLTSAEVIVPRDQTPDENEEVIVRIIGHFFASQTAQRKIREIVQQVKQQEQKYPQGVASQRSK

SEQ ID NO: 45 - DNA, 82 bp, Homo sapiens
gatcgtcagaattatcgggcacttctttgctagccagactgcacagcgcaagatcagggaaattgtacaacaggtgaagcag

SEQ ID NO: 46 - DNA, 3393 bp, Homo sapiens
cctgcctgcctccctgcgcacccgcagcctcccccgctgcctccctagggctcccctccggccgccagcgcccatttttcattccctagatagagatactttgcgcgcacacacatacatacgcgcgcaaaaaggaaaaaaaaaaaaaaaagcccaccctccagcctcgctgcaaagagaaaaccggagcagccgcagctcgcagctcgcagctcgcagcccgcagcccgcagaggacgcccagagcggcgagcgggcgggcagacggaccgacggactcgcgccgcgtccacctgtcggccgggcccagccgagcgcgcagcgggcacgccgcgcgcgcggagcagccgtgcccgccgcccgggccccgcgccagggcgcacacgctcccgcccccctacccggcccgggcgggagtttgcacctctccctgcccgggtgctcgagctgccgttgcaaagccaactttggaaaaagttttttgggggagacttgggccttgaggtgcccagctccgcgctttccgattttgggggcctttccagaaaatgttgcaaaaaagctaagccggcgggcagaggaaaacgcctgtagccggcgagtgaagacgaaccatcgactgccgtgttccttttcctcttggaggttggagtcccctgggcgcccccacacggctagacgcctcggctggttcgcgacgcagccccccggccgtggatgctcactcgggctcgggatccgcccaggtagcggcctcggacccaggtcctgcgcccaggtcctcccctgccccccagcgacggagccggggccgggggcggcggcgcccgggggccatgcgggtgagccgcggctgcagaggcctgagcgcctgatcgccgcggacccgagccgagcccacccccctccccagccccccaccctggccgcgggggcggcgcgctcgatctacgcgtccggggccccgcggggccgggcccggagtcggcatgaatcgctgctgggcgctcttcctgtctctctgctgctacctgcgtctggtcagcgccgagggggaccccattcccgaggagctttatgagatgctgagtgaccactcgatccgctcctttgatgatctccaacgcctgctgcacggagaccccggagaggaagatggggccgagttggacctgaacatgacccgctcccactctggaggcgagctggagagcttggctcgtggaagaaggagcctgggttccctgaccattgctgagccggccatgatcgccgagtgcaagacgcgcaccgaggtgttcgagatctcccggcgcctcatagaccgcaccaacgccaacttcctggtgtggccgccctgtgtggaggtgcagcgctgctccggctgctgcaacaaccgcaacgtgcagtgccgccccacccaggtgcagctgcgacctgtccaggtgagaaagatcgagattgtgcggaagaagccaatctttaagaaggccacggtgacgctggaagaccacctggcatgcaagtgtgagacagtggcagctgcacggcctgtgacccgaagcccggggggttcccaggagcagcgagccaaaacgccccaaactcgggtgaccattcggacggtgcgagtccgccggccccccaagggcaagcaccggaaattcaagcacacgcatgacaagacggcactgaaggagacccttggagcctaggggcatcggcaggagagtgtgtgggcagggttatttaatatggtatttgctgtattgcccccatggggtccttggagtgataatattgtttccctcgtccgtctgtctcgatgcctgattcggacggccaatggtgcttcccccacccctccacgtgtccgtccacccttccatcagcgggtctcctcccagcggcctccggcgtcttgcccagcagctcaagaagaaaaagaaggactgaactccatcgccatcttcttcccttaactccaagaacttgggataagagtgtgagagagactgatggggtcgctctttgggggaaacgggctccttcccctgcacctggcctgggccacacctgagcgctgtggactgtcctgaggagccctgaggacctctcagcatagcctgcctgatccctgaacccctggccagctctgaggggaggcacctccaggcaggccaggctgcctcggactccatggctaagaccacagacgggcacacagactggagaaaacccctcccacggtgcccaaacaccagtcacctcgtctccctggtgcctctgtgcacagtggcttcttttcgttttcgttttgaagacgtggactcctcttggtgggtgtggccagcacaccaagtggctgggtgccctctcaggtgggttagagatggagtttgctgttgaggtggctgtagatggtgacctgggtatcccctgcctcctgccaccccttcctccccacactccactctgattcacctcttcctctggttcctttcatctctctacctccaccctgcattttcctcttgtcctggcccttcagtctgctccaccaaggggctcttgaaccccttattaaggccccagatgatcccagtcactcctctctagggcagaagactagaggccagggcagcaagggacctgctcatcatattccaacccagccacgactgccatgtaaggttgtgcagggtgtgtactgcacaaggacattgtatgcagggagcactgttcacatcatagataaagctgatttgtatatttattatgacaatttctggcagatgtaggtaaagaggaaaaggatccttttcctaattcacacaaagactccttgtggactggctgtgcccctgatgcagcctgtggcttggagtggccaaataggagggagactgtggtaggggcagggaggcaacactgctgtccacatgacctccatttcccaaagtcctctgctccagcaactgcccttccaggtgggtgtgggacacctgggagaaggtctccaagggagggtgcagccctcttgcccgcacccctccctgcttgcacacttccccatctttgatccttctgagctccacctctggtggctcctcctaggaaaccagctcgtgggctgggaatgggggagagaagggaaaagatccccaagaccccctggggtgggatctgagctcccacctcccttcccacctactgcactttcccccttcccgccttccaaaacctgcttccttcagtttgtaaagtcggtgattatatttttgggggctttccttttattttttaaatgtaaaatttatttatattccgtatttaaagttgtaaaaaaaaataaccacaaaacaaaaccaaatgaaaaaaaaaaaaaaaaaa

SEQ ID NO: 47 - protein, 241 aa, Homo sapiens
MNRCWALFLSLCCYLRLVSAEGDPIPEELYEMLSDHSIRSFDDLQRLLHGDPGEEDGAELDLNMTRSHSGGELESLARGRRSLGSLTIAEPAMIAECKTRTEVFEISRRLIDRTNANFLVWPPCVEVQRCSGCCNNRNVQCRPTQVQLRPVQVRKIEIVRKKPIFKKATVTLEDHLACKCETVAAARPVTRSPGGSQEQRAKTPQTRVTIRTVRVRRPPKGKHRKFKHTHDKTALKETLGA

SEQ ID NO: 48 - DNA, 141 bp, Homo sapiens
gacaagacggcactgaaggagacccttggagcctaggggcatcggcaggagagtgtgtgggcagggttatttaatatggtatttgctgtattgcccccatggggtccttggagtgataatattgtttccctcgtccgtctg

SEQ ID NO: 49 - DNA, 466 bp, Homo sapiens
accactgctggctttttgctgtagctccacattcctgtgcattgaggggttaacattaggctgggaagatgacaaaacttgaagagcatctggagggaattgtcaatatcttccaccaatactcagttcggaaggggcattttgacaccctctctaagggtgagctgaagcagctgcttacaaaggagcttgcaaacaccatcaagaatatcaaagataaagctgtcattgatgaaatattccaaggcctggatgctaatcaagatgaacaggtcgactttcaagaattcatatccctggtagccattgcgctgaaggctgcccattaccacacccacaaagagtaggtagctctctgaaggctttttacccagcaatgtcctcaatgagggtcttttctttccctcaccaaaacccagccttgcccgtggggagtaagagttaataaacacactcacgaaaagtt

SEQ ID NO: 50 - protein, 92 aa, Homo sapiens
MTKLEEHLEGIVNIFHQYSVRKGHFDTLSKGELKQLLTKELANTIKNIKDKAVIDEIFQGLDANQDEQVDFQEFISLVAIALKAAHYHTHKE

SEQ ID NO: 51 - DNA, 102 bp, Homo sapiens
tctctaagggtgagctgaagcagctgcttacaaaggagcttgcaaacaccatcaagaatatcaaagataaagctgtcattgatgaaatattccaaggcctgg

SEQ ID NO: 52 - DNA, 428 bp, Homo sapiens
atgtctcttgtcagctgtctttcagaagacctggtggggcaagtccgtgggcatcatgttgaccgagctggagaaagccttgaactctatcatcgacgtctaccacaagtactccctgataaaggggaatttccatgccgtctacagggatgacctgaagaaattgctagagaccgagtgtcctcagtatatcaggaaaaagggtgcagacgtctggttcaaagagttggatatcaacactgatggtgcagttaacttccaggagttcctcattctggtgataaagatgggcgtggcagcccacaaaaaaagccatgaagaaagccacaaagagtagctgagttactgggcccagaggctgggcccctggacatgtacctgcagaataataaagtcatcaatacctcaaaaaaaaaaaaaaaaaaaaa

SEQ ID NO: 53 - protein, 93 aa, Homo sapiens
MLTELEKALNSIIDVYHKYSLIKGNFHAVYRDDLKKLLETECPQYIRKKGADVWFKELDINTDGAVNFQEFLILVIKMGVAAHKKSHEESHKE

SEQ ID NO: 54 - DNA, 93 bp, Homo sapiens
gaagaaattgctagagaccgagtgtcctcagtatatcaggaaaaagggtgcagacgtctggttcaaagagttggatatcaacactgatggtgc

SEQ ID NO: 55 - DNA, 586 bp, Homo sapiens
aaacactctgtgtggctcctcggctttgacagagtgcaagacgatgacttgcaaaatgtcgcagctggaacgcaacatagagaccatcatcaacaccttccaccaatactctgtgaagctggggcacccagacaccctgaaccagggggaattcaaagagctggtgcgaaaagatctgcaaaattttctcaagaaggagaataagaatgaaaaggtcatagaacacatcatggaggacctggacacaaatgcagacaagcagctgagcttcgaggagttcatcatgctgatggcgaggctaacctgggcctcccacgagaagatgcacgagggtgacgagggccctggccaccaccataagccaggcctcggggagggcaccccctaagaccacagtggccaagatcacagtggccacggccacggccacagtcatggtggccacggccacagccactaatcaggaggccaggccaccctgcctctacccaaccagggccccggggcctgttatgtcaaactgtcttggctgtggggctaggggctggggccaaataaagtctcttcctccaagtcaaaaaaaaaa

SEQ ID NO: 56 - protein, 114 aa, Homo sapiens
MTCKMSQLERNIETIINTFHQYSVKLGHPDTLNQGEFKELVRKDLQNFLKKENKNEKVIEHIMEDLDTNADKQLSFEEFIMLMARLTWASHEKMHEGDEGPGHHHKPGLGEGTP

SEQ ID NO: 57 - DNA, 58 bp, Homo sapiens
gccacggccacagtcatggtggccacggccacagccactaatcaggaggccaggccac

SEQ ID NO: 58 - DNA, 2341 bp, Homo sapiens
gaagggcccctcccactgagtcggctctggtctccccgcccctgagccgcgaggactggacgcagctggctgcggagctctgggcgggcgctggggtcgcctgttgcagcctctcttccgcccggcggcccacaccggtcaggcccggcgcgggctgcgctctccagctgtggctatggccccagccccgagatgaggagggagagaactaggggcccgcaggcctgggaatttccgtcccccaccaagtccggatgctcactccaaagtctcagcaggcccctgagggagggagctgtcagccagggaaaaccgagaacaccatcaccatgacaaccagtcaccagcctcaggacagatacaaagctgtctggcttatcttcttcatgctgggtctgggaacgctgctcccgtggaattttttcatgacggccactcagtatttcacaaaccgcctggacatgtcccagaatgtgtccttggtcactgctgaactgagcaaggacgcccaggcgtcagccgcccctgcagcacccttgcctgagcggaactctctcagtgccatcttcaacaatgtcatgaccctatgtgccatgctgcccctgctgttattcacctacctcaactccttcctgcatcagaggatcccccagtccgtacggatcctgggcagcctggtggccatcctgctggtgtttctgatcactgccatcctggtgaaggtgcagctggatgctctgcccttctttgtcatcaccatgatcaagatcgtgctcattaattcatttggtgccatcctgcagggcagcctgtttggtctggctggccttctgcctgccagctacacggcccccatcatgagtggccagggcctagcaggcttctttgcctccgtggccatgatctgcgctattgccagtggctcggagctatcagaaagtgccttcggctactttatcacagcctgtgctgttatcattttgaccatcatctgttacctgggcctgccccgcctggaattctaccgctactaccagcagctcaagcttgaaggacccggggagcaggagaccaagttggacctcattagcaaaggagaggagccaagagcaggcaaagaggaatctggagtttcagtctccaactctcagcccaccaatgaaagccactctatcaaagccatcctgaaaaatatctcagtcctggctttctctgtctgcttcatcttcactatcaccattgggatgtttccagccgtgactgttgaggtcaagtccagcatcgcaggcagcagcacctgggaacgttacttcattcctgtgtcctgtttcttgactttcaatatctttgactggttgggccggagcctcacagctgtattcatgtggcctgggaaggacagccgctggctgccaagcctggtgctggcccggctggtgtttgtgccactgctgctgctgtgcaacattaagccccgccgctacctgactgtggtcttcgagcacgatgcctggttcatcttcttcatggctgcctttgccttctccaacggctacctcgccagcctctgcatgtgcttcgggcccaagaaagtgaagccagctgaggcagagaccgcaggagccatcatggccttcttcctgtgtctgggtctggcactgggggctgttttctccttcctgttccgggcaattgtgtgacaaaggatggacagaaggactgcctgcctccctccctgtctgcctcctgccccttccttctgccaggggtgatcctgagtggtctggcggttttttcttctaactgacttctgctttccacggcgtgtgctgggcccggatctccaggccctggggagggagcctctggacggacagtggggacattgtgggtttggggctcagagtcgagggacggggtgtagcctcggcatttgcttgagtttctccactcttggctctgactgatccctgcttgtgcaggccagtggaggctcttgggcttggagaacacgtgtgtctctgtgtatgtgtctgtgtgtctgcgtccgtgtctgtcagactgtctgcctgtcctggggtggctaggagctgggtctgaccgttgtatggtttgacctgatatactccattctcccctgcgcctcctcctctgtgttctctccatgtccccctcccaactccccatgcccagttcttacccatcatgcaccctgtacagttgccacgttactgccttttttaaaaatatatttgacagaaaccaggtgccttcagaggctctctgatttaaataaacctttcttgtttttttctccatggctaaaaaaaaaaaaaaaaaa

SEQ ID NO: 59 - protein, 456 aa, Homo sapiens [sequence omitted]

SEQ ID NO: 60 - DNA, 66 bp, Homo sapiens
ccagcctctgcatgtgcttcgggcccaagaaagtgaagccagctgaggcagagaccgcaggagcca

SEQ ID NO: 61 - DNA, 3431 bp, Homo sapiens
ggttttcaggagcccgagcgagggcgccgcttttgcgtccgggaggagccaaccgtggcgcaggcggcgcggggaggcgtcccagagtctcactctgccgcccaggctggactgcagtgacacaatctcggctgactgcaaccactgcctccagggttcaagcgattctcttgcctcagcctcccaagtagctgggattacagattgatgttcatgttcctgacactactacaagattcatactcctgatgctactgacaacgtggcttctccacagtcaccaaaccagggatgctatactggacttccctactctcatctgctccagccccctgaccttatagttgcccagctttcctggcaattgactttgcccatcaatacacaggatttagcatccagggaagatgtcggagcctcagatgttaattttctaattgagaatgttggcgctgtccgaacctggagacaggaaaacaaaaagtcctttctcctgattcaccaaaaaataaaatactgactaccatcactgtgatgagattcctatagtctcaggaactgaagtctttaaacaaccagggaccctctgcccctagaataagaacatactagaagtcccttctgctaggacaacgaggatcatgggagaccacctggaccttctcctaggagtggtgctcatggccggtcctgtgtttggaattccttcctgctcctttgatggccgaatagccttttatcgtttctgcaacctcacccaggtcccccaggtcctcaacaccactgagaggctcctgctgagcttcaactatatcaggacagtcactgcttcatccttcccctttctggaacagctgcagctgctggagctcgggagccagtatacccccttgactattgacaaggaggccttcagaaacctgcccaaccttagaatcttggacctgggaagtagtaagatatacttcttgcatccagatgcttttcagggactgttccatctgtttgaacttagactgtatttctgtggtctctctgatgctgtattgaaagatggttatttcagaaatttaaaggctttaactcgcttggatctatccaaaaatcagattcgtagcctttaccttcatccttcatttgggaagttgaattccttaaagtccatagatttttcctccaaccaaatattccttgtatgtgaacatgagctcgagcccctacaagggaaaacgctctccttttttagcctcgcagctaatagcttgtatagcagagtctcagtggactggggaaaatgtatgaacccattcagaaacatggtgctggagatactagatgtttctggaaatggctggacagtggacatcacaggaaactttagcaatgccatcagcaaaagccaggccttctctttgattcttgcccaccacatcatgggtgccgggtttggcttccataacatcaaagatcctgaccagaacacatttgctggcctggccagaagttcagtgagacacctggatctttcacatgggtttgtcttctccctgaactcacgagtctttgagacactcaaggatttgaaggttctgaaccttgcctacaacaagataaataagattgcagatgaagcattttacggacttgacaacctccaagttctcaatttgtcatataaccttctgggggaactttacagttcgaatttctatggactacctaaggtagcctacattgatttgcaaaagaatcacattgcaataattcaagaccaaacattcaaattcctggaaaaattacagaccttggatctccgagacaatgctcttacaaccattcattttattccaagcatacccgatatcttcttgagtggcaataaactagtgactttgccaaagatcaaccttacagcgaacctcatccacttatcagaaaacaggctagaaaatctagatattctctactttctcctacgggtacctcatctccagattctcattttaaatcaaaatcgcttctcctcctgtagtggagatcaaaccccttcagagaatcccagcttagaacagcttttccttggagaaaatatgttgcaacttgcctgggaaactgagctctgttgggatgtttttgagggactttctcatcttcaagttctgtatttgaatcataactatcttaattcccttccaccaggagtatttagccatctgactgcattaaggggactaagcctcaactccaacaggctgacagttctttctcacaatgatttacctgctaatttagagatcctggacatatccaggaaccagctcctagctcctaatcctgatgtatttgtatcacttagtgtcttggatataactcataacaagttcatttgtgaatgtgaacttagcacttttatcaattggcttaatcacaccaatgtcactatagctgggcctcctgcagacatatattgtgtgtaccctgactcgttctctggggtttccctcttctctctttccacggaaggttgtgatgaagaggaagtcttaaagtccctaaagttctcccttttcattgtatgcactgtcactctgactctgttcctcatgaccatcctcacagtcacaaagttccggggcttctgttttatctgttataagacagcccagagactggtgttcaaggaccatccccagggcacagaacctgatatgtacaaatatgatgcctatttgtgcttcagcagcaaagacttcacatgggtgcagaatgctttgctcaaacacctggacactcaatacagtgaccaaaacagattcaacctgtgctttgaagaaagagactttgtcccaggagaaaaccgcattgccaatatccaggatgccatctggaacagtagaaagatcgtttgtcttgtgagcagacacttccttagagatggctggtgccttgaagccttcagttatgcccagggcaggtgcttatctgaccttaacagtgctctcatcatggtggtggttgggtccttgtcccagtaccagttgatgaaacatcaatccatcagaggctttgtacagaaacagcagtatttgaggtggcctgaggatctccaggatgttggctggtttcttcataaactctctcaacagatactaaagaaagaaaaagaaaagaagaaagacaataacattccgttgcaaactgtagcaaccatctcctaatcaaaggagcaatttccaacttatctcaagccacaaataactcttcactttgtatttgcaccaagttatcattttggggtcctctctggaggttttttttttctttttgctactatgaaaacaacataaatctctcaattttcgtatcaacaccatgttctgtctcactaacctccaaatggaaaataatagatctagaaaattgcaactgcc

SEQ ID NO: 62 - protein, 858 aa, Homo sapiens
MGDHLDLLLGVVLMAGPVFGIPSCSFDGRIAFYRFCNLTQVPQVLNTTERLLLSFNYIRTVTASSFPFLEQLQLLELGSQYTPLTIDKEAFRNLPNLRILDLGSSKIYFLHPDAFQGLFHLFELRLYFCGLSDAVLKDGYFRNLKALTRLDLSKNQIRSLYLHPSFGKLNSLKSIDFSSNQIFLVCEHELEPLQGKTLSFFSLAANSLYSRVSVDWGKCMNPFRNMVLEILDVSGNGWTVDITGNFSNAISKSQAFSLILAHHIMGAGFGFHNIKDPDQNTFAGLARSSVRHLDLSHGFVFSLNSRVFETLKDLKVLNLAYNKINKIADEAFYGLDNLQVLNLSYNLLGELYSSNFYGLPKVAYIDLQKNHIAIIQDQTFKFLEKLQTLDLRDNALTTIHFIPSIPDIFLSGNKLVTLPKINLTANLIHLSENRLENLDILYFLLRVPHLQILILNQNRFSSCSGDQTPSENPSLEQLFLGENMLQLAWETELCWDVFEGLSHLQVLYLNHNYLNSLPPGVFSHLTALRGLSLNSNRLTVLSHNDLPANLEILDISRNQLLAPNPDVFVSLSVLDITHNKFICECELSTFINWLNHTNVTIAGPPADIYCVYPDSFSGVSLFSLSTEGCDEEEVLKSLKFSLFIVCTVTLTLFLMTILTVTKFRGFCFICYKTAQRLVFKDHPQGTEPDMYKYDAYLCFSSKDFTWVQNALLKHLDTQYSDQNRFNLCFEERDFVPGENRIANIQDAIWNSRKIVCLVSRHFLRDGWCLEAFSYAQGRCLSDLNSALIMVVVGSLSQYQLMKHQSIRGFVQKQQYLRWPEDLQDVGWFLHKLSQQILKKEKEKKKDNNIPLQTVATIS

SEQ ID NO: 63 - DNA, 103 bp, Homo sapiens
ccctctgcccctagaataagaacatactagaagtcccttctgctaggacaacgaggatcatgggagaccacctggaccttctcctaggagtggtgctcatggc

SEQ ID NO: 64 - DNA, 1669 bp, Homo sapiens
ctccctcagcaaggacagcagaggaccagctaagagggagagaagcaactacagaccccccctgaaaacaaccctcagacgccacatcccctgacaagctgccaggcaggttctcttcctctcacatactgacccacggctccaccctctctcccctggaaaggacaccatgagcactgaaagcatgatccgggacgtggagctggccgaggaggcgctccccaagaagacaggggggccccagggctccaggcggtgcttgttcctcagcctcttctccttcctgatcgtggcaggcgccaccacgctcttctgcctgctgcactttggagtgatcggcccccagagggaagagttccccagggacctctctctaatcagccctctggcccaggcagtcagatcatcttctcgaaccccgagtgacaagcctgtagcccatgttgtagcaaaccctcaagctgaggggcagctccagtggctgaaccgccgggccaatgccctcctggccaatggcgtggagctgagagataaccagctggtggtgccatcagagggcctgtacctcatctactcccaggtcctcttcaagggccaaggctgcccctccacccatgtgctcctcacccacaccatcagccgcatcgccgtctcctaccagaccaaggtcaacctcctctctgccatcaagagcccctgccagagggagaccccagagggggctgaggccaagccctggtatgagcccatctatctgggaggggtcttccagctggagaagggtgaccgactcagcgctgagatcaatcggcccgactatctcgactttgccgagtctgggcaggtctactttgggatcattgccctgtgaggaggacgaacatccaaccttcccaaacgcctcccctgccccaatccctttattaccccctccttcagacaccctcaacctcttctggctcaaaaagagaattgggggcttagggtcggaacccaagcttagaactttaagcaacaagaccaccacttcgaaacctgggattcaggaatgtgtggcctgcacagtgaagtgctggcaaccactaagaattcaaactggggcctccagaactcactggggcctacagctttgatccctgacatctggaatctggagaccagggagcctttggttctggccagaatgctgcaggacttgagaagacctcacctagaaattgacacaagtggaccttaggccttcctctctccagatgtttccagacttccttgagacacggagcccagccctccccatggagccagctccctctatttatgtttgcacttgtgattatttattatttatttattatttatttatttacagatgaatgtatttatttgggagaccggggtatcctgggggacccaatgtaggagctgccttggctcagacatgttttccgtgaaaacggagctgaacaataggctgttcccatgtagccccctggcctctgtgccttcttttgattatgttttttaaaatatttatctgattaagttgtctaaacaatgctgatttggtgaccaactgtcactcattgctgagcctctgctccccaggggagttgtgtctgtaatcgccctactattcagtggcgagaaataaagtttgcttagaaaagaa

SEQ ID NO: 65 - protein, 233 aa, Homo sapiens
MSTESMIRDVELAEEALPKKTGGPQGSRRCLFLSLFSFLIVAGATTLFCLLHFGVIGPQREEFPRDLSLISPLAQAVRSSSRTPSDKPVAHVVANPQAEGQLQWLNRRANALLANGVELRDNQLVVPSEGLYLIYSQVLFKGQGCPSTHVLLTHTISRIAVSYQTKVNLLSAIKSPCQRETPEGAEAKPWYEPIYLGGVFQLEKGDRLSAEINRPDYLDFAESGQVYFGIIAL

SEQ ID NO: 66 - DNA, 85 bp, Homo sapiens
cccagggacctctctctaatcagccctctggcccaggcagtcagatcatcttctcgaaccccgagtgacaagcctgtagcccatg

SEQ ID NO: 67 - DNA, 1621 bp, Homo sapiens
gcggcaggtctctgcgcagcccagcccgccggtccacgccgcgcaccgctccgagggccagcgccacccgctccgcagccggcaccatgcgcgagatcgtgcacatccaggcgggccagtgcggcaaccagatcggcgccaagttttgggaggtcatcagcgatgagcatgggatcgaccccacaggcagttaccatggagacagtgacttgcagctggagagaatcaacgtgtactacaatgaggctgctggtaacaaatatgtacctcgggccatcctggtggatctggagcctggcaccatggactctgtcaggtctggacccttcggccagatcttcagaccagacaacttcgtgttcggccagagtggagccgggaataactgggccaagggccactacacagagggagccgagctggtcgactcggtcctggatgtggtgaggaaggagtcagagagctgtgactgtctccagggcttccagctgacccactctctggggggcggcacggggtccgggatgggcaccctgctcatcagcaagatccgggaagagtacccagaccgcatcatgaacaccttcagcgtcatgccctcacccaaggtgtcagacacggtggtggagccctacaacgccaccctctctgtccaccagctggtggaaaacacagatgaaacctactccattgataacgaggccctgtatgacatctgcttccgcaccctgaagctgaccacccccacctacggggacctcaaccacctggtgtcggccaccatgagcggggtcaccacctgcctgcgcttcccgggccagctgaacgcagacctgcgcaagctggcggtgaacatggtgcccttccctcgcctgcacttcttcatgcccggcttcgcgcccctgaccagccggggcagccagcagtaccgggcgctcacggtgcccgagctcacccagcagatgttcgactccaagaacatgatggccgcctgcgacccgcgccacggccgctacctgacggtggctgccatcttccggggccgcatgtccatgaaggaggtggacgagcagatgctcaacgtgcagaacaagaacagcagctacttcgtggagtggatccccaacaacgtgaagacggccgtgtgcgacatcccgccccgcggcctgaagatgtcggccaccttcatcggcaacagcacggccatccaggagctgttcaagcgcatctccgagcagttcacggccatgttccggcgcaaggccttcctgcactggtacacgggcgagggcatggacgagatggagttcaccgaggccgagagcaacatgaacgacctggtgtccgagtaccagcagtaccaggacgccacggccgacgaacaaggggagttcgaggaggaggagggcgaggacgaggcttaaaaacttctcagatcaatcgtgcatccttagtgaacttctgttgtcctcaagcatggtctttctacttgtaaactatggtgctcagttttgcctctgttagaaattcacactgttgatgtaatgatgtggaactcctctaaaaattacagtattgtctgtgaaggtatctatactaataaaaaagcatgtgtagaaaa

SEQ ID NO: 68 - protein, 445 aa, Homo sapiens
MREIVHIQAGQCGNQIGAKFWEVISDEHGIDPTGSYHGDSDLQLERINVYYNEAAGNKYVPRAILVDLEPGTMDSVRSGPFGQIFRPDNFVFGQSGAGNNWAKGHYTEGAELVDSVLDVVRKESESCDCLQGFQLTHSLGGGTGSGMGTLLISKIREEYPDRIMNTFSVMPSPKVSDTVVEPYNATLSVHQLVENTDETYSIDNEALYDICFRTLKLTTPTYGDLNHLVSATMSGVTTCLRFPGQLNADLRKLAVNMVPFPRLHFFMPGFAPLTSRGSQQYRALTVPELTQQMFDSKNMMAACDPRHGRYLTVAAIFRGRMSMKEVDEQMLNVQNKNSSYFVEWIPNNVKTAVCDIPPRGLKMSATFIGNSTAIQELFKRISEQFTAMFRRKAFLHWYTGEGMDEMEFTEAESNMNDLVSEYQQYQDATADEQGEFEEEEGEDEA

SEQ ID NO: 69 - DNA, 68 bp, Homo sapiens
gccagatcttcagaccagacaacttcgtgttcggccagagtggagccgggaataactgggccaagggc

SEQ ID NO: 70 - DNA, 508 bp, Homo sapiens
tttggtgctttggatccatttccatcggtccttacagccgctcgtcagactccagcagccaagatggtgaagcagatcgagagcaagactgcttttcaggaagccttggacgctgcaggtgataaacttgtagtagttgacttctcagccacgtggtgtgggccttgcaaaatgatcaagcctttctttcattccctctctgaaaagtattccaacgtgatattccttgaagtagatgtggatgactgtcaggatgttgcttcagagtgtgaagtcaaatgcatgccaacattccagttttttaagaagggacaaaaggtgggtgaattttctggagccaataaggaaaagcttgaagccaccattaatgaattagtctaatcatgttttctgaaaatataaccagccattggctatttaaaacttgtaatttttttaatttacaaaaatataaaatatgaagacataaacccagttgccatctgcgtgacaataaaacattaatgct

SEQ ID NO: 71 - protein, 105 aa, Homo sapiens
MVKQIESKTAFQEALDAAGDKLVVVDFSATWCGPCKMIKPFFHSLSEKYSNVIFLEVDVDDCQDVASECEVKCMPTFQFFKKGQKVGEFSGANKEKLEATINELV

SEQ ID NO: 72 - DNA, 84 bp, Homo sapiens
atgcatgccaacattccagttttttaagaagggacaaaaggtgggtgaattttctggagccaataaggaaaagcttgaagccac

SEQ ID NO: 73 - DNA, 1869 bp, Homo sapiens
ggagtttgagtgagagatatagggaaggaagggaagtaagcagtcacagacgctggcggccaccagaagtttgagcctctttggtagcaggaggctggaagaaaggacagaagtagctctggctgtgatggggatcttactgggcctgctactcctggggcacctaacagtggacacttatggccgtcccatcctggaagtgccagagagtgtaacaggaccttggaaaggggatgtgaatcttccctgcacctatgaccccctgcaaggctacacccaagtcttggtgaagtggctggtacaacgtggctcagaccctgtcaccatctttctacgtgactcttctggagaccatatccagcaggcaaagtaccagggccgcctgcatgtgagccacaaggttccaggagatgtatccctccaattgagcaccctggagatggatgaccggagccactacacgtgtgaagtcacctggcagactcctgatggcaaccaagtcgtgagagataagattactgagctccgtgtccagaaactctctgtctccaagcccacagtgacaactggcagcggttatggcttcacggtgccccagggaatgaggattagccttcaatgccaggctcggggttctcctcccatcagttatatttggtataagcaacagactaataaccaggaacccatcaaagtagcaaccctaagtaccttactcttcaagcctgcggtgatagccgactcaggctcctatttctgcactgccaagggccaggttggctctgagcagcacagcgacattgtgaagtttgtggtcaaagactcctcaaagctactcaagaccaagactgaggcacctacaaccatgacataccccttgaaagcaacatctacagtgaagcagtcctgggactggaccactgacatggatggctaccttggagagaccagtgctgggccaggaaagagcctgcctgtctttgccatcatcctcatcatctccttgtgctgtatggtggtttttaccatggcctatatcatgctctgtcggaagacatcccaacaagagcatgtctacgaagcagccagggcacatgccagagaggccaacgactctggagaaaccatgagggtggccatcttcgcaagtggctgctccagtgatgagccaacttcccagaatctgggcaacaactactctgatgagccctgcataggacaggagtaccagatcatcgcccagatcaatggcaactacgcccgcctgctggacacagttcctctggattatgagtttctggccactgagggcaaaagtgtctgttaaaaatgccccattaggccaggatctgctgacataattgcctagtcagtccttgccttctgcatggccttcttccctgctacctctcttcctggatagcccaaagtgtccgcctaccaacactggagccgctgggagtcactggctttgccctggaatttgccagatgcatctcaagtaagccagctgctggatttggctctgggcccttctagtatctctgccgggggcttctggtactcctctctaaataccagagggaagatgcccatagcactaggacttggtcatcatgcctacagacactattcaactttggcatcttgccaccagaagacccgagggaggctcagctctgccagctcagaggaccagctatatccaggatcatttctctttcttcagggccagacagcttttaattgaaattgttatttcacaggccagggttcagttctgctcctccactataagtctaatgttctgactctctcctggtgctcaataaatatctaatcataacagcaaaaaaaaaaaaaaaaaaa

SEQ ID NO: 74 - protein, 399 aa, Homo sapiens
MGILLGLLLLGHLTVDTYGRPILEVPESVTGPWKGDVNLPCTYDPLQGYTQVLVKWLVQRGSDPVTIFLRDSSGDHIQQAKYQGRLHVSHKVPGDVSLQLSTLEMDDRSHYTCEVTWQTPDGNQVVRDKITELRVQKLSVSKPTVTTGSGYGFTVPQGMRISLQCQARGSPPISYIWYKQQTNNQEPIKVATLSTLLFKPAVIADSGSYFCTAKGQVGSEQHSDIVKFVVKDSSKLLKTKTEAPTTMTYPLKATSTVKQSWDWTTDMDGYLGETSAGPGKSLPVFAIILIISLCCMVVFTMAYIMLCRKTSQQEHVYEAARAHAREANDSGETMRVAIFASGCSSDEPTSQNLGNNYSDEPCIGQEYQIIAQINGNYARLLDTVPLDYEFLATEGKSVC

SEQ ID NO: 75 - DNA, 73 bp, Homo sapiens
cccaacaagagcatgtctacgaagcagccagggcacatgccagagaggccaacgactctggagaaaccatgag

SEQ ID NO: 76 - DNA, 5089 bp, Homo sapiens
ctcgggcaacggccgccgccgccacagccacacagccgccgccactgcgtccgtccccggtgagcgccgctgacgcgcggagatgaaattcccggcctcggtgctggcgtccgtgttcctgttcgtggccgagacaacggcggcgctcagcctgagcagcacctaccgctcgggcggggaccgcatgtggcaggcgctgacgttgcttttctcgctactgccttgcgcgctcgtgcagctcacgcttctcttcgtacaccgcgacctcagccgcgaccgcccgctcgtactgctgctgcacctgctgcaacttgggccccttttcaggtgttttgaagtcttctgcatctactttcagtcaggcaacaatgaagagccttatgtcagtatcaccaagaagaggcaaatgccaaaaaatggcctctcagaggagattgagaaggaggtgggccaggcagaaggcaaactaatcacccaccgatcagcgttcagccgggcgtcggtgatccaggctttcttgggctcagccccccagctgaccctacagctgtacataagtgtcatgcagcaggacgtcactgttggaagaagtctcctcatgaccatatccctgttgtccattgtgtatggagccttgcgctgcaacatcctagccatcaaaatcaagtacgatgagtatgaagtcaaagtgaagcctctggcctatgtctgtatcttcctgtggaggagctttgagattgccactcgagttgtagtcctggtcctctttacctccgtcctgaagacctgggtggtggttataatactcatcaacttcttcagtttcttcttgtacccctggatcctcttctggtgcagtggttccccattccctgagaacatagagaaggccctcagtagagtgggcaccaccattgtactatgctttctaactttactctatactggtatcaacatgttctgctggtctgctgtacagctgaaaattgacagccctgacctcatcagcaagtcccataattggtaccagctactggtgtattacatgataagattcatcgagaatgccatcctcctcctcctgtggtatcttttcaagactgacatctatatgtatgtgtgcgcacctctgttggtcctgcagctgctcattgggtactgcacagccattctcttcatgcttgtattctatcagttcttccacccttgcaaaaagctcttttcttccagtgtttctgaaggctttcagaggtggctcaggtgtttttgctgggcctgcaggcagcaaaaaccctgtgagccgataggaaaggaagatctacagtcatccagagatagagatgagacaccttctagcagtaaaacaagtcctgagcctggtcagttcttgaatgctgaagatctctgctctgcttaatgggacccaaggtctcagagcacaggcatattattttctgggtttgatactcgttattcatacaaataatgagccctacacagggaacaaggcaggaagttagctgttaactccttgtgagctgcttctctttatagagctcttgggtatgtagaactgtatgggaagaagccaggaaaacctctgagtgttgaaggggcaacccaaggcatcacagttcacaggtaaccatgttgtgttcttctaggcattactggccttttcactgacaagttacccctgaaatctgagttgtactggttagattcattaggttgaatgaggagaggggcttacctgttctctagttttccagactgctggtttgggtaacctgaagttttatgatccctgaacatagttttcacccaagagctgtcctggtgaccaaaaaagattactagggttttgccatcagcaacatcattcctgtcagagctttcagggagggctgttcaagtttggtttttgaatagacagaggtttcattttcatctcattagggcttttttgtacatagccaactgtagccaccctggcatgctgtctctaattgattcaagggcctagatttggagactttgttccttagcatccatggatgcagaaatgagtgataaatttggccatgaaagccctggaattttaggaaagttgtgattctttgatatgttgatgaaattctggatcaggaggggtgttaaaacatcaaaatgatggcgacttgtataagtagaattcttaccatcttactcctgcctccccattccttgcctgtcaggaccattttagaagagttaccttggttaacttaagggttttttagaaaaccccacagaaatctctcacccagttcaggtgtatagggaattttcattttcattatttcaaggaatagagttttcctcactaccacttgtaattagagattgacttcagaaactttttctaaattataaagacggaatgaccagaaaatttttgtctttcatggaatgcaatttgacttggcataattgtgagttaatttgataaagatctccagttgtatcctctgacaccctttaatgttctatataatttttcctttaatcggagaccctatttgtttcattaaagaggattgggtagcatatcctcaattatcttggaaaaatgcgtagatctagtgccattatttctaccattaaaatcttgaaagcgaaatacttgaaaagaggtgaccataaagatcacaccaatttagaatgaatattaaagtctgagaaatttacaaaagggactctatggactcgattttaccatatggaatagggatccacttctctgttaacctacaaaacgtatttatctggccattgcacttcggataattttcatttttaattcctcttggtgtcaaatttttaagtaatttcatgcacacaggagaaaatgcaatttgataatcagtttccactacattcggaggtcaagaaagcagtatatattctttcacaaggcatccatactgtttaatatttatagagttcatagaaatacatcaataagctcctaaattatagagcctcaattttggtttttctcatttgaaatgtttttgatttatcaatatttgtggtttaactttgtgggggtgtccaggcagtagatcattttttgtctatttttaaccaaataagaataacactcaagactatgttctccatcccaacacatcacttaccacttgcactattcttaataggcctaaaatagtgagcatatataatcaaaataatacttcatacaacatatacttccatgcactcttcatgtaatcacatatgtgcatagatacacaatcgtattacataaaacacccttgaaaatatatgactttgaataaaataaagctaccatgttaatacatcattttttgtttcttcctaattaacaaaagggctctataatgattaggagagctgtaaggccattctttagtcattccaagtgtatatttgtatcacaccagttacttgtgttcattgacaccaaatattttcaagctttttgtgagaaagagattcttgccttgaggctctgcagtggcaaatggtaggggcaatagcgctcccttttcacctgaaatgccttcagctcaggccttgggagtgaggtgtgggagtagccaccagcctcccactgactaggcatgttaggaattagacaaggatggagagactggttttttccagccttggtttggaagcttgtctcaaaaaccattacaaaatcttaaccttcaaatacattctaaatcactttaatttagaagataggtgagcaacttgagtgatcccaaaccaaactaacagtgctggtttgtccgacacccaaagcccacttcacacatttataaggacagagatttggtaactcatttgggtattttgtcagttttaacccttaatatacaggtatcccagctttgggcacatgtatgtccattcactttcaggaaggggtgtcagtactttctttctgtgtggtgaaaacataagccatggtgaactgataatttttgtttttaaattatttatattactgaattggcaaaattacagttcacactgcagagctaggttgtcctattggcataaaacaaaccagcaacttttctcatgtgtttggagttaaaatgtgtttttcagttataatttcaatttttaaatttcttggtgctttgtctaattaattacatcccataacttgtcaggatagttgctccaactgaattgctatcatttggctggatgggggtgaagtatgtcttcaaaatatattgaagtaagttcatcaaacatgtttagacttcctctcattgctggagacagcccagtgtagagattggcacttccctgtccagcactacaacttaattgctctatgcctcagtttccccataatacccttttccaacctacctcacaaggttatcagaaagatcaaattaaataatagatgtgaaaatgctttgaaaatgtttttaagtgctatgcatatttatagagttattatagttattcaaatccataagcaggttatttttatttttttactgtttgaaaagaaataagtagtgtcattcatatgagttcctgagtggatatgcgaatctttggtcttctcgacaggtgccctttctcttaccactagttgcttacaaaaatagcacccaaacacatggcacttggaagaaaaagacccactgaatctgagaaagtactttctggtggcaaatgaatttatcattttagtatagttttcgataaaggatatagcaacatcttttgataattgtgctttacaacttgaatgctgattcaaggcattatttggatgtgagtttaatcttttcagccttgtaaatgggaaaatatatattaaaattgattgtcaaatacagcatttctttggaaaccaccttaaaacattagtgctatggttatgagtgtatgtgccagtacttaccagtcaatgcattgtggatatgagctttcgttgactgcttctctgcagtcgttgatgctaataaatattgtcctgtttcttcatataataaattaatttttcaatttctccttgtaaaaa

SEQ ID NO: 77 - protein, 444 aa, Homo sapiens
MKFPASVLASVFLFVAETTAALSLSSTYRSGGDRMWQALTLLFSLLPCALVQLTLLFVHRDLSRDRPLVLLLHLLQLGPLFRCFEVFCIYFQSGNNEEPYVSITKKRQMPKNGLSEEIEKEVGQAEGKLITHRSAFSRASVIQAFLGSAPQLTLQLYISVMQQDVTVGRSLLMTISLLSIVYGALRCNILAIKIKYDEYEVKVKPLAYVCIFLWRSFEIATRVVVLVLFTSVLKTWVVVIILINFFSFFLYPWILFWCSGSPFPENIEKALSRVGTTIVLCFLTLLYTGINMFCWSAVQLKIDSPDLISKSHNWYQLLVYYMIRFIENAILLLLWYLFKTDIYMYVCAPLLVLQLLIGYCTAILFMLVFYQFFHPCKKLFSSSVSEGFQRWLRCFCWACRQQKPCEPIGKEDLQSSRDRDETPSSSKTSPEPGQFLNAEDLCSA

SEQ ID NO: 78 - DNA, 62 bp, Homo sapiens
gcagcaggacgtcactgttggaagaagtctcctcatgaccatatccctgttgtccattgtgt

SEQ ID NO: 79 - DNA, 2170 bp, Homo sapiens
ctctttccgtctcaggtcgccgctgcgaagggagccgccgccatgtctgcgcatctgcaatggatggtcgtgcggaactgctccagtttcctgatcaagaggaataagcagacctacagcactgagcccaataacttgaaggcccgcaattccttccgctacaacggactgattcaccgcaagactgtgggcgtggagccggcagccgacggcaaaggtgtcgtggtggtcattaagcggagatccggccagcggaagcctgccacctcctatgtgcggaccaccatcaacaagaatgctcgcgccacgctcagcagcatcagacacatgatccgcaagaacaagtaccgccccgacctgcgcatggcagccatccgcagggccagcgccatcctgcgcagccagaagcctgtgatggtgaagaggaagcggacccgccccaccaagagctcctgagccccctgcccccagagcaataaagtcagctggctttctcacctgcctcgactgggcctccctttttgaaacgctctggggagctctggccctgtgtgttgtcattcaggccatgtcatcaaaactctgcatgtcaccttgtccatctggaggtgatgtcaatggctggccatgcaggaggggtggggtagctgccttgtccctggtgagggcaagggtcactgtcttcacagaaaaagtttgctgacttgtgattgagacctactgtcccattgtgaggtggcctgaagaatcccagctggggcagtggcttccattcagaagaagaaaggccttttctagcccagaagggtgcaggctgagggctgggccctgggccctggtgctgtagcacggtttggggacttggggtgttcccaagacctgggggacgacagacatcacgggaggaagatgagatgacttttgcatccagggagtgggtgcagccacatttggaggggatgggctttacttgatgcaacctcatctctgagatgggcaacttggtgggtggtggcttataactgtaagggagatggcagccccagggtacagccagcaggcattgagcagccttagcattgtccccctactcccgtcctccaggtgtccccatccctcccctgtctctttgagctggctcttgtcacttaggtctcatctcagtggccgctcctgggccaccctgtcacccaagctttcctgattgcccagccctcttgtttcctttggcctgtttgctccctagtgtttattacagcttgtgaggccaggagtttgagaccatcctaggcaacataatgagacaccgtctctaaaataaaattagctgggtgtggtggtgcaccgcctgtggtcccagctcctcagaggttgagtagaggctgaggtgagcggagcacttgagccaagagtatgaggctgcagtgagcccatgagccccaccactacactccagcctggaagacaccatgacacacaggcctggatggggaaagagtcctgctgttgatcctcacatgtttcctgggcacctaactctgtcagccactgccagggaccaaggatccagcatccatggcacccctggttcctgccatcctggggtacccgattcaaagaaggactctgctccctgtctgagaccacccccggctctgactgagagtaaggggactgtcagggcctcgacttgccattggttggggtcgtacggggctgggagccctgcgttttgaggcagaccactgcccttccgacctcagtcctgtctgctccagtcttgcccagctcgaaggagagcagatctgaccacttgccagcccctgtctgctgtgaattaccatttcctttgtccttcccttagttgggtctattagctcagattgagaggtgttgccttaaaactgagttgggtgacttggtacctgctcaggaccccccgcactgtcccaatcccactcaggcccacctccagctggcctcactccgctggtgacttcgtacctgctcaggagcccccactgtcccagtcccactcaggcccatctctggctggcctcactgcgctgggactccgccttcataaggagagctcactgctcacgttagtagatggccccttctcgtgaggcctctcccctggcacctgcttcagttgtcctccacagca

SEQ ID NO: 80 - protein, 137 aa, Homo sapiens [sequence omitted]

SEQ ID NO: 81 - DNA, 65 bp, Homo sapiens
cggaccaccatcaacaagaatgctcgcgccacgctcagcagcatcagacacatgatccgcaagaa

SEQ ID NO: 82 - DNA, 28 bp, Artificial Sequence
  Description of Artificial Sequence Synthetic primer
aaaatttcaactctctcctgtgagaaca

SEQ ID NO: 83 - DNA, 26 bp, Artificial Sequence
  Description of Artificial Sequence Synthetic primer
aacctaaagtcctcacaaaacaacct

SEQ ID NO: 84 - DNA, 20 bp, Artificial Sequence
  Description of Artificial Sequence Synthetic primer
aagcatggcctgtacaacct

SEQ ID NO: 85 - DNA, 25 bp, Artificial Sequence
  Description of Artificial Sequence Synthetic primer
accagacctctacattccattttgg

SEQ ID NO: 86 - DNA, 25 bp, Artificial Sequence
  Description of Artificial Sequence Synthetic primer
accagacttttcagacaaacccttt

SEQ ID NO: 87 - DNA, 20 bp, Artificial Sequence
  Description of Artificial Sequence Synthetic primer
acccagacgtcctggagatc

SEQ ID NO: 88 - DNA, 18 bp, Artificial Sequence
  Description of Artificial Sequence Synthetic primer
accctggtcgtggtgatg

SEQ ID NO: 89 - DNA, 25 bp, Artificial Sequence
  Description of Artificial Sequence Synthetic primer
acctattggtcaagccatcagaaaa

SEQ ID NO: 90 - DNA, 17 bp, Artificial Sequence
  Description of Artificial Sequence Synthetic primer
acctcaggcgcattgct

SEQ ID NO: 91 - DNA, 26 bp, Artificial Sequence
  Description of Artificial Sequence Synthetic primer
acggatttgaaagcacagaatcagat

SEQ ID NO: 92 - DNA, 19 bp, Artificial Sequence
  Description of Artificial Sequence Synthetic primer
actacccctgtgcgttgtc

SEQ ID NO: 93 - DNA, 24 bp, Artificial Sequence
  Description of Artificial Sequence Synthetic primer
actgagtactggattgtccggaat

SEQ ID NO: 94 - DNA, 22 bp, Artificial Sequence
  Description of Artificial Sequence Synthetic primer
agatgcagcaggagttggaaaa

SEQ ID NO: 95 - DNA, 22 bp, Artificial Sequence
  Description of Artificial Sequence Synthetic primer
agattgcctttgcactcagtgt

SEQ ID NO: 96 - DNA, 27 bp, Artificial Sequence
  Description of Artificial Sequence Synthetic primer
agcacccagcaataactctaataatgt

SEQ ID NO: 97 - DNA, 14 bp, Artificial Sequence
  Description of Artificial Sequence Synthetic primer
agccgcgcctccac

SEQ ID NO: 98 - DNA, 24 bp, Artificial Sequence
  Description of Artificial Sequence Synthetic primer
agcctgtgtttgcttgaaagagat

SEQ ID NO: 99 - DNA, 25 bp, Artificial Sequence
  Description of Artificial Sequence Synthetic primer
aggaaatggaagatgggctatacct

SEQ ID NO: 100 - DNA, 23 bp, Artificial Sequence
  Description of Artificial Sequence Synthetic primer
aggacctcaggttgtgtatacct

SEQ ID NO: 101 - DNA, 23 bp, Artificial Sequence
  Description of Artificial Sequence Synthetic primer
aggcctactgcaagcacaagtac

SEQ ID NO: 102 - DNA, 27 bp, Artificial Sequence
  Description of Artificial Sequence Synthetic primer
atttaattggtggtgaagctactcgaa

SEQ ID NO: 103 - DNA, 25 bp, Artificial Sequence
  Description of Artificial Sequence Synthetic primer
atttgtgctatgtccatggaaagga

SEQ ID NO: 104 - DNA, 23 bp, Artificial Sequence
  Description of Artificial Sequence Synthetic primer
caaagagctggtgcgaaaagatc

SEQ ID NO: 105 - DNA, 22 bp, Artificial Sequence
  Description of Artificial Sequence Synthetic primer
caagcctgcagctcattttctg

SEQ ID NO: 106 - DNA, 22 bp, Artificial Sequence
  Description of Artificial Sequence Synthetic primer
caaggacttggcccaaagaaag

SEQ ID NO: 107 - DNA, 27 bp, Artificial Sequence
  Description of Artificial Sequence Synthetic primer
cactgctcgttttctatatcaccaaaa

SEQ ID NO: 108 - DNA, 21 bp, Artificial Sequence
  Description of Artificial Sequence Synthetic primer
cagctcctactgttggacaca

SEQ ID NO: 109 - DNA, 18 bp, Artificial Sequence
  Description of Artificial Sequence Synthetic primer
caggagcaggcccaagag

SEQ ID NO: 110 - DNA, 18 bp, Artificial Sequence
  Description of Artificial Sequence Synthetic primer
cagggccatggagaacca

SEQ ID NO: 111 - DNA, 25 bp, Artificial Sequence
  Description of Artificial Sequence Synthetic primer
catcgcccatggttaagaaaatcat

SEQ ID NO: 112 - DNA, 19 bp, Artificial Sequence
  Description of Artificial Sequence Synthetic primer
catctcgcgcatgcagtac

SEQ ID NO: 113 - DNA, 20 bp, Artificial Sequence
  Description of Artificial Sequence Synthetic primer
catgaagggtgcctctcgaa

SEQ ID NO: 114 - DNA, 25 bp, Artificial Sequence
  Description of Artificial Sequence Synthetic primer
cattgcttattctccaccttttggt

SEQ ID NO: 115 - DNA, 25 bp, Artificial Sequence
  Description of Artificial Sequence Synthetic primer
catttggctggcaaggagattaaaa

SEQ ID NO: 116 - DNA, 25 bp, Artificial Sequence
  Description of Artificial Sequence Synthetic primer
ccaagcgcaagagaaagtataactg

SEQ ID NO: 117 - DNA, 23 bp, Artificial Sequence
  Description of Artificial Sequence Synthetic primer
ccaagtacaccagttccaagtga

SEQ ID NO: 118 - DNA, 25 bp, Artificial Sequence
  Description of Artificial Sequence Synthetic primer
ccacactgaaaaggaaaatgggaat

SEQ ID NO: 119 - DNA, 21 bp, Artificial Sequence
  Description of Artificial Sequence Synthetic primer
ccactcaggagggccatagtc

SEQ ID NO: 120 - DNA, 23 bp, Artificial Sequence
  Description of Artificial Sequence Synthetic primer
ccagcagtgtctgatgagaaacc

SEQ ID NO: 121 - DNA, 19 bp, Artificial Sequence
  Description of Artificial Sequence Synthetic primer
ccagtggcaagtgctccaa

SEQ ID NO: 122 - DNA, 23 bp, Artificial Sequence
  Description of Artificial Sequence Synthetic primer
cccaacaagagcatgtctacgaa

SEQ ID NO: 123 - DNA, 21 bp, Artificial Sequence
  Description of Artificial Sequence Synthetic primer
cccaatgcctacgacaagaca

SEQ ID NO: 124 - DNA, 21 bp, Artificial Sequence
  Description of Artificial Sequence Synthetic primer
cccaatgcctacgacaagaca

SEQ ID NO: 125 - DNA, 21 bp, Artificial Sequence
  Description of Artificial Sequence Synthetic primer
cccaatgcctacgacaagaca

SEQ ID NO: 126 - DNA, 22 bp, Artificial Sequence
  Description of Artificial Sequence Synthetic primer
cccagggacctctctctaatca

SEQ ID NO: 127 - DNA, 22 bp, Artificial Sequence
  Description of Artificial Sequence Synthetic primer
ccccaaaggactcaaagaacct

SEQ ID NO: 128 - DNA, 20 bp, Artificial Sequence
  Description of Artificial Sequence Synthetic primer
ccccgaaggcagatttgtgt

SEQ ID NO: 129 - DNA, 25 bp, Artificial Sequence
  Description of Artificial Sequence Synthetic primer
ccctctgcccctagaataagaacat

SEQ ID NO: 130 - DNA, 25 bp, Artificial Sequence
  Description of Artificial Sequence Synthetic primer
ccctctgcccctagaataagaacat

SEQ ID NO: 131 - DNA, 24 bp, Artificial Sequence
  Description of Artificial Sequence Synthetic primer
ccgaatgatgactggacgaatgag

SEQ ID NO: 132 - DNA, 25 bp, Artificial Sequence
  Description of Artificial Sequence Synthetic primer
ccgatcataagaagactctggaaca

SEQ ID NO: 133 - DNA, 16 bp, Artificial Sequence
  Description of Artificial Sequence Synthetic primer
ccgggctgctgttcct

SEQ ID NO: 134 - DNA, 22 bp, Artificial Sequence
  Description of Artificial Sequence Synthetic primer
ccgtactgctgaggagatcaag

SEQ ID NO: 135 - DNA, 20 bp, Artificial Sequence
  Description of Artificial Sequence Synthetic primer
cctctgctctgtcacttgct

SEQ ID NO: 136 - DNA, 25 bp, Artificial Sequence
  Description of Artificial Sequence Synthetic primer
cctgaaaaaaaggagctgaggaaag

SEQ ID NO: 137 - DNA, 24 bp, Artificial Sequence
  Description of Artificial Sequence Synthetic primer
cctgaagaaaagggaaaacttgct

SEQ ID NO: 138 - DNA, 25 bp, Artificial Sequence
  Description of Artificial Sequence Synthetic primer
cctgcatcccccatagttaagaaaa

SEQ ID NO: 139 - DNA, 19 bp, Artificial Sequence
  Description of Artificial Sequence Synthetic primer
ccttcactagcgggagtcc

SEQ ID NO: 140 - DNA, 21 bp, Artificial Sequence
  Description of Artificial Sequence Synthetic primer
cgaaggtctcacgaggtcaac

SEQ ID NO: 141 - DNA, 20 bp, Artificial Sequence
  Description of Artificial Sequence Synthetic primer
cgacagctgcagaccttcag

SEQ ID NO: 142 - DNA, 25 bp, Artificial Sequence
  Description of Artificial Sequence Synthetic primer
cgagatgacttcgaaaagctgacta

SEQ ID NO: 143 - DNA, 24 bp, Artificial Sequence
  Description of Artificial Sequence Synthetic primer
cgatcgtcacactgaatctattgc

SEQ ID NO: 144 - DNA, 19 bp, Artificial Sequence
  Description of Artificial Sequence Synthetic primer
cgcaccctctgatgttcca

SEQ ID NO: 145 - DNA, 19 bp, Artificial Sequence
  Description of Artificial Sequence Synthetic primer
cgcacgagggacaatagga

SEQ ID NO: 146 - DNA, 17 bp, Artificial Sequence
  Description of Artificial Sequence Synthetic primer
cgccactggcagagcat

SEQ ID NO: 147 - DNA, 18 bp, Artificial Sequence
  Description of Artificial Sequence Synthetic primer
cggtcaggcaccaaatgg

SEQ ID NO: 148 - DNA, 24 bp, Artificial Sequence
  Description of Artificial Sequence Synthetic primer
cgtacctacagtggatgtcctaca

SEQ ID NO: 149 - DNA, 21 bp, Artificial Sequence
  Description of Artificial Sequence Synthetic primer
cgtgagactccaactctgtga

SEQ ID NO: 150 - DNA, 25 bp, Artificial Sequence
  Description of Artificial Sequence Synthetic primer
ctcactgcttgtaggtagaaggaaa

SEQ ID NO: 151 - DNA, 25 bp, Artificial Sequence
  Description of Artificial Sequence Synthetic primer
ctcattacaggaggaagtggctatt

SEQ ID NO: 152 - DNA, 23 bp, Artificial Sequence
  Description of Artificial Sequence Synthetic primer
ctgaatcagcaggtcttcaatga

SEQ ID NO: 153 - DNA, 18 bp, Artificial Sequence
  Description of Artificial Sequence Synthetic primer
ctgcccacaaggcttgtc

SEQ ID NO: 154 - DNA, 17 bp, Artificial Sequence
  Description of Artificial Sequence Synthetic primer
ctggccagggagatgca

SEQ ID NO: 155 - DNA, 19 bp, Artificial Sequence
  Description of Artificial Sequence Synthetic primer
ctgggtgcccacaatcatg

SEQ ID NO: 156 - DNA, 19 bp, Artificial Sequence
  Description of Artificial Sequence Synthetic primer
ctgggtgcccacaatcatg

SEQ ID NO: 157 - DNA, 20 bp, Artificial Sequence
  Description of Artificial Sequence Synthetic primer
ctgtcctgcgtgttgaaaga

SEQ ID NO: 158 - DNA, 20 bp, Artificial Sequence
  Description of Artificial Sequence Synthetic primer
cttcctggcaggctgtagac

SEQ ID NO: 159 - DNA, 25 bp, Artificial Sequence
  Description of Artificial Sequence Synthetic primer
ctttgtcggttacctaggagagaga

SEQ ID NO: 160 - DNA, 26 bp, Artificial Sequence
  Description of Artificial Sequence Synthetic primer
gaaatggtgttcttctctgacctgaa

SEQ ID NO: 161 - DNA, 17 bp, Artificial Sequence
  Description of Artificial Sequence Synthetic primer
gaacaggcgccaatgct

SEQ ID NO: 162 - DNA, 22 bp, Artificial Sequence
  Description of Artificial Sequence Synthetic primer
gaactctctgacacagcaggaa

SEQ ID NO: 163 - DNA, 25 bp, Artificial Sequence
  Description of Artificial Sequence Synthetic primer
gaagaaattgctagagaccgagtgt

SEQ ID NO: 164 - DNA, 20 bp, Artificial Sequence
  Description of Artificial Sequence Synthetic primer
gacaagacggcactgaagga

SEQ ID NO: 165 - DNA, 22 bp, Artificial Sequence
  Description of Artificial Sequence Synthetic primer
gaccagaggaagaagcaacaca

SEQ ID NO: 166 - DNA, 23 bp, Artificial Sequence
  Description of Artificial Sequence Synthetic primer
gacgattctccaccgagtatgag

SEQ ID NO: 167 - DNA, 23 bp, Artificial Sequence
  Description of Artificial Sequence Synthetic primer
gagatggtgccacagatatggaa

SEQ ID NO: 168 - DNA, 18 bp, Artificial Sequence
  Description of Artificial Sequence Synthetic primer
gagcctggacacgcagta

SEQ ID NO: 169 - DNA, 18 bp, Artificial Sequence
  Description of Artificial Sequence Synthetic primer
gagcctggacacgcagta

SEQ ID NO: 170 - DNA, 26 bp, Artificial Sequence
  Description of Artificial Sequence Synthetic primer
gagctgagtctcttaatggaaatcca

SEQ ID NO: 171 - DNA, 23 bp, Artificial Sequence
  Description of Artificial Sequence Synthetic primer
gaggagctacagattccgttcag

SEQ ID NO: 172 - DNA, 24 bp, Artificial Sequence
  Description of Artificial Sequence Synthetic primer
gaggatttgcacatggattttaaa

SEQ ID NO: 173 - DNA, 24 bp, Artificial Sequence
  Description of Artificial Sequence Synthetic primer
gatcagttctcacaggagctacag

SEQ ID NO: 174 - DNA, 24 bp, Artificial Sequence
  Description of Artificial Sequence Synthetic primer
gatcgtcagaattatcgggcactt

SEQ ID NO: 175 - DNA, 24 bp, Artificial Sequence
  Description of Artificial Sequence Synthetic primer
gatgctgctaacaaggaaattgca

SEQ ID NO: 176 - DNA, 24 bp, Artificial Sequence
  Description of Artificial Sequence Synthetic primer
gcaagagtgatctgcatgtttttt

SEQ ID NO: 177 - DNA, 20 bp, Artificial Sequence
  Description of Artificial Sequence Synthetic primer
gcaagatgggtcctgactca

SEQ ID NO: 178 - DNA, 18 bp, Artificial Sequence
  Description of Artificial Sequence Synthetic primer
gcacgcatggttcaacgt

SEQ ID NO: 179 - DNA, 18 bp, Artificial Sequence
  Description of Artificial Sequence Synthetic primer
gcagcaggacgtcactgt

SEQ ID NO: 180 - DNA, 20 bp, Artificial Sequence
  Description of Artificial Sequence Synthetic primer
gcagctcgctgaagtttgtc

SEQ ID NO: 181 - DNA, 25 bp, Artificial Sequence
  Description of Artificial Sequence Synthetic primer
gcattctcagatccttcaccatcac

SEQ ID NO: 182 - DNA, 24 bp, Artificial Sequence
  Description of Artificial Sequence Synthetic primer
gccaatcccactaatcctgatgag

SEQ ID NO: 183 - DNA, 23 bp, Artificial Sequence
  Description of Artificial Sequence Synthetic primer
gccaattccactgatcctgtgaa

SEQ ID NO: 184 - DNA, 25 bp, Artificial Sequence
  Description of Artificial Sequence Synthetic primer
gccacctaggaacatatggagtttt

SEQ ID NO: 185 - DNA, 22 bp, Artificial Sequence
  Description of Artificial Sequence Synthetic primer
gccagatcttcagaccagacaa

SEQ ID NO: 186 - DNA, 23 bp, Artificial Sequence
  Description of Artificial Sequence Synthetic primer
gccccggatagaggaaactaagt

SEQ ID NO: 187 - DNA, 25 bp, Artificial Sequence
  Description of Artificial Sequence Synthetic primer
gcccttggtgattctaatagtcctt

SEQ ID NO: 188 - DNA, 17 bp, Artificial Sequence
  Description of Artificial Sequence Synthetic primer
gccgagccacacaagga

SEQ ID NO: 189 - DNA, 17 bp, Artificial Sequence
  Description of Artificial Sequence Synthetic primer
gccggccgaagagttca

SEQ ID NO: 190 - DNA, 20 bp, Artificial Sequence
  Description of Artificial Sequence Synthetic primer
gccttggaacacaccttcgt

SEQ ID NO: 191 - DNA, 17 bp, Artificial Sequence
  Description of Artificial Sequence Synthetic primer
gcgctgagccagttcca

SEQ ID NO: 192 - DNA, 20 bp, Artificial Sequence
  Description of Artificial Sequence Synthetic primer
gcgtttgcagcctttgtgat

SEQ ID NO: 193 - DNA, 23 bp, Artificial Sequence
  Description of Artificial Sequence Synthetic primer
gctaggcatcttcttctgtgtca

SEQ ID NO: 194 - DNA, 20 bp, Artificial Sequence
  Description of Artificial Sequence Synthetic primer
gctcagatggaagccgaatg

SEQ ID NO: 195 - DNA, 21 bp, Artificial Sequence
  Description of Artificial Sequence Synthetic primer
gctccctggattgacctcagt

SEQ ID NO: 196 - DNA, 26 bp, Artificial Sequence
  Description of Artificial Sequence Synthetic primer
gctgtcctcaaaagcaaggaaaatat

SEQ ID NO: 197 - DNA, 28 bp, Artificial Sequence
  Description of Artificial Sequence Synthetic primer
gcttgctacttggacttattgtacttct

SEQ ID NO: 198 - DNA, 24 bp, Artificial Sequence
  source: Description of Artificial Sequence Synthetic primer
ggaaaccatacaggctgaaatcct

SEQ ID NO: 199 - DNA, 22 bp, Artificial Sequence
  Description of Artificial Sequence Synthetic primer
ggacagacccttcctctttgtg

SEQ ID NO: 200 - DNA, 19 bp, Artificial Sequence
  Description of Artificial Sequence Synthetic primer
ggacagtgaccctcaacca

SEQ ID NO: 201 - DNA, 18 bp, Artificial Sequence
  Description of Artificial Sequence Synthetic primer
ggacgggacggactacga

SEQ ID NO: 202 - DNA, 25 bp, Artificial Sequence
  Description of Artificial Sequence Synthetic primer
ggagagatgagagaaaggtttgctt

SEQ ID NO: 203 - DNA, 23 bp, Artificial Sequence
  Description of Artificial Sequence Synthetic primer
ggagcaggtgaagaatgccttta

SEQ ID NO: 204 - DNA, 23 bp, Artificial Sequence
  Description of Artificial Sequence Synthetic primer
ggaggtgtcctacaggtgaaaag

SEQ ID NO: 205 - DNA, 21 bp, Artificial Sequence
  Description of Artificial Sequence Synthetic primer
ggatggaacgctctacaagct

SEQ ID NO: 206 - DNA, 15 bp, Artificial Sequence
  Description of Artificial Sequence Synthetic primer
ggcgtggaggccagt

SEQ ID NO: 207 - DNA, 25 bp, Artificial Sequence
  Description of Artificial Sequence Synthetic primer
ggcgtgtcccatgtttttgagtata

SEQ ID NO: 208 - DNA, 23 bp, Artificial Sequence
  Description of Artificial Sequence Synthetic primer
ggctaacaggcgacttctacttc

SEQ ID NO: 209 - DNA, 18 bp, Artificial Sequence
  Description of Artificial Sequence Synthetic primer
ggctgactggcagatcca

SEQ ID NO: 210 - DNA, 24 bp, Artificial Sequence
  Description of Artificial Sequence Synthetic primer
ggctgtccttatcatcacatgtgt

SEQ ID NO: 211 - DNA, 25 bp, Artificial Sequence
  Description of Artificial Sequence Synthetic primer
ggctgttggagataaacttcctgaa

SEQ ID NO: 212 - DNA, 21 bp, Artificial Sequence
  Description of Artificial Sequence Synthetic primer
gggaccataggctcacaacac

SEQ ID NO: 213 - DNA, 24 bp, Artificial Sequence
  Description of Artificial Sequence Synthetic primer
gggagaagtctgcaagatgtcaag

SEQ ID NO: 214 - DNA, 18 bp, Artificial Sequence
  Description of Artificial Sequence Synthetic primer
gggagccgactggattcc

SEQ ID NO: 215 - DNA, 16 bp, Artificial Sequence
  Description of Artificial Sequence Synthetic primer
gggagctggccaagca

SEQ ID NO: 216 - DNA, 20 bp, Artificial Sequence
  Description of Artificial Sequence Synthetic primer
gggtcatcttgtggcaaagg

SEQ ID NO: 217 - DNA, 23 bp, Artificial Sequence
  Description of Artificial Sequence Synthetic primer
ggtacagacatgagatgcttcca

SEQ ID NO: 218 - DNA, 24 bp, Artificial Sequence
  Description of Artificial Sequence Synthetic primer
ggtcacttattcagcattgcacaa

SEQ ID NO: 219 - DNA, 18 bp, Artificial Sequence
  Description of Artificial Sequence Synthetic primer
ggtcgtggcaagcaagga

SEQ ID NO: 220 - DNA, 22 bp, Artificial Sequence
  Description of Artificial Sequence Synthetic primer
ggtggatggcacagactatagg

SEQ ID NO: 221 - DNA, 25 bp, Artificial Sequence
  Description of Artificial Sequence Synthetic primer
ggttaatgcagacagaagagactct

SEQ ID NO: 222 - DNA, 25 bp, Artificial Sequence
  Description of Artificial Sequence Synthetic primer
gtaaaggaggaagagcccaagattc

SEQ ID NO: 223 - DNA, 25 bp, Artificial Sequence
  Description of Artificial Sequence Synthetic primer
gtcataagtgaggccagcagtaaaa

SEQ ID NO: 224 - DNA, 19 bp, Artificial Sequence
  Description of Artificial Sequence Synthetic primer
gtccaagcccagactagca

SEQ ID NO: 225 - DNA, 20 bp, Artificial Sequence
  Description of Artificial Sequence Synthetic primer
gtcccacaactcgtcaagct

SEQ ID NO: 226 - DNA, 21 bp, Artificial Sequence
  Description of Artificial Sequence Synthetic primer
gtctgcagcatgctcatgttc

SEQ ID NO: 227 - DNA, 25 bp, Artificial Sequence
  Description of Artificial Sequence Synthetic primer
gtgatgagctccagagacatagaag

SEQ ID NO: 228 - DNA, 25 bp, Artificial Sequence
  Description of Artificial Sequence Synthetic primer
gtgtcataactcagtcaagctcagt

SEQ ID NO: 229 - DNA, 27 bp, Artificial Sequence
  Description of Artificial Sequence Synthetic primer
gttaaggccaaatatcccaaacagatg

SEQ ID NO: 230 - DNA, 22 bp, Artificial Sequence
  Description of Artificial Sequence Synthetic primer
gttcttggcctcagtgattcca

SEQ ID NO: 231 - DNA, 25 bp, Artificial Sequence
  Description of Artificial Sequence Synthetic primer
tcacagagtgaaatgatggcagaaa

SEQ ID NO: 232 - DNA, 26 bp, Artificial Sequence
  Description of Artificial Sequence Synthetic primer
tccatagtctcttaggtaccaatgct

SEQ ID NO: 233 - DNA, 19 bp, Artificial Sequence
  Description of Artificial Sequence Synthetic primer
tcctcactgctggcttcac

SEQ ID NO: 234 - DNA, 20 bp, Artificial Sequence
  Description of Artificial Sequence Synthetic primer
tcgagggcgaccagaaattc

SEQ ID NO: 235 - DNA, 19 bp, Artificial Sequence
  Description of Artificial Sequence Synthetic primer
tctcggcttggacgaacct

SEQ ID NO: 236 - DNA, 22 bp, Artificial Sequence
  Description of Artificial Sequence Synthetic primer
tctctaagggtgagctgaagca

SEQ ID NO: 237 - DNA, 23 bp, Artificial Sequence
  Description of Artificial Sequence Synthetic primer
tctgccaccatcctctatgagat

SEQ ID NO: 238 - DNA, 21 bp, Artificial Sequence
  Description of Artificial Sequence Synthetic primer
tctgcttcccgatgacaacac

SEQ ID NO: 239 - DNA, 25 bp, Artificial Sequence
  Description of Artificial Sequence Synthetic primer
tgaagaagtggccttgacagaaatt

SEQ ID NO: 240 - DNA, 24 bp, Artificial Sequence
  Description of Artificial Sequence Synthetic primer
tgaagaggcattgcacagatcaaa

SEQ ID NO: 241 - DNA, 21 bp, Artificial Sequence
  Description of Artificial Sequence Synthetic primer
tgaagccatgaagctgacaca

SEQ ID NO: 242 - DNA, 17 bp, Artificial Sequence
  Description of Artificial Sequence Synthetic primer
tgcgctcgggtctcaac

SEQ ID NO: 243 - DNA, 25 bp, Artificial Sequence
  Description of Artificial Sequence Synthetic primer
tggaaatgagacatgcacaaagaga

SEQ ID NO: 244 - DNA, 19 bp, Artificial Sequence
  Description of Artificial Sequence Synthetic primer
tggagcaccaggtgatcct

SEQ ID NO: 245 - DNA, 21 bp, Artificial Sequence
  Description of Artificial Sequence Synthetic primer
tggagctgcaaatgtggtcat

SEQ ID NO: 246 - DNA, 23 bp, Artificial Sequence
  Description of Artificial Sequence Synthetic primer
tggcagaacctcaagactttcag

SEQ ID NO: 247 - DNA, 19 bp, Artificial Sequence
  Description of Artificial Sequence Synthetic primer
tggcggtgatctccttcct

SEQ ID NO: 248 - DNA, 22 bp, Artificial Sequence
  Description of Artificial Sequence Synthetic primer
tggtggcattcagatttttgaa

SEQ ID NO: 249 - DNA, 30 bp, Artificial Sequence
  Description of Artificial Sequence Synthetic primer
tgtgttgggtgcaagtataatttagttaca

SEQ ID NO: 250 - DNA, 19 bp, Artificial Sequence
  Description of Artificial Sequence Synthetic primer
tgttgtgcctgctgaggat

SEQ ID NO: 251 - DNA, 23 bp, Artificial Sequence
  Description of Artificial Sequence Synthetic primer
ttagaactcgcgtttccacttca

SEQ ID NO: 252 - DNA, 25 bp, Artificial Sequence
  Description of Artificial Sequence Synthetic primer
ttccctgttcaagtttcctttgtct

SEQ ID NO: 253 - DNA, 27 bp, Artificial Sequence
  Description of Artificial Sequence Synthetic primer
ttggcaaggaactgaatatgatcatca

SEQ ID NO: 254 - DNA, 21 bp, Artificial Sequence
  Description of Artificial Sequence Synthetic primer
tttccgctgctaatccagtgt

SEQ ID NO: 255 - DNA, 24 bp, Artificial Sequence
  Description of Artificial Sequence Synthetic primer
tttgccttcttcagaaaccatcct

SEQ ID NO: 256 - DNA, 27 bp, Artificial Sequence
  Description of Artificial Sequence Synthetic primer
ttttgccctgtaaagcagaagagatat

SEQ ID NO: 257 - DNA, 23 bp, Artificial Sequence
  Description of Artificial Sequence Synthetic primer
aaaaccaaccagggaatgtgagt

SEQ ID NO: 258 - DNA, 32 bp, Artificial Sequence
  Description of Artificial Sequence Synthetic primer
tgaaagtcaatggctgcagaaaatataaattg

SEQ ID NO: 259 - DNA, 25 bp, Artificial Sequence
  Description of Artificial Sequence Synthetic primer
tggaacacaaagctgatctacaaca

SEQ ID NO: 260 - DNA, 19 bp, Artificial Sequence
  Description of Artificial Sequence Synthetic primer
gccgagccaaactcaagtg

SEQ ID NO: 261 - DNA, 20 bp, Artificial Sequence
  Description of Artificial Sequence Synthetic primer
actgcaggaagcaacacgtt

SEQ ID NO: 262 - DNA, 20 bp, Artificial Sequence
  Description of Artificial Sequence Synthetic primer
gctcctggagtgaagccatt

SEQ ID NO: 263 - DNA, 25 bp, Artificial Sequence
  Description of Artificial Sequence Synthetic primer
ccttgacctccaccgtatatttgag

SEQ ID NO: 264 - DNA, 20 bp, Artificial Sequence
  Description of Artificial Sequence Synthetic primer
caggaggatgtccggttctg

SEQ ID NO: 265 - DNA, 34 bp, Artificial Sequence
  Description of Artificial Sequence Synthetic primer
aaattcaccttaaagcaaaagcaatatatgagaa

SEQ ID NO: 266 - DNA, 24 bp, Artificial Sequence
  Description of Artificial Sequence Synthetic primer
agagatttcatgaggccaaaagga

SEQ ID NO: 267 - DNA, 25 bp, Artificial Sequence
  Description of Artificial Sequence Synthetic primer
tcacaggactatgatcagcttcctt

SEQ ID NO: 268 - DNA, 22 bp, Artificial Sequence
  Description of Artificial Sequence Synthetic primer
ccgaagacgtgtttgcaaatgt

SEQ ID NO: 269 - DNA, 25 bp, Artificial Sequence
  Description of Artificial Sequence Synthetic primer
agctcagttgagttagagtctggaa

SEQ ID NO: 270 - DNA, 27 bp, Artificial Sequence
  Description of Artificial Sequence Synthetic primer
gatcttagcaacaaagcttcattagca

SEQ ID NO: 271 - DNA, 17 bp, Artificial Sequence
  Description of Artificial Sequence Synthetic primer
cgcccacaagccacaga

SEQ ID NO: 272 - DNA, 22 bp, Artificial Sequence
  Description of Artificial Sequence Synthetic primer
ccccagttctcctggctttaac

SEQ ID NO: 273 - DNA, 23 bp, Artificial Sequence
  Description of Artificial Sequence Synthetic primer
gggaattcagcctcagtgatgtc

SEQ ID NO: 274 - DNA, 20 bp, Artificial Sequence
  Description of Artificial Sequence Synthetic primer
gctcctggagtgaagccatt

SEQ ID NO: 275 - DNA, 21 bp, Artificial Sequence
  Description of Artificial Sequence Synthetic primer
gaaccctgtacgtgcttcctt

SEQ ID NO: 276 - DNA, 18 bp, Artificial Sequence
  Description of Artificial Sequence Synthetic primer
cagccactgtccctgtct

SEQ ID NO: 277 - DNA, 24 bp, Artificial Sequence
  Description of Artificial Sequence Synthetic primer
ggagcatgatctggtccttaaagt

SEQ ID NO: 278 - DNA, 17 bp, Artificial Sequence
  Description of Artificial Sequence Synthetic primer
actctgggcccgcaatg

SEQ ID NO: 279 - DNA, 32 bp, Artificial Sequence
  Description of Artificial Sequence Synthetic primer
acacttctctgaaagaatatgatgtcactttt

SEQ ID NO: 280 - DNA, 18 bp, Artificial Sequence
  Description of Artificial Sequence Synthetic primer
gcaacagagggcccacat

SEQ ID NO: 281 - DNA, 16 bp, Artificial Sequence
  Description of Artificial Sequence Synthetic primer
acgctgcccgttcaga

SEQ ID NO: 282 - DNA, 28 bp, Artificial Sequence
  Description of Artificial Sequence Synthetic primer
ccccaaggagtttggaaattaggattat

SEQ ID NO: 283 - DNA, 34 bp, Artificial Sequence
  Description of Artificial Sequence Synthetic primer
atttcaaatgctgctttattcttacaaatactgt

SEQ ID NO: 284 - DNA, 17 bp, Artificial Sequence
  Description of Artificial Sequence Synthetic primer
ggcaggacagcctcctt

SEQ ID NO: 285 - DNA, 20 bp, Artificial Sequence
  Description of Artificial Sequence Synthetic primer
agtaacaccgccacgaagac

SEQ ID NO: 286 - DNA, 23 bp, Artificial Sequence
  Description of Artificial Sequence Synthetic primer
gtttgccttctcatcaccaatgg

SEQ ID NO: 287 - DNA, 21 bp, Artificial Sequence
  Description of Artificial Sequence Synthetic primer
cagcacgtcctgaactgtttc

SEQ ID NO: 288 - DNA, 19 bp, Artificial Sequence
  Description of Artificial Sequence Synthetic primer
ccacccatgccccattctt

SEQ ID NO: 289 - DNA, 31 bp, Artificial Sequence
  Description of Artificial Sequence Synthetic primer
cactttcaaagactttacatgtaccaaacat

SEQ ID NO: 290 - DNA, 18 bp, Artificial Sequence
  Description of Artificial Sequence Synthetic primer
ggtgctggtcacgatcct

SEQ ID NO: 291 - DNA, 28 bp, Artificial Sequence
  Description of Artificial Sequence Synthetic primer
agatttgactcatcagtagaccctagag

SEQ ID NO: 292 - DNA, 26 bp, Artificial Sequence
  Description of Artificial Sequence Synthetic primer
atttttccatgcaaatgggtgaaact

SEQ ID NO: 293 - DNA, 25 bp, Artificial Sequence
  Description of Artificial Sequence Synthetic primer
gactccctccaagattgcctaattt

SEQ ID NO: 294 - DNA, 20 bp, Artificial Sequence
  Description of Artificial Sequence Synthetic primer
gcctctccgcttccatcttc

SEQ ID NO: 295 - DNA, 29 bp, Artificial Sequence
  Description of Artificial Sequence Synthetic primer
tcttctgcttctcttaataatgctcacaa

SEQ ID NO: 296 - DNA, 34 bp, Artificial Sequence
  Description of Artificial Sequence Synthetic primer
cctttgctgatgaggaatttttaaagtatttcat

SEQ ID NO: 297 - DNA, 22 bp, Artificial Sequence
  Description of Artificial Sequence Synthetic primer
tcttccacaggacaaggtgaga

SEQ ID NO: 298 - DNA, 17 bp, Artificial Sequence
  Description of Artificial Sequence Synthetic primer
ggcaggcggagcaagag

SEQ ID NO: 299 - DNA, 26 bp, Artificial Sequence
  Description of Artificial Sequence Synthetic primer
tcagaggcaataccatctcacctata

SEQ ID NO: 300 - DNA, 24 bp, Artificial Sequence
  Description of Artificial Sequence Synthetic primer
gacttcagccaatcttcaaaacgt

SEQ ID NO: 301 - DNA, 25 bp, Artificial Sequence
  Description of Artificial Sequence Synthetic primer
cctccatgatgtgttctatgacctt

SEQ ID NO: 302 - DNA, 20 bp, Artificial Sequence
  Description of Artificial Sequence Synthetic primer
cgtgagatcgtgcagtgatg

SEQ ID NO: 303 - DNA, 17 bp, Artificial Sequence
  Description of Artificial Sequence Synthetic primer
aggccttgcagcagtgt

SEQ ID NO: 304 - DNA, 21 bp, Artificial Sequence
  Description of Artificial Sequence Synthetic primer
gctactctgtgggctcttgtc

SEQ ID NO: 305 - DNA, 25 bp, Artificial Sequence
  Description of Artificial Sequence Synthetic primer
cctcttcagtttcagcaatggtttg

SEQ ID NO: 306 - DNA, 19 bp, Artificial Sequence
  Description of Artificial Sequence Synthetic primer
gctgctcggcagattggta

SEQ ID NO: 307 - DNA, 22 bp, Artificial Sequence
  Description of Artificial Sequence Synthetic primer
cacctcactttcagcagtctgt

SEQ ID NO: 308 - DNA, 25 bp, Artificial Sequence
  Description of Artificial Sequence Synthetic primer
ccaataagcttcctccttccttctg

SEQ ID NO: 309 - DNA, 25 bp, Artificial Sequence
  Description of Artificial Sequence Synthetic primer
aaattgcttgaagatgggactctca

SEQ ID NO: 310 - DNA, 17 bp, Artificial Sequence
  Description of Artificial Sequence Synthetic primer
ggcggtagcgcttgact

SEQ ID NO: 311 - DNA, 25 bp, Artificial Sequence
  Description of Artificial Sequence Synthetic primer
tgagatatgatgagcctcgcttttc

SEQ ID NO: 312 - DNA, 25 bp, Artificial Sequence
  Description of Artificial Sequence Synthetic primer
ccaagggcgatttaatatgggtcat

SEQ ID NO: 313 - DNA, 23 bp, Artificial Sequence
  Description of Artificial Sequence Synthetic primer
aggtgttgttccttcacggaatc

SEQ ID NO: 314 - DNA, 17 bp, Artificial Sequence
  Description of Artificial Sequence Synthetic primer
gtgtgggccgagactga

SEQ ID NO: 315 - DNA, 25 bp, Artificial Sequence
  Description of Artificial Sequence Synthetic primer
ctccattcaatagtccaggtcttca

SEQ ID NO: 316 - DNA, 21 bp, Artificial Sequence
  Description of Artificial Sequence Synthetic primer
tctgtggacctcagcagcatt

SEQ ID NO: 317 - DNA, 23 bp, Artificial Sequence
  Description of Artificial Sequence Synthetic primer
agcgcactgtaagtctcattctg

SEQ ID NO: 318 - DNA, 20 bp, Artificial Sequence
  Description of Artificial Sequence Synthetic primer
cacacttggcggttctttcg

SEQ ID NO: 319 - DNA, 23 bp, Artificial Sequence
  Description of Artificial Sequence Synthetic primer
ctcatggtttctccagagtcgtt

SEQ ID NO: 320 - DNA, 25 bp, Artificial Sequence
  Description of Artificial Sequence Synthetic primer
cccactgaccactcacattaatctt

SEQ ID NO: 321 - DNA, 25 bp, Artificial Sequence
  Description of Artificial Sequence Synthetic primer
cccactgaccactcacattaatctt

SEQ ID NO: 322 - DNA, 25 bp, Artificial Sequence
  Description of Artificial Sequence Synthetic primer
cccactgaccactcacattaatctt

SEQ ID NO: 323 - DNA, 20 bp, Artificial Sequence
  Description of Artificial Sequence Synthetic primer
catgggctacaggcttgtca

SEQ ID NO: 324 - DNA, 20 bp, Artificial Sequence
  Description of Artificial Sequence Synthetic primer
gaggccctgggcagattact

SEQ ID NO: 325 - DNA, 20 bp, Artificial Sequence
  Description of Artificial Sequence Synthetic primer
cgtgggccacattgttacac

SEQ ID NO: 326 - DNA, 19 bp, Artificial Sequence
  source: Description of Artificial Sequence Synthetic primer
gccatgagcaccactccta

SEQ ID NO: 327 - DNA, 19 bp, Artificial Sequence
  Description of Artificial Sequence Synthetic primer
gccatgagcaccactccta

SEQ ID NO: 328 - DNA, 22 bp, Artificial Sequence
  Description of Artificial Sequence Synthetic primer
gatgcaatgcttgccatgctat

SEQ ID NO: 329 - DNA, 23 bp, Artificial Sequence
  Description of Artificial Sequence Synthetic primer
gcagtccaggaaactttcaggat

SEQ ID NO: 330 - DNA, 21 bp, Artificial Sequence
  Description of Artificial Sequence Synthetic primer
gcaggtccccatcttcttcag

SEQ ID NO: 331 - DNA, 25 bp, Artificial Sequence
  Description of Artificial Sequence Synthetic primer
caatttagtccaaaagggccattct

SEQ ID NO: 332 - DNA, 18 bp, Artificial Sequence
  Description of Artificial Sequence Synthetic primer
cctgtttgcgcagtaccc

SEQ ID NO: 333 - DNA, 20 bp, Artificial Sequence
  Description of Artificial Sequence Synthetic primer
ccagaggcatggaccttgag

SEQ ID NO: 334 - DNA, 24 bp, Artificial Sequence
  Description of Artificial Sequence Synthetic primer
gataggatgcccatccagaagaac

SEQ ID NO: 335 - DNA, 21 bp, Artificial Sequence
  Description of Artificial Sequence Synthetic primer
ctcctcccttctggtcagttg

SEQ ID NO: 336 - DNA, 19 bp, Artificial Sequence
  Description of Artificial Sequence Synthetic primer
gctgtccccgaatcctaca

SEQ ID NO: 337 - DNA, 15 bp, Artificial Sequence
  Description of Artificial Sequence Synthetic primer
cccgctgccggtcaa

SEQ ID NO: 338 - DNA, 22 bp, Artificial Sequence
  Description of Artificial Sequence Synthetic primer
ggcttttctgggaaccagtgat

SEQ ID NO: 339 - DNA, 24 bp, Artificial Sequence
  Description of Artificial Sequence Synthetic primer
gttcatgtattgctttgcgttgga

SEQ ID NO: 340 - DNA, 25 bp, Artificial Sequence
  Description of Artificial Sequence Synthetic primer
acctggcccattctgtaaataaagg

SEQ ID NO: 341 - DNA, 23 bp, Artificial Sequence
  Description of Artificial Sequence Synthetic primer
gactttaagaagcggctgtagct

SEQ ID NO: 342 - DNA, 22 bp, Artificial Sequence
  Description of Artificial Sequence Synthetic primer
cccatagtccacagagaacaca

SEQ ID NO: 343 - DNA, 23 bp, Artificial Sequence
  Description of Artificial Sequence Synthetic primer
agcatgacccgatcttgaacttc

SEQ ID NO: 344 - DNA, 21 bp, Artificial Sequence
  Description of Artificial Sequence Synthetic primer
catgctggatgctgacacaaa

SEQ ID NO: 345 - DNA, 23 bp, Artificial Sequence
  Description of Artificial Sequence Synthetic primer
gatcttcccggtctaagccatag

SEQ ID NO: 346 - DNA, 22 bp, Artificial Sequence
  Description of Artificial Sequence Synthetic primer
gagaggcctcagcttgtcaaat

SEQ ID NO: 347 - DNA, 25 bp, Artificial Sequence
  Description of Artificial Sequence Synthetic primer
gatcctggcatctctctgaaatgag

SEQ ID NO: 348 - DNA, 22 bp, Artificial Sequence
  Description of Artificial Sequence Synthetic primer
ggctgctgatgtcaaacagaat

SEQ ID NO: 349 - DNA, 21 bp, Artificial Sequence
  Description of Artificial Sequence Synthetic primer
cctccaccacagtcaccatgt

SEQ ID NO: 350 - DNA, 17 bp, Artificial Sequence
  Description of Artificial Sequence Synthetic primer
acctcccttcccgacca

SEQ ID NO: 351 - DNA, 19 bp, Artificial Sequence
  Description of Artificial Sequence Synthetic primer
tgcggcgattctgaaacca

SEQ ID NO: 352 - DNA, 15 bp, Artificial Sequence
  Description of Artificial Sequence Synthetic primer
gtggcgtgccaaggc

SEQ ID NO: 353 - DNA, 15 bp, Artificial Sequence
  Description of Artificial Sequence Synthetic primer
gtggcgtgccaaggc

SEQ ID NO: 354 - DNA, 21 bp, Artificial Sequence
  Description of Artificial Sequence Synthetic primer
tgaagacaaatcgcttttcca

SEQ ID NO: 355 - DNA, 23 bp, Artificial Sequence
  Description of Artificial Sequence Synthetic primer
ccctcatgtgtgctcttcctaag

SEQ ID NO: 356 - DNA, 25 bp, Artificial Sequence
  Description of Artificial Sequence Synthetic primer
ggaacaggaagagtatgatgcgttt

SEQ ID NO: 357 - DNA, 27 bp, Artificial Sequence
  Description of Artificial Sequence Synthetic primer
cagcattggtttatgatcagtctttca

SEQ ID NO: 358 - DNA, 20 bp, Artificial Sequence
  Description of Artificial Sequence Synthetic primer
cccaggagagacggaaacag

SEQ ID NO: 359 - DNA, 25 bp, Artificial Sequence
  Description of Artificial Sequence Synthetic primer
gcttctgtttgctcactcttaaggt

SEQ ID NO: 360 - DNA, 25 bp, Artificial Sequence
  Description of Artificial Sequence Synthetic primer
gcaccatcagtgttgatatccaact

SEQ ID NO: 361 - DNA, 25 bp, Artificial Sequence
  Description of Artificial Sequence Synthetic primer
cagacggacgagggaaacaatatta

SEQ ID NO: 362 - DNA, 21 bp, Artificial Sequence
  Description of Artificial Sequence Synthetic primer
ggcccagagccttttcattct

SEQ ID NO: 363 - DNA, 23 bp, Artificial Sequence
  Description of Artificial Sequence Synthetic primer
ttcctcgttgtccttcttgaact

SEQ ID NO: 364 - DNA, 23 bp, Artificial Sequence
  Description of Artificial Sequence Synthetic primer
tgcctgatcacatttcctccaaa

SEQ ID NO: 365 - DNA, 21 bp, Artificial Sequence
  Description of Artificial Sequence Synthetic primer
cccgggttatgctggttgtac

SEQ ID NO: 366 - DNA, 21 bp, Artificial Sequence
  Description of Artificial Sequence Synthetic primer
cccgggttatgctggttgtac

SEQ ID NO: 367 - DNA, 22 bp, Artificial Sequence
  Description of Artificial Sequence Synthetic primer
ggatgtgtgaatgcaccaagtc

SEQ ID NO: 368 - DNA, 21 bp, Artificial Sequence
  Description of Artificial Sequence Synthetic primer
tgaactggaacttggcacaca

SEQ ID NO: 369 - DNA, 21 bp, Artificial Sequence
  Description of Artificial Sequence Synthetic primer
ggaggaggcttccttgactgt

SEQ ID NO: 370 - DNA, 25 bp, Artificial Sequence
  Description of Artificial Sequence Synthetic primer
cagacaaatttgggaagtgaacagt

SEQ ID NO: 371 - DNA, 25 bp, Artificial Sequence
  Description of Artificial Sequence Synthetic primer
ctgcttcacctgttgtacaatttcc

SEQ ID NO: 372 - DNA, 18 bp, Artificial Sequence
  Description of Artificial Sequence Synthetic primer
tgaccggcctggaagaga

SEQ ID NO: 373 - DNA, 24 bp, Artificial Sequence
  Description of Artificial Sequence Synthetic primer
tggctcatttgttgtttcttatgg

SEQ ID NO: 374 - DNA, 33 bp, Artificial Sequence
  Description of Artificial Sequence Synthetic primer
agttttaatattttctcttcacttgtcctggaa

SEQ ID NO: 375 - DNA, 16 bp, Artificial Sequence
  Description of Artificial Sequence Synthetic primer
cccggagcagctgtgt

SEQ ID NO: 376 - DNA, 24 bp, Artificial Sequence
  Description of Artificial Sequence Synthetic primer
acacaatggacaacagggatatgg

SEQ ID NO: 377 - DNA, 18 bp, Artificial Sequence
  Description of Artificial Sequence Synthetic primer
aacgtgtggcctcagtgt

SEQ ID NO: 378 - DNA, 22 bp, Artificial Sequence
  Description of Artificial Sequence Synthetic primer
gctggtcatcgacgaaattgag

SEQ ID NO: 379 - DNA, 25 bp, Artificial Sequence
  Description of Artificial Sequence Synthetic primer
ggtgcatgagaagtgaataggtgat

SEQ ID NO: 380 - DNA, 25 bp, Artificial Sequence
  Description of Artificial Sequence Synthetic primer
cgtcagctgtttcatagtcattgtt

SEQ ID NO: 381 - DNA, 29 bp, Artificial Sequence
  Description of Artificial Sequence Synthetic primer
cagagctaatctaaggtaattccatgtct

SEQ ID NO: 382 - DNA, 20 bp, Artificial Sequence
  Description of Artificial Sequence Synthetic primer
gcccttggcccagttattcc

SEQ ID NO: 383 - DNA, 20 bp, Artificial Sequence
  Description of Artificial Sequence Synthetic primer
gctgcttcaggagggagatc

SEQ ID NO: 384 - DNA, 24 bp, Artificial Sequence
  Description of Artificial Sequence Synthetic primer
gttgctgggttcttaacacaatgg

SEQ ID NO: 385 - DNA, 19 bp, Artificial Sequence
  Description of Artificial Sequence Synthetic primer
gggccagggaaaccttctg

SEQ ID NO: 386 - DNA, 25 bp, Artificial Sequence
  Description of Artificial Sequence Synthetic primer
ctctggaagtgctttagcttctttc

SEQ ID NO: 387 - DNA, 24 bp, Artificial Sequence
  Description of Artificial Sequence Synthetic primer
caggacacacttccgatggattta

SEQ ID NO: 388 - DNA, 24 bp, Artificial Sequence
  Description of Artificial Sequence Synthetic primer
tcacaggcttctcgataaaatgct

SEQ ID NO: 389 - DNA, 18 bp, Artificial Sequence
  Description of Artificial Sequence Synthetic primer
gggacttgctgccttcct

SEQ ID NO: 390 - DNA, 25 bp, Artificial Sequence
  Description of Artificial Sequence Synthetic primer
ctcactgaggagtctcttgatctga

SEQ ID NO: 391 - DNA, 20 bp, Artificial Sequence
  Description of Artificial Sequence Synthetic primer
ggctccatctacaggttgca

SEQ ID NO: 392 - DNA, 27 bp, Artificial Sequence
  Description of Artificial Sequence Synthetic primer
cttctcatctctggaaatcaggcttat

SEQ ID NO: 393 - DNA, 25 bp, Artificial Sequence
  Description of Artificial Sequence Synthetic primer
gggcaatcagagttttggtttgaaa

SEQ ID NO: 394 - DNA, 28 bp, Artificial Sequence
  Description of Artificial Sequence Synthetic primer
ctgtctcttctgttttcttcttgtagga

SEQ ID NO: 395 - DNA, 25 bp, Artificial Sequence
  Description of Artificial Sequence Synthetic primer
cacggataaacctggaaatgattgg

SEQ ID NO: 396 - DNA, 22 bp, Artificial Sequence
  Description of Artificial Sequence Synthetic primer
ccatcacttggcccatgaaaag

SEQ ID NO: 397 - DNA, 20 bp, Artificial Sequence
  Description of Artificial Sequence Synthetic primer
cccagcagggcaaatctctt

SEQ ID NO: 398 - DNA, 16 bp, Artificial Sequence
  Description of Artificial Sequence Synthetic primer
agtcgtccggctgctc

SEQ ID NO: 399 - DNA, 25 bp, Artificial Sequence
  Description of Artificial Sequence Synthetic primer
ctggagtggttgatttagtctggta

SEQ ID NO: 400 - DNA, 25 bp, Artificial Sequence
  Description of Artificial Sequence Synthetic primer
agatgtcaaactcactcatggcttt

SEQ ID NO: 401 - DNA, 29 bp, Artificial Sequence
  Description of Artificial Sequence Synthetic primer
tgtcactctccatgttaaaatcttccatt

SEQ ID NO: 402 - DNA, 16 bp, Artificial Sequence
  Description of Artificial Sequence Synthetic primer
ccagctcccgcactgt

SEQ ID NO: 403 - DNA, 21 bp, Artificial Sequence
  Description of Artificial Sequence Synthetic primer
cacgatgcaggtgacattgac

SEQ ID NO: 404 - DNA, 17 bp, Artificial Sequence
  Description of Artificial Sequence Synthetic primer
gggttggcctgcatgtg

SEQ ID NO: 405 - DNA, 21 bp, Artificial Sequence
  Description of Artificial Sequence Synthetic primer
gttggcagaccatgagtacga

SEQ ID NO: 406 - DNA, 25 bp, Artificial Sequence
  Description of Artificial Sequence Synthetic primer
tttctgtcactgattcagggaactg

SEQ ID NO: 407 - DNA, 17 bp, Artificial Sequence
  Description of Artificial Sequence Synthetic primer
ccggcaccactcacagt

SEQ ID NO: 408 - DNA, 20 bp, Artificial Sequence
  Description of Artificial Sequence Synthetic primer
ctgggtttgccggattcttg

SEQ ID NO: 409 - DNA, 18 bp, Artificial Sequence
  Description of Artificial Sequence Synthetic primer
gggcaatgttgcgagacc

SEQ ID NO: 410 - DNA, 22 bp, Artificial Sequence
  Description of Artificial Sequence Synthetic primer
agcctggacaaatctgtgaagt

SEQ ID NO: 411 - DNA, 16 bp, Artificial Sequence
  Description of Artificial Sequence Synthetic primer
gtgggagcgccacaca

SEQ ID NO: 412 - DNA, 24 bp, Artificial Sequence
  Description of Artificial Sequence Synthetic primer
tctgaaaagagcctttggattgct

SEQ ID NO: 413 - DNA, 23 bp, Artificial Sequence
  Description of Artificial Sequence Synthetic primer
ctcctcttcctcctggttttctg

SEQ ID NO: 414 - DNA, 21 bp, Artificial Sequence
  Description of Artificial Sequence Synthetic primer
ggtgtgagccccgaagtaatc

SEQ ID NO: 415 - DNA, 26 bp, Artificial Sequence
  Description of Artificial Sequence Synthetic primer
tctggaaaatctggaatgacgttctc

SEQ ID NO: 416 - DNA, 19 bp, Artificial Sequence
  Description of Artificial Sequence Synthetic primer
gccctaccgggaactgaag

SEQ ID NO: 417 - DNA, 20 bp, Artificial Sequence
  Description of Artificial Sequence Synthetic primer
gtgcccgtgccaattatctg

SEQ ID NO: 418 - DNA, 25 bp, Artificial Sequence
  Description of Artificial Sequence Synthetic primer
tggcagtgatgcaaagcaaaataaa

SEQ ID NO: 419 - DNA, 22 bp, Artificial Sequence
  Description of Artificial Sequence Synthetic primer
tgagggctagatggtccagatc

SEQ ID NO: 420 - DNA, 25 bp, Artificial Sequence
  Description of Artificial Sequence Synthetic primer
gttgttgctcatggtgtagtatcct

SEQ ID NO: 421 - DNA, 22 bp, Artificial Sequence
  Description of Artificial Sequence Synthetic primer
cagtgggtgtaaacagcattgg

SEQ ID NO: 422 - DNA, 25 bp, Artificial Sequence
  Description of Artificial Sequence Synthetic primer
gctggaagtttttcagagggttctt

SEQ ID NO: 423 - DNA, 20 bp, Artificial Sequence
  Description of Artificial Sequence Synthetic primer
tgtattcccgcgaccattcg

SEQ ID NO: 424 - DNA, 24 bp, Artificial Sequence
  Description of Artificial Sequence Synthetic primer
agaacattccgggcattcaaatct

SEQ ID NO: 425 - DNA, 22 bp, Artificial Sequence
  Description of Artificial Sequence Synthetic primer
tggtggagagcaaagtcttgag

SEQ ID NO: 426 - DNA, 26 bp, Artificial Sequence
  Description of Artificial Sequence Synthetic primer
ccattggcataccaacattctctcat

SEQ ID NO: 427 - DNA, 18 bp, Artificial Sequence
  Description of Artificial Sequence Synthetic primer
gccctcctgggtcctcta

SEQ ID NO: 428 - DNA, 27 bp, Artificial Sequence
  Description of Artificial Sequence Synthetic primer
tctatgtagtctccctgaatggtatgg

SEQ ID NO: 429 - DNA, 21 bp, Artificial Sequence
  Description of Artificial Sequence Synthetic primer
gggaaagcgtgatccgtactt

SEQ ID NO: 430 - DNA, 22 bp, Artificial Sequence
  Description of Artificial Sequence Synthetic primer
gccaaggtgatgcctattctca

SEQ ID NO: 431 - DNA, 22 bp, Artificial Sequence
  Description of Artificial Sequence Synthetic primer
cagtcaacgtctcacacaccat

SEQ ID NO: 432 - DNA, 18 bp, Artificial Sequence
  Description of Artificial Sequence Synthetic primer
tgcctgggtgctctggaa

SEQ ID NO: 433 - DNA, 26 bp, Artificial Sequence
  Description of Artificial Sequence Synthetic primer
ccaggccttggaatatttcatcaatg

SEQ ID NO: 434 - DNA, 20 bp, Artificial Sequence
  Description of Artificial Sequence Synthetic primer
ccagggctgccttcagaaat

SEQ ID NO: 435 - DNA, 27 bp, Artificial Sequence
  Description of Artificial Sequence Synthetic primer
tgtccaggctttgaatttctcatatgt

SEQ ID NO: 436 - DNA, 25 bp, Artificial Sequence
  Description of Artificial Sequence Synthetic primer
cagccctcgttctctttctagttta

SEQ ID NO: 437 - DNA, 20 bp, Artificial Sequence
  Description of Artificial Sequence Synthetic primer
tggccagagcttttccgaat

SEQ ID NO: 438 - DNA, 24 bp, Artificial Sequence
  Description of Artificial Sequence Synthetic primer
gctatccctttgcaattccagtga

SEQ ID NO: 439 - DNA, 22 bp, Artificial Sequence
  Description of Artificial Sequence Synthetic primer
ctccacgctcttcaggaagaag

SEQ ID NO: 440 - DNA, 25 bp, Artificial Sequence
  Description of Artificial Sequence Synthetic primer
gctcagtttctactacttggtgtgt

SEQ ID NO: 441 - DNA, 25 bp, Artificial Sequence
  Description of Artificial Sequence Synthetic primer
tcgaggtcttcagatttcagagtca

SEQ ID NO: 442 - DNA, 17 bp, Artificial Sequence
  Description of Artificial Sequence Synthetic primer
ggacgtgccgcttttcc

SEQ ID NO: 443 - DNA, 21 bp, Artificial Sequence
  Description of Artificial Sequence Synthetic primer
acccactttgttggcctttct

SEQ ID NO: 444 - DNA, 16 bp, Artificial Sequence
  Description of Artificial Sequence Synthetic primer
ccgccacgagcacagt

SEQ ID NO: 445 - DNA, 18 bp, Artificial Sequence
  Description of Artificial Sequence Synthetic primer
ccggcggatctgatcact

SEQ ID NO: 446 - DNA, 25 bp, Artificial Sequence
  Description of Artificial Sequence Synthetic primer
gcacacctgacatgaaagagtaaga

SEQ ID NO: 447 - DNA, 21 bp, Artificial Sequence
  Description of Artificial Sequence Synthetic primer
ggcactggcttcaaagaactc

SEQ ID NO: 448 - DNA, 25 bp, Artificial Sequence
  Description of Artificial Sequence Synthetic primer
ggcaggacatgatttatggacagta

SEQ ID NO: 449 - DNA, 24 bp, Artificial Sequence
  Description of Artificial Sequence Synthetic primer
gaaagtggtctctgtggaaaacct

SEQ ID NO: 450 - DNA, 24 bp, Artificial Sequence
  Description of Artificial Sequence Synthetic primer
cctcgtccattctacgaacttctc

SEQ ID NO: 451 - DNA, 20 bp, Artificial Sequence
  Description of Artificial Sequence Synthetic primer
tgcatttgcacggtgaactc

SEQ ID NO: 452 - DNA, 22 bp, Artificial Sequence
  Description of Artificial Sequence Synthetic primer
acttgtgcagactcaggttgtg

SEQ ID NO: 453 - DNA, 24 bp, Artificial Sequence
  Description of Artificial Sequence Synthetic primer
gattctcgagtgcggaagtcaata

SEQ ID NO: 454 - DNA, 22 bp, Artificial Sequence
  source: Description of Artificial Sequence Synthetic primer
gttactttgcaacaggcaggaa

SEQ ID NO: 455 - DNA, 23 bp, Artificial Sequence
  Description of Artificial Sequence Synthetic primer
cttctctgtgtagctggcatagg

SEQ ID NO: 456 - DNA, 25 bp, Artificial Sequence
  Description of Artificial Sequence Synthetic primer
gggactctggagtacattccaaatg

SEQ ID NO: 457 - DNA, 20 bp, Artificial Sequence
  Description of Artificial Sequence Synthetic primer
tccgcagggtgtagaggtaa

SEQ ID NO: 458 - DNA, 22 bp, Artificial Sequence
  Description of Artificial Sequence Synthetic primer
gcctctcctgctccaaattcat

SEQ ID NO: 459 - DNA, 18 bp, Artificial Sequence
  Description of Artificial Sequence Synthetic primer
tggaactggcgggaacag

SEQ ID NO: 460 - DNA, 25 bp, Artificial Sequence
  Description of Artificial Sequence Synthetic primer
cccagtcaagttgatgcagaaaatt

SEQ ID NO: 461 - DNA, 19 bp, Artificial Sequence
  Description of Artificial Sequence Synthetic primer
gcagagcctcgaacacaga

SEQ ID NO: 462 - DNA, 26 bp, Artificial Sequence
  Description of Artificial Sequence Synthetic primer
gttgagtgatgctgtttgtaatgact

SEQ ID NO: 463 - DNA, 19 bp, Artificial Sequence
  Description of Artificial Sequence Synthetic primer
ggccttgaggtgctttgtg

SEQ ID NO: 464 - DNA, 17 bp, Artificial Sequence
  Description of Artificial Sequence Synthetic primer
gcgcggtcgtggtttag

SEQ ID NO: 465 - DNA, 20 bp, Artificial Sequence
  Description of Artificial Sequence Synthetic primer
ctgggcttgtctcccgattt

SEQ ID NO: 466 - DNA, 23 bp, Artificial Sequence
  Description of Artificial Sequence Synthetic primer
cctcctccacctccttcttcata

SEQ ID NO: 467 - DNA, 23 bp, Artificial Sequence
  Description of Artificial Sequence Synthetic primer
tcaatcaagcagtcccactgatc

SEQ ID NO: 468 - DNA, 17 bp, Artificial Sequence
  Description of Artificial Sequence Synthetic primer
tccaccacggcgtacag

SEQ ID NO: 469 - DNA, 18 bp, Artificial Sequence
  Description of Artificial Sequence Synthetic primer
gggctgaggttgctctga

SEQ ID NO: 470 - DNA, 25 bp, Artificial Sequence
  Description of Artificial Sequence Synthetic primer
gttgtggagatgtagcagagaagat

SEQ ID NO: 471 - DNA, 18 bp, Artificial Sequence
  Description of Artificial Sequence Synthetic primer
tggaactggcgggaacag

SEQ ID NO: 472 - DNA, 21 bp, Artificial Sequence
  Description of Artificial Sequence Synthetic primer
catggtgctggtcagagagaa

SEQ ID NO: 473 - DNA, 16 bp, Artificial Sequence
  Description of Artificial Sequence Synthetic primer
gcagcctgggctcctg

SEQ ID NO: 474 - DNA, 20 bp, Artificial Sequence
  Description of Artificial Sequence Synthetic primer
ggacccaagagcagtttcca

SEQ ID NO: 475 - DNA, 22 bp, Artificial Sequence
  Description of Artificial Sequence Synthetic primer
ggcctctgcagatttccattct

SEQ ID NO: 476 - DNA, 22 bp, Artificial Sequence
  Description of Artificial Sequence Synthetic probe
cctttaaggaaatgaatcctcc

SEQ ID NO: 477 - DNA, 20 bp, Artificial Sequence
  Description of Artificial Sequence Synthetic probe
tttttcttgttccatcccag

SEQ ID NO: 478 - DNA, 18 bp, Artificial Sequence
  Description of Artificial Sequence Synthetic probe
caaacagtgcaagatgtc

SEQ ID NO: 479 - DNA, 20 bp, Artificial Sequence
  Description of Artificial Sequence Synthetic probe
ccacattggaaacaccattt

SEQ ID NO: 480 - DNA, 22 bp, Artificial Sequence
  Description of Artificial Sequence Synthetic probe
aaaagactgagcatgctcactt

SEQ ID NO: 481 - DNA, 17 bp, Artificial Sequence
  Description of Artificial Sequence Synthetic probe
ccgggtgtctgcattga

SEQ ID NO: 482 - DNA, 15 bp, Artificial Sequence
  Description of Artificial Sequence Synthetic probe
cccagcctcaatgtc

SEQ ID NO: 483 - DNA, 18 bp, Artificial Sequence
  Description of Artificial Sequence Synthetic probe
tcccagtctcattaagcc

SEQ ID NO: 484 - DNA, 16 bp, Artificial Sequence
  Description of Artificial Sequence Synthetic probe
caggcgaatcaacatc

SEQ ID NO: 485 - DNA, 16 bp, Artificial Sequence
  Description of Artificial Sequence Synthetic probe
caccccagctgttctt

SEQ ID NO: 486 - DNA, 26 bp, Artificial Sequence
  Description of Artificial Sequence Synthetic probe
tctcaggtagatgtgattatccttat

SEQ ID NO: 487 - DNA, 16 bp, Artificial Sequence
  Description of Artificial Sequence Synthetic probe
ctcgccccatggttca

SEQ ID NO: 488 - DNA, 16 bp, Artificial Sequence
  Description of Artificial Sequence Synthetic probe
cagcagcagcttcttt

SEQ ID NO: 489 - DNA, 16 bp, Artificial Sequence
  Description of Artificial Sequence Synthetic probe
ctgctgacagaaactt

SEQ ID NO: 490 - DNA, 21 bp, Artificial Sequence
  Description of Artificial Sequence Synthetic probe
cctgagattaaatgtaaaatc

SEQ ID NO: 491 - DNA, 19 bp, Artificial Sequence
  Description of Artificial Sequence Synthetic probe
ccaaggacgatacctcgcg

SEQ ID NO: 492 - DNA, 20 bp, Artificial Sequence
  Description of Artificial Sequence Synthetic probe
tcttctgcatacactcctcc

SEQ ID NO: 493 - DNA, 18 bp, Artificial Sequence
  Description of Artificial Sequence Synthetic probe
ctgcatgaacccatctgc

SEQ ID NO: 494 - DNA, 21 bp, Artificial Sequence
  Description of Artificial Sequence Synthetic probe
tctacaggtcccctctgagcc

SEQ ID NO: 495 - DNA, 16 bp, Artificial Sequence
  Description of Artificial Sequence Synthetic probe
ccgggaaggttcgcta

SEQ ID NO: 496 - DNA, 20 bp, Artificial Sequence
  Description of Artificial Sequence Synthetic probe
ctggtgcaaaagaggtacac

SEQ ID NO: 497 - DNA, 19 bp, Artificial Sequence
  Description of Artificial Sequence Synthetic probe
acgtctcttcgattttcag

SEQ ID NO: 498 - DNA, 18 bp, Artificial Sequence
  Description of Artificial Sequence Synthetic probe
tccttcttgagaaaattt

SEQ ID NO: 499 - DNA, 18 bp, Artificial Sequence
  Description of Artificial Sequence Synthetic probe
ttgtacatggccactttc

SEQ ID NO: 500 - DNA, 19 bp, Artificial Sequence
  Description of Artificial Sequence Synthetic probe
ctcagggagctccttcgtt

SEQ ID NO: 501 - DNA, 17 bp, Artificial Sequence
  Description of Artificial Sequence Synthetic probe
cagctcctcatcatttc

SEQ ID NO: 502 - DNA, 18 bp, Artificial Sequence
  Description of Artificial Sequence Synthetic probe
ccggtgcttcagttagat

SEQ ID NO: 503 - DNA, 18 bp, Artificial Sequence
  Description of Artificial Sequence Synthetic probe
caggagagagcgggacta

SEQ ID NO: 504 - DNA, 18 bp, Artificial Sequence
  Description of Artificial Sequence Synthetic probe
ccaggtgtcggactgtac

SEQ ID NO: 505 - DNA, 18 bp, Artificial Sequence
  Description of Artificial Sequence Synthetic probe
ttggatttgccatttttc

SEQ ID NO: 506 - DNA, 17 bp, Artificial Sequence
  Description of Artificial Sequence Synthetic probe
ctccacctgagtgttcg

SEQ ID NO: 507 - DNA, 17 bp, Artificial Sequence
  Description of Artificial Sequence Synthetic probe
ccccgaagacagcagtc

SEQ ID NO: 508 - DNA, 21 bp, Artificial Sequence
  Description of Artificial Sequence Synthetic probe
aagatgacacctgtgcataat

SEQ ID NO: 509 - DNA, 21 bp, Artificial Sequence
  Description of Artificial Sequence Synthetic probe
atacttctcttggatttcttg

SEQ ID NO: 510 - DNA, 15 bp, Artificial Sequence
  Description of Artificial Sequence Synthetic probe
catgcctgaatctgc

SEQ ID NO: 511 - DNA, 15 bp, Artificial Sequence
  Description of Artificial Sequence Synthetic probe
ccgcccaccgcggaa

SEQ ID NO: 512 - DNA, 18 bp, Artificial Sequence
  Description of Artificial Sequence Synthetic probe
cccagtgagttcagcctt

SEQ ID NO: 513 - DNA, 21 bp, Artificial Sequence
  Description of Artificial Sequence Synthetic probe
aaacaactgtggtatgaagat

SEQ ID NO: 514 - DNA, 18 bp, Artificial Sequence
  Description of Artificial Sequence Synthetic probe
atgcgggacaccttccga

SEQ ID NO: 515 - DNA, 16 bp, Artificial Sequence
  Description of Artificial Sequence Synthetic probe
ccagcagtcgtctttg

SEQ ID NO: 516 - DNA, 16 bp, Artificial Sequence
  Description of Artificial Sequence Synthetic probe
catgtgccctggctgc

SEQ ID NO: 517 - DNA, 15 bp, Artificial Sequence
  Description of Artificial Sequence Synthetic probe
ccgacctccaaagcc

SEQ ID NO: 518 - DNA, 15 bp, Artificial Sequence
  Description of Artificial Sequence Synthetic probe
ccgacctccaaagcc

SEQ ID NO: 519 - DNA, 15 bp, Artificial Sequence
  Description of Artificial Sequence Synthetic probe
ccgacctccaaagcc

SEQ ID NO: 520 - DNA, 15 bp, Artificial Sequence
  Description of Artificial Sequence Synthetic probe
aggcagtcagatcat

SEQ ID NO: 521 - DNA, 17 bp, Artificial Sequence
  Description of Artificial Sequence Synthetic probe
tgggtccaagggtagac

SEQ ID NO: 522 - DNA, 17 bp, Artificial Sequence
  Description of Artificial Sequence Synthetic probe
atcccccttgaaggcag

SEQ ID NO: 523 - DNA, 19 bp, Artificial Sequence
  Description of Artificial Sequence Synthetic probe
cccatgatcctcgttgtcc

SEQ ID NO: 524 - DNA, 19 bp, Artificial Sequence
  Description of Artificial Sequence Synthetic probe
cccatgatcctcgttgtcc

SEQ ID NO: 525 - DNA, 21 bp, Artificial Sequence
  Description of Artificial Sequence Synthetic probe
atcacctttcccaataaggag

SEQ ID NO: 526 - DNA, 20 bp, Artificial Sequence
  Description of Artificial Sequence Synthetic probe
aagaaaccaagaaaaaattt

SEQ ID NO: 527 - DNA, 16 bp, Artificial Sequence
  Description of Artificial Sequence Synthetic probe
ttcgccagcgctgaag

SEQ ID NO: 528 - DNA, 15 bp, Artificial Sequence
  Description of Artificial Sequence Synthetic probe
caggcaacaggaatc

SEQ ID NO: 529 - DNA, 17 bp, Artificial Sequence
  Description of Artificial Sequence Synthetic probe
tttctctcggcggcctt

SEQ ID NO: 530 - DNA, 19 bp, Artificial Sequence
  Description of Artificial Sequence Synthetic probe
ttggacttgcctgttaaat

SEQ ID NO: 531 - DNA, 17 bp, Artificial Sequence
  Description of Artificial Sequence Synthetic probe
ctcaccttgagcaaccg

SEQ ID NO: 532 - DNA, 17 bp, Artificial Sequence
  Description of Artificial Sequence Synthetic probe
ctgaacagtgacaaatc

SEQ ID NO: 533 - DNA, 18 bp, Artificial Sequence
  Description of Artificial Sequence Synthetic probe
aacaccccctccagctca

SEQ ID NO: 534 - DNA, 20 bp, Artificial Sequence
  Description of Artificial Sequence Synthetic probe
ctggagttggcccctgtgag

SEQ ID NO: 535 - DNA, 15 bp, Artificial Sequence
  Description of Artificial Sequence Synthetic probe
ctgctggcagaacat

SEQ ID NO: 536 - DNA, 20 bp, Artificial Sequence
  Description of Artificial Sequence Synthetic probe
caagtcagttaccgaataat

SEQ ID NO: 537 - DNA, 20 bp, Artificial Sequence
  Description of Artificial Sequence Synthetic probe
acatccagattggttttatg

SEQ ID NO: 538 - DNA, 16 bp, Artificial Sequence
  Description of Artificial Sequence Synthetic probe
ccaggaccagatcttt

SEQ ID NO: 539 - DNA, 16 bp, Artificial Sequence
  Description of Artificial Sequence Synthetic probe
ccagcccctgaaggag

SEQ ID NO: 540 - DNA, 25 bp, Artificial Sequence
  Description of Artificial Sequence Synthetic probe
ctttttaacaaggtagttaacctgc

SEQ ID NO: 541 - DNA, 15 bp, Artificial Sequence
  Description of Artificial Sequence Synthetic probe
cccagctgtgggcag

SEQ ID NO: 542 - DNA, 20 bp, Artificial Sequence
  Description of Artificial Sequence Synthetic probe
ccttcgaacccatacctgac

SEQ ID NO: 543 - DNA, 16 bp, Artificial Sequence
  Description of Artificial Sequence Synthetic probe
ctgccggacaggatga

SEQ ID NO: 544 - DNA, 18 bp, Artificial Sequence
  Description of Artificial Sequence Synthetic probe
actaaggttgcaaaagct

SEQ ID NO: 545 - DNA, 15 bp, Artificial Sequence
  Description of Artificial Sequence Synthetic probe
ccaggcgaaaaccaa

SEQ ID NO: 546 - DNA, 18 bp, Artificial Sequence
  Description of Artificial Sequence Synthetic probe
cctctcgtctctgaagaa

SEQ ID NO: 547 - DNA, 16 bp, Artificial Sequence
  Description of Artificial Sequence Synthetic probe
cagaggccctggctcc

SEQ ID NO: 548 - DNA, 19 bp, Artificial Sequence
  Description of Artificial Sequence Synthetic probe
tctcagaggtccagataaa

SEQ ID NO: 549 - DNA, 18 bp, Artificial Sequence
  Description of Artificial Sequence Synthetic probe
ctggaaggcatcctcctc

SEQ ID NO: 550 - DNA, 18 bp, Artificial Sequence
  Description of Artificial Sequence Synthetic probe
ctggaaggcatcctcctc

SEQ ID NO: 551 - DNA, 17 bp, Artificial Sequence
  Description of Artificial Sequence Synthetic probe
gctggagagtgtagatc

SEQ ID NO: 552 - DNA, 20 bp, Artificial Sequence
  Description of Artificial Sequence Synthetic probe
ctcctgactctaggcttgtc

SEQ ID NO: 553 - DNA, 16 bp, Artificial Sequence
  Description of Artificial Sequence Synthetic probe
acgcagagcacccctg

SEQ ID NO: 554 - DNA, 19 bp, Artificial Sequence
  Description of Artificial Sequence Synthetic probe
atacgaatgtagagatccc

SEQ ID NO: 555 - DNA, 16 bp, Artificial Sequence
  Description of Artificial Sequence Synthetic probe
acagctaccaggaccc

SEQ ID NO: 556 - DNA, 17 bp, Artificial Sequence
  Description of Artificial Sequence Synthetic probe
tcaaccaggttaatttc

SEQ ID NO: 557 - DNA, 21 bp, Artificial Sequence
  Description of Artificial Sequence Synthetic probe
caccctttttcctgatatact

SEQ ID NO: 558 - DNA, 20 bp, Artificial Sequence
  Description of Artificial Sequence Synthetic probe
aataaccctgcccacacact

SEQ ID NO: 559 - DNA, 18 bp, Artificial Sequence
  Description of Artificial Sequence Synthetic probe
ttgtcttctccaaactcc

SEQ ID NO: 560 - DNA, 14 bp, Artificial Sequence
  Description of Artificial Sequence Synthetic probe
tgcagcagctggag

SEQ ID NO: 561 - DNA, 17 bp, Artificial Sequence
  Description of Artificial Sequence Synthetic probe
ctcctgctgatgctttc

SEQ ID NO: 562 - DNA, 18 bp, Artificial Sequence
  Description of Artificial Sequence Synthetic probe
cagcaaggtcctggccct

SEQ ID NO: 563 - DNA, 18 bp, Artificial Sequence
  Description of Artificial Sequence Synthetic probe
cagcaaggtcctggccct

SEQ ID NO: 564 - DNA, 17 bp, Artificial Sequence
  Description of Artificial Sequence Synthetic probe
cagggccttagagaaca

SEQ ID NO: 565 - DNA, 14 bp, Artificial Sequence
  Description of Artificial Sequence Synthetic probe
tggcctgaaaacac

SEQ ID NO: 566 - DNA, 17 bp, Artificial Sequence
  Description of Artificial Sequence Synthetic probe
tgttgtccataataccc

SEQ ID NO: 567 - DNA, 20 bp, Artificial Sequence
  Description of Artificial Sequence Synthetic probe
actgggaaacatggttccaa

SEQ ID NO: 568 - DNA, 18 bp, Artificial Sequence
  Description of Artificial Sequence Synthetic probe
ctttgctagccagactgc

SEQ ID NO: 569 - DNA, 16 bp, Artificial Sequence
  Description of Artificial Sequence Synthetic probe
tcggtccccgaacatg

SEQ ID NO: 570 - DNA, 13 bp, Artificial Sequence
  Description of Artificial Sequence Synthetic probe
acctgcttttccc

SEQ ID NO: 571 - DNA, 18 bp, Artificial Sequence
  Description of Artificial Sequence Synthetic probe
atccccctcactgggttt

SEQ ID NO: 572 - DNA, 16 bp, Artificial Sequence
  Description of Artificial Sequence Synthetic probe
ccacacctgagcttcc

SEQ ID NO: 573 - DNA, 19 bp, Artificial Sequence
  Description of Artificial Sequence Synthetic probe
tcatgaggagacttcttcc

SEQ ID NO: 574 - DNA, 19 bp, Artificial Sequence
  Description of Artificial Sequence Synthetic probe
ctaaaggcaaagaaacttc

SEQ ID NO: 575 - DNA, 17 bp, Artificial Sequence
  Description of Artificial Sequence Synthetic probe
atgtcctggccatcctg

SEQ ID NO: 576 - DNA, 15 bp, Artificial Sequence
  Description of Artificial Sequence Synthetic probe
ctcagccccaacttt

SEQ ID NO: 577 - DNA, 17 bp, Artificial Sequence
  Description of Artificial Sequence Synthetic probe
tccaggtggctcaaatt

SEQ ID NO: 578 - DNA, 18 bp, Artificial Sequence
  Description of Artificial Sequence Synthetic probe
ccgagtccttaaggtttc

SEQ ID NO: 579 - DNA, 17 bp, Artificial Sequence
  Description of Artificial Sequence Synthetic probe
cactctggccgaacacg

SEQ ID NO: 580 - DNA, 14 bp, Artificial Sequence
  Description of Artificial Sequence Synthetic probe
ctggcacacctccc

SEQ ID NO: 581 - DNA, 20 bp, Artificial Sequence
  Description of Artificial Sequence Synthetic probe
cctgatatgagcagtgcttc

SEQ ID NO: 582 - DNA, 16 bp, Artificial Sequence
  Description of Artificial Sequence Synthetic probe
aaccagacaaggcccc

SEQ ID NO: 583 - DNA, 19 bp, Artificial Sequence
  Description of Artificial Sequence Synthetic probe
aagtgtgaagcctgaagcc

SEQ ID NO: 584 - DNA, 15 bp, Artificial Sequence
  Description of Artificial Sequence Synthetic probe
ccccaggagttgctg

SEQ ID NO: 585 - DNA, 19 bp, Artificial Sequence
  Description of Artificial Sequence Synthetic probe
cccaggaacagctcgtttt

SEQ ID NO: 586 - DNA, 18 bp, Artificial Sequence
  Description of Artificial Sequence Synthetic probe
ctcccctgtgtgagaata

SEQ ID NO: 587 - DNA, 15 bp, Artificial Sequence
  Description of Artificial Sequence Synthetic probe
ctgcttggcgccttc

SEQ ID NO: 588 - DNA, 18 bp, Artificial Sequence
  Description of Artificial Sequence Synthetic probe
tcagagctgctgcttatt

SEQ ID NO: 589 - DNA, 19 bp, Artificial Sequence
  Description of Artificial Sequence Synthetic probe
caccagcatctagcttgtt

SEQ ID NO: 590 - DNA, 21 bp, Artificial Sequence
  Description of Artificial Sequence Synthetic probe
aagctccaaaagagataaaca

SEQ ID NO: 591 - DNA, 17 bp, Artificial Sequence
  Description of Artificial Sequence Synthetic probe
ccagccttccacataac

SEQ ID NO: 592 - DNA, 20 bp, Artificial Sequence
  Description of Artificial Sequence Synthetic probe
atggtggacaagatttttga

SEQ ID NO: 593 - DNA, 16 bp, Artificial Sequence
  Description of Artificial Sequence Synthetic probe
ccccacaggaacagtc

SEQ ID NO: 594 - DNA, 22 bp, Artificial Sequence
  Description of Artificial Sequence Synthetic probe
catcagttgtgataaggataac

SEQ ID NO: 595 - DNA, 16 bp, Artificial Sequence
  Description of Artificial Sequence Synthetic probe
acgggcttcaagaact

SEQ ID NO: 596 - DNA, 20 bp, Artificial Sequence
  Description of Artificial Sequence Synthetic probe
caccatctgctttcctttta

SEQ ID NO: 597 - DNA, 19 bp, Artificial Sequence
  Description of Artificial Sequence Synthetic probe
cctttctcttggagcttat

SEQ ID NO: 598 - DNA, 17 bp, Artificial Sequence
  Description of Artificial Sequence Synthetic probe
cccagcgacccagtcag

SEQ ID NO: 599 - DNA, 14 bp, Artificial Sequence
  Description of Artificial Sequence Synthetic probe
cccgcgcttctcca

SEQ ID NO: 600 - DNA, 23 bp, Artificial Sequence
  Description of Artificial Sequence Synthetic probe
agctcagattcttcccctggtgg

SEQ ID NO: 601 - DNA, 18 bp, Artificial Sequence
  Description of Artificial Sequence Synthetic probe
tctgccgtagaggtattt

SEQ ID NO: 602 - DNA, 19 bp, Artificial Sequence
  Description of Artificial Sequence Synthetic probe
attcaggaactagaaattc

SEQ ID NO: 603 - DNA, 15 bp, Artificial Sequence
  Description of Artificial Sequence Synthetic probe
acgccaggccttcac

SEQ ID NO: 604 - DNA, 17 bp, Artificial Sequence
  Description of Artificial Sequence Synthetic probe
ctggcagcagtgtatca

SEQ ID NO: 605 - DNA, 20 bp, Artificial Sequence
  Description of Artificial Sequence Synthetic probe
cttcccacatactgcttcac

SEQ ID NO: 606 - DNA, 18 bp, Artificial Sequence
  Description of Artificial Sequence Synthetic probe
ctggcaaatttgattttt

SEQ ID NO: 607 - DNA, 17 bp, Artificial Sequence
  Description of Artificial Sequence Synthetic probe
caggtcttgggacttct

SEQ ID NO: 608 - DNA, 14 bp, Artificial Sequence
  Description of Artificial Sequence Synthetic probe
ccgccgagtctttt

SEQ ID NO: 609 - DNA, 18 bp, Artificial Sequence
  Description of Artificial Sequence Synthetic probe
ttggagctggtgtacttg

SEQ ID NO: 610 - DNA, 19 bp, Artificial Sequence
  Description of Artificial Sequence Synthetic probe
ccttcctctcctctcctcg

SEQ ID NO: 611 - DNA, 16 bp, Artificial Sequence
  Description of Artificial Sequence Synthetic probe
ccgctgagcctggatg

SEQ ID NO: 612 - DNA, 17 bp, Artificial Sequence
  Description of Artificial Sequence Synthetic probe
atagtcgcccacttggc

SEQ ID NO: 613 - DNA, 18 bp, Artificial Sequence
  Description of Artificial Sequence Synthetic probe
ccaaggccaagtcgcgct

SEQ ID NO: 614 - DNA, 20 bp, Artificial Sequence
  Description of Artificial Sequence Synthetic probe
cagcccagttcttgtagttg

SEQ ID NO: 615 - DNA, 18 bp, Artificial Sequence
  Description of Artificial Sequence Synthetic probe
tcggaggtgtgatagcag

SEQ ID NO: 616 - DNA, 17 bp, Artificial Sequence
  Description of Artificial Sequence Synthetic probe
aaccgagcctgctctat

SEQ ID NO: 617 - DNA, 19 bp, Artificial Sequence
  Description of Artificial Sequence Synthetic probe
cactgtaacacagatgttg

SEQ ID NO: 618 - DNA, 17 bp, Artificial Sequence
  Description of Artificial Sequence Synthetic probe
aaaggctggctgaatca

SEQ ID NO: 619 - DNA, 18 bp, Artificial Sequence
  Description of Artificial Sequence Synthetic probe
aaaatgcacctaaaattc

SEQ ID NO: 620 - DNA, 17 bp, Artificial Sequence
  Description of Artificial Sequence Synthetic probe
caggacgccacgtagtt

SEQ ID NO: 621 - DNA, 19 bp, Artificial Sequence
  Description of Artificial Sequence Synthetic probe
aacccatacaggtgaaaag

SEQ ID NO: 622 - DNA, 18 bp, Artificial Sequence
  Description of Artificial Sequence Synthetic probe
attgcctcaacagcttca

SEQ ID NO: 623 - DNA, 17 bp, Artificial Sequence
  Description of Artificial Sequence Synthetic probe
cagagctgtgaagcctt

SEQ ID NO: 624 - DNA, 20 bp, Artificial Sequence
  Description of Artificial Sequence Synthetic probe
caggtttggagctcctggac

SEQ ID NO: 625 - DNA, 19 bp, Artificial Sequence
  Description of Artificial Sequence Synthetic probe
cataccttttgtcaatttc

SEQ ID NO: 626 - DNA, 19 bp, Artificial Sequence
  Description of Artificial Sequence Synthetic probe
ccactgcttcctgacacaa

SEQ ID NO: 627 - DNA, 19 bp, Artificial Sequence
  Description of Artificial Sequence Synthetic probe
cagatgacatcagaagacc

SEQ ID NO: 628 - DNA, 16 bp, Artificial Sequence
  Description of Artificial Sequence Synthetic probe
ccaccagggcatccag

SEQ ID NO: 629 - DNA, 14 bp, Artificial Sequence
  Description of Artificial Sequence Synthetic probe
tgggtgcagcgaac

SEQ ID NO: 630 - DNA, 19 bp, Artificial Sequence
  Description of Artificial Sequence Synthetic probe
caaacaccatcaagaatat

SEQ ID NO: 631 - DNA, 17 bp, Artificial Sequence
  Description of Artificial Sequence Synthetic probe
ccatggtcaagagaaag

SEQ ID NO: 632 - DNA, 16 bp, Artificial Sequence
  Description of Artificial Sequence Synthetic probe
ctcgccgtggtggaaa

SEQ ID NO: 633 - DNA, 25 bp, Artificial Sequence
  Description of Artificial Sequence Synthetic probe
tcgtaaaatattttgatgagattct

SEQ ID NO: 634 - DNA, 19 bp, Artificial Sequence
  Description of Artificial Sequence Synthetic probe
caaggatggatcatttctt

SEQ ID NO: 635 - DNA, 18 bp, Artificial Sequence
  Description of Artificial Sequence Synthetic probe
tcagagcaggctcatctt

SEQ ID NO: 636 - DNA, 17 bp, Artificial Sequence
  Description of Artificial Sequence Synthetic probe
ccttcatggcattcaac

SEQ ID NO: 637 - DNA, 20 bp, Artificial Sequence
  Description of Artificial Sequence Synthetic probe
caggaacttcaacagataat

SEQ ID NO: 638 - DNA, 16 bp, Artificial Sequence
  Description of Artificial Sequence Synthetic probe
ccaggctggccacctg

SEQ ID NO: 639 - DNA, 19 bp, Artificial Sequence
  Description of Artificial Sequence Synthetic probe
atgctgattggaaataaat

SEQ ID NO: 640 - DNA, 22 bp, Artificial Sequence
  source: Description of Artificial Sequence Synthetic probe
acgatcctgacattatagcctt

SEQ ID NO: 641 - DNA, 23 bp, Artificial Sequence
  Description of Artificial Sequence Synthetic probe
ctttatctgtgtcctcgccagca

SEQ ID NO: 642 - DNA, 19 bp, Artificial Sequence
  Description of Artificial Sequence Synthetic probe
tggatttatacccaaccct

SEQ ID NO: 643 - DNA, 19 bp, Artificial Sequence
  Description of Artificial Sequence Synthetic probe
cctgacttcaccactatgc

SEQ ID NO: 644 - DNA, 17 bp, Artificial Sequence
  Description of Artificial Sequence Synthetic probe
ccgacgaccttggtttc

SEQ ID NO: 645 - DNA, 21 bp, Artificial Sequence
  Description of Artificial Sequence Synthetic probe
aagttgaaagaaacagatctc

SEQ ID NO: 646 - DNA, 21 bp, Artificial Sequence
  Description of Artificial Sequence Synthetic probe
catacaggttaccaaagtgac

SEQ ID NO: 647 - DNA, 19 bp, Artificial Sequence
  Description of Artificial Sequence Synthetic probe
ctccaccgttctcaagtca

SEQ ID NO: 648 - DNA, 13 bp, Artificial Sequence
  Description of Artificial Sequence Synthetic probe
cgtgctggcctcc

SEQ ID NO: 649 - DNA, 16 bp, Artificial Sequence
  Description of Artificial Sequence Synthetic probe
ccacctggaagaacgc

SEQ ID NO: 650 - DNA, 19 bp, Artificial Sequence
  Description of Artificial Sequence Synthetic probe
atgctgctaaacaaatcaa

SEQ ID NO: 651 - DNA, 20 bp, Artificial Sequence
  Description of Artificial Sequence Synthetic probe
ctcaagacctagaaaataag

SEQ ID NO: 652 - DNA, 21 bp, Artificial Sequence
  Description of Artificial Sequence Synthetic probe
catttcatcctcctcaacaac

SEQ ID NO: 653 - DNA, 18 bp, Artificial Sequence
  Description of Artificial Sequence Synthetic probe
ctggtggaactggaaata

SEQ ID NO: 654 - DNA, 15 bp, Artificial Sequence
  Description of Artificial Sequence Synthetic probe
ctctcctgagagccc

SEQ ID NO: 655 - DNA, 20 bp, Artificial Sequence
  Description of Artificial Sequence Synthetic probe
cttggattcctcataaatca

SEQ ID NO: 656 - DNA, 17 bp, Artificial Sequence
  Description of Artificial Sequence Synthetic probe
cctaaggaaccaaattc

SEQ ID NO: 657 - DNA, 19 bp, Artificial Sequence
  Description of Artificial Sequence Synthetic probe
ccacaggaaacctcaaagc

SEQ ID NO: 658 - DNA, 18 bp, Artificial Sequence
  Description of Artificial Sequence Synthetic probe
ctgtccacaccttgctcc

SEQ ID NO: 659 - DNA, 19 bp, Artificial Sequence
  Description of Artificial Sequence Synthetic probe
cccaaaagagttaaccttg

SEQ ID NO: 660 - DNA, 19 bp, Artificial Sequence
  Description of Artificial Sequence Synthetic probe
tcgatctcagttgctcttc

SEQ ID NO: 661 - DNA, 20 bp, Artificial Sequence
  Description of Artificial Sequence Synthetic probe
ctgtgaaccatctgaacatg

SEQ ID NO: 662 - DNA, 15 bp, Artificial Sequence
  Description of Artificial Sequence Synthetic probe
ccccggcctgtggtc

SEQ ID NO: 663 - DNA, 20 bp, Artificial Sequence
  Description of Artificial Sequence Synthetic probe
ccatggctttagctgacttg

SEQ ID NO: 664 - DNA, 24 bp, Artificial Sequence
  Description of Artificial Sequence Synthetic probe
catttaggacttcataaagatttt

SEQ ID NO: 665 - DNA, 18 bp, Artificial Sequence
  Description of Artificial Sequence Synthetic probe
cctagacactgatgaccc

SEQ ID NO: 666 - DNA, 18 bp, Artificial Sequence
  Description of Artificial Sequence Synthetic probe
ctttcacagccccagccc

SEQ ID NO: 667 - DNA, 17 bp, Artificial Sequence
  Description of Artificial Sequence Synthetic probe
ctgggacaggcctcatg

SEQ ID NO: 668 - DNA, 17 bp, Artificial Sequence
  Description of Artificial Sequence Synthetic probe
cctaaggaaccaaattc

SEQ ID NO: 669 - DNA, 15 bp, Artificial Sequence
  Description of Artificial Sequence Synthetic probe
cctgtcgctcttccc

SEQ ID NO: 670 - DNA, 17 bp, Artificial Sequence
  Description of Artificial Sequence Synthetic probe
cagctcctccatgattg

SEQ ID NO: 671 - DNA, 15 bp, Artificial Sequence
  Description of Artificial Sequence Synthetic probe
cccagcctgatcgct

SEQ ID NO: 672 - DNA, 15 bp, Artificial Sequence
  Description of Artificial Sequence Synthetic probe
actgcagcaaggcag